(19) United States
(12) Patent Application Publication
(10) Pub. No.: US 2007/0255634 A1
(43) Pub. Date: Nov. 1, 2007

(54) Vehicle fee-tax management system

(75) Inventor: Kenneth Rand Alley, Littleton, CO (US)

Correspondence Address: CR MILES, P.C.;CRAIG R. MILES, 405 MASON COURT, SUITE 119, FORT COLLINS, CO, 80524, US

(73) Assignee: Automotive Titling of Colorado, Inc.

(21) Appl. No.: 11/714,752

(22) Filed: Mar. 5, 2007

Related U.S. Application Data
(63) Continuation-in-part of application No. 11/418,877, filed on May 5, 2006.
(60) Provisional application No. 60/678,395, filed on May 5, 2005.

(51) Int. Cl. G06Q 40/00

(52) U.S. Cl. 705/35

(57) ABSTRACT

A fee-tax manager which provides a fee-tax administrator module which provides a hierarchical structure of a plurality of fee-tax modules which function to couple one or a plurality of fee-tax identifiers to each one of a plurality of fee-taxes of a plurality of fee-tax entities for retrievable storage by matched correspondence with fee-tax retrieval elements which comprise part of a fee-tax inquiry generated by the functionalities of a plurality of fee-tax retrieval modules of a fee-tax user module of the fee-tax manager application program.

This United States Patent application is a continuation-in-part of U.S. patent application Ser. No. 11/418,877, filed May 5, 2006, which claims the benefit of U.S. Provisional Patent Application No. 60/678,395, filed May 5, 2005, each hereby incorporated by reference herein.

### I. BACKGROUND

Generally, an automotive titling system in which motor vehicle titling data elements entered in a motor vehicle titling inquiry author generates a motor vehicle titling inquiry which applied to a motor vehicle titling database generates motor vehicle titling data instructions relevant to a motor vehicle titling event.

A fee-tax manager which provides a fee-tax administrator module which provides a hierarchical structure of a plurality of fee-tax modules which function to couple one or a plurality of fee-tax identifiers to each one of a plurality of fee-taxes of a plurality of fee-tax entities for retrievable storage by matched correspondence with fee-tax retrieval elements which comprise part of a fee-tax inquiry generated by the functionalities of a plurality of fee-tax retrieval modules of a fee-tax user module of the fee-tax manager application program.

Typically, ownership of a motor vehicle in the United States (and other countries or regions as well) is documented by registering the title to the motor vehicle with the government of the state, county, city, or other motor vehicle jurisdiction in which the motor vehicle is owned. The conventional approach to registering the title of a motor vehicle with a motor vehicle jurisdiction typically involves manually populating the fields if one or more motor vehicle registration documents, producing other required registration documents, and calculating fees in the format or amount required by the motor vehicle jurisdiction in which the motor vehicle is owned or operated (the “motor vehicle title registration application”). The burden of preparing and filing the motor vehicle title registration application in a particular motor vehicle jurisdiction typically falls to the motor vehicle sales entity (such as a motor vehicle dealer) or the financial entity (such as a bank or other lender) that initiates the motor vehicle loan or initiates the motor vehicle lease for the buyer of the vehicle.

Even though every state of the United States (along with most other countries) requires motor vehicle title registration of each motor vehicle and even though motor vehicle sales entities and financial entities which initiate motor vehicle sales, loans or leases have prepared the motor vehicle title registration applications for many years, there yet remains a variety of long felt but unresolved problems with respect to titling a motor vehicle.

A first problem with respect to motor vehicle title registration can be that titling laws, regulations, rules, tax rates, form documents, filing locations, or other requirements (“motor vehicle registration requirements”) vary from motor vehicle titling jurisdiction to motor vehicle titling jurisdiction; however, the services provided by motor vehicle sales entities, financial entities, or other motor vehicle titling entities (“titling entity”) have not remained local, but rather, have become regional or national. This requires each motor vehicle sales, financing, and titling entity to create, develop and maintain a hardcopy or electronic database of the titling requirements of numerous motor vehicle jurisdictions. The development and maintenance of this additional database creates an additional burden for the titling entity which can translate into increased costs paid by the motor vehicle buyer.

This problem may be exacerbated because the motor vehicle registration requirements encompassed by the plurality of motor vehicle jurisdictions relevant to a titling entity are frequently altered due to legislation, agency action, operation of contracts, or the like. These alterations to the motor vehicle registration requirements can require a corresponding alteration in the practice of a titling entity to achieve the filing of a proper motor vehicle title registration application.

Another problem related to the provision of regional or nationwide services by a titling entity can be the increased difficulty in assessing motor vehicle title registration requirements when the motor vehicle owner, the motor vehicle sales transaction, the motor vehicle financing transaction, or the motor vehicle title entity are located, reside or occur in different motor vehicle jurisdictions each applying a unique set of automotive titling instructions.

Another problem related to the provision of regional or nationwide services by a titling entity can be the difficulty in establishing and maintaining retrievable storage of the plurality of fees and taxes of a plurality of taxing entities which may further vary based on a plurality of transaction types with the taxing entity, the type of vehicle, various vehicle values, the vehicle status with respect to the title, lien condition, the plate type, and other factors.

Another problem for a motor vehicle titling entity can be the burden of manually populating the fields (whether by hand writing or by key stroke) of certain documents encompassed by the motor vehicle title registration application. Due to the variables or factors unique to a particular motor vehicle buyer's record which must be assessed to select the various elements which make up the motor vehicle registration application along with making any corresponding manual data entries into the motor vehicle title registration application and to the buyer's file, along with any other action required to complete the motor vehicle title registration application (the “motor vehicle titling event”), each motor vehicle title registration application can take a clerk between about sixty to ninety minutes to complete.

Another problem for a motor vehicle titling entity can be determination of which taxes or fees apply to a particular motor vehicle title registration transaction in a particular motor vehicle titling jurisdiction and the actual amount of any taxes or fees which must be paid to complete that particular motor vehicle title registration transaction. Based on the existing number of different types of motor vehicle transactions which can be performed with the existing plurality of a motor vehicle jurisdictions in the United States and the existing number of factors which act to increase of decrease the amount of the fees or the taxes or both paid to register the title of a motor vehicle about 7,000,000 different combinations can occur which effect the amount of the fees or taxes to be paid. This makes determination of the exact amount of the fees or taxes payable on any given a motor vehicle registration with a particular motor vehicle jurisdiction impractical for the large majority of motor vehicle titling entities. Therefore, the conventional practice of the most motor vehicle titling entities is to prepare form documents which allow an estimate of the fees or taxes or both to be paid on any given motor vehicle transaction. Subsequently, the actual amount of fees or taxes for the motor vehicle transaction is determined by follow up with the particular motor vehicle jurisdiction and any difference refunded or collected from the vehicle owner.

Other problems with conventional automotive titling devices and methods may be disclosed throughout other areas of the specification, drawings, photographs, and claims.

### II. SUMMARY OF THE INVENTION

Accordingly, a broad object of the invention can be to provide an electronic automotive titling system which provides a titling entity motor vehicle titling instructions for a particular motor vehicle titling event including a plurality of motor vehicle titling data entities which as to certain embodiments of the invention can be automatically populated with motor vehicle titling data elements.

Another broad object of the invention can be to provide a motor vehicle titling database which contains a plurality of motor vehicle titling data entities which can be mapped against a plurality of inquiry fields and motor vehicle titling data elements (which can be applied individually or in various permutations and combinations) in a motor vehicle titling inquiry to generate the motor vehicle titling instructions for each motor vehicle titling event regardless of the actual location of: the titling entity, motor vehicle jurisdiction which controls the performance of the motor vehicle buyer, the motor vehicle sales entity, the motor vehicle insurance entity, the motor vehicle financing entity, the motor vehicle, or the like.

Another broad object of the invention can be to provide an application program which allows motor vehicle titling data elements to be extracted from a second computer motor vehicle titling database of a titling entity and mapped against a plurality of inquiry fields of a motor vehicle titling inquiry author to generate the motor vehicle titling inquiry which can be used to retrieve a part of the plurality of motor vehicle titling data entities in a motor vehicle titling database relating to a motor vehicle titling event.

Another broad object of the invention can be to provide an application program which generates a motor vehicle titling inquiry which can be applied to a motor vehicle titling database containing a plurality of motor vehicle titling data entities to generate motor vehicle titling instructions relating to a particular motor vehicle titling event, including, but not limited to, motor vehicle title registration instructions and motor vehicle title registration application documents which can have the data entity fields properly populated.

Another broad object of the invention can be to provide a motor vehicle titling service which provides to a user access to the program application which provides a motor vehicle titling inquiry author in which a plurality of motor vehicle titling data elements relating to a particular motor vehicle titling event can be established in a plurality of inquiry fields to generate a motor vehicle titling inquiry which can be applied to the motor vehicle titling database of the motor vehicle titling service to generate a motor vehicle titling instruction.

Another broad object of the invention can be to provide a fee-tax manager having a fee-tax administrator module which provides a hierarchical structure of a plurality of fee-tax modules which function to couple fee-tax identifiers to each one of a plurality of fee-taxes (see definition of “fee-tax” below) of a plurality of fee-tax entities for retrievable storage by matched correspondence with fee-tax retrieval elements entered into a plurality of fee-tax retrieval modules of a fee-tax user module of the fee-tax manager to provide an accurate determination of the fees or taxes or both payable on a given motor vehicle transaction performed in any one of a plurality of fee-tax entities.

Naturally, further objects of the invention are disclosed throughout other areas of the specification, drawings, photographs, and claims.

### III. A BRIEF DESCRIPTION OF THE DRAWINGS

FIG. 1 provides a block diagram of a particular embodiment of the invention.

FIG. 2 provides a block diagram of hardware means, software means, and network means which may be utilized to practice various embodiments of the invention.

FIG. 3 is a screen image representation of first part of a particular embodiment of an application interface of a motor vehicle titling inquiry author.

FIG. 4 is a screen image representation of a second part of a particular embodiment of an application interface of the motor vehicle titling inquiry author.

FIG. 5 is a screen image representation of a third part of a particular embodiment of an application interface of the motor vehicle titling inquiry author.

FIG. 6 is a screen image representation of a motor vehicle titling data entity viewer in a first level architecture.

FIG. 7 is a screen image representation of a first level architecture data entity list.

FIG. 8 is a screen image representation of a second level architecture data entity list and a third level architecture data entity list.

FIG. 9 is a screen image representation of an add data entity viewer.

FIG. 10 is a screen image representation of an add data entity viewer including a data entity field population module activation element.

FIG. 11 is a screen image representation of a viewable list of undefined data entity fields generated by operation of the data entity field population module activation element.

FIG. 12 is a screen image representation of a data field setting module viewer generated by selection of an undefined data entity field in an enabled PDF data entity.

FIG. 13 is a screen image representation of a field argument viewer generated by selection of the direct field copy module of the data field setting module viewer.

FIG. 14 is a screen image representation of an argument setting viewer generated by selection of a field argument in the field argument viewer of the direct field copy module.

FIG. 15 is a screen image representation of a field argument viewer generated by selection of the fee-tax module of the data field setting module viewer.

FIG. 16 is a screen image representation of an argument setting viewer generated by selection of a field argument in the field argument viewer of the fee-tax module.

FIG. 17 is a screen image representation of a field argument viewer generated by selection of the static text module of the data field setting module viewer.

FIG. 18 is a screen image representation of an argument setting viewer generated by selection of a field argument in the field argument viewer of the static text module.

FIG. 19 is a screen image representation of a field argument viewer generated by selection of the calculated value module of the data field setting module viewer.

FIG. 20 is a screen image representation of an argument setting viewer generated by selection of a field argument in the field argument viewer of the calculated value module.

FIG. 21 is a screen image representation of a field argument viewer generated by selection of the full name module of the data field setting module viewer.

FIG. 22 is a screen image representation of a first argument setting viewer generated by selection of a name format field argument in the field argument viewer of the full name module.

FIG. 23 is a screen image representation of a second argument setting viewer generated by selection of a name source field argument in the field argument viewer of the full name module.

FIG. 24 is a screen image representation of a field argument viewer generated by selection of the checkbox module of the data field setting module viewer.

FIG. 25 is a screen image representation of a first argument setting viewer generated by selection of a field name field argument in the field argument viewer of the checkbox module.

FIG. 26 is a screen image representation of a second argument setting viewer generated by selection of a checkbox value field argument in the field argument viewer of the checkbox module.

FIG. 27 is a screen image representation of a third argument setting viewer generated by selection of a match value field argument in the field argument viewer of the checkbox module.

FIG. 28 is a screen image representation of a field argument viewer generated by selection of the data value module of the data field setting module viewer.

FIG. 29 is a screen image representation of a first argument setting viewer generated by selection of a date format field argument in the field argument viewer of the date value module.

FIG. 30 is a screen image representation of a second argument setting viewer generated by selection of a date value field argument in the field argument viewer of the date value module.

FIG. 31 is a screen image representation of a field argument viewer generated by selection of the character form field module (or field element selection module) of the data field setting module viewer.

FIG. 32 is a screen image representation of a first argument setting viewer generated by selection of a field name field argument in the field argument viewer of the character form field module.

FIG. 33 is a screen image representation of a second argument setting viewer generated by selection of a sequence field argument (field element field argument) in the field argument viewer of the character form field module.

FIG. 34 is a screen image representation of a third argument setting viewer generated by selection of a start field argument (count direction field argument) in the field argument viewer of the checkbox module.

FIG. 35 is a screen image representation of a field argument viewer generated by selection of the address module of the data field setting module viewer.

FIG. 36 is a screen image representation of a first argument setting viewer generated by selection of an address format field argument in the field argument viewer of the address module.

FIG. 37 is a screen image representation of a second argument setting viewer generated by selection of a address source field argument (field element field argument) in the field argument viewer of the character form field module.

FIG. 38 is a flow diagram of a method of using an embodiment of the automotive titling system.

FIG. 39 is a screen image representation of a motor vehicle titling instruction generated by a motor vehicle titling instruction viewer.

FIGS. 40A and 40B is non-limiting example of a motor vehicle titling inquiry is provided in an XML schema.

FIGS. 41A to 41D provide a non-limiting example of a “return inquiry” step on a titling instruction inquiry in an XML schema.

FIGS. 42A to 42D provide a non-limiting example of a motor vehicle titling instruction in an XML schema.

FIG. 43 is a screen image representation of a part of an administrator fee-tax graphic interface.

FIG. 44 is a screen image representation of a part of an administrator fee-tax graphic interface.

FIGS. 45A and 45 B is a screen image representation of a part of an administrator fee-tax graphic interface.

FIG. 46 is a screen image representation of a part of an administrator fee-tax graphic interface.

FIG. 47 is a screen image representation of a part of an administrator fee-tax graphic interface.

FIG. 48 is a screen image representation of a part of an administrator fee-tax graphic interface.

FIG. 49 is a screen image representation of a part of an administrator fee-tax graphic interface.

FIGS. 50A and 50B is a screen image representation of a part of an administrator fee-tax graphic interface.

FIG. 51 is a screen image representation of a part of an administrator fee-tax graphic interface.

FIG. 52 is a screen image representation of a part of an administrator fee-tax graphic interface.

FIG. 53 is a screen image representation of a part of an administrator fee-tax graphic interface.

FIG. 54 is a flow diagram which shows the steps in a method of utilizing the functionalities of the plurality of fee-tax modules of the fee-tax administrator module of the invention.

FIG. 55 is a screen image representation of a part of customer fee-tax graphic user interface.

FIG. 56 is a screen image representation of a part of customer fee-tax graphic user interface.

FIG. 57 is a flow diagram which shows the steps in a method of utilizing the functionalities of the plurality of fee-tax retrieval modules of the fee-tax user module of the invention.

### IV. DETAILED DESCRIPTION OF THE PREFERRED EMBODIMENTS

An automotive titling system in which motor vehicle titling data elements entered in a motor vehicle titling inquiry author generates a motor vehicle titling inquiry which applied to a motor vehicle titling database generates motor vehicle titling data instructions relevant to a motor vehicle titling event.

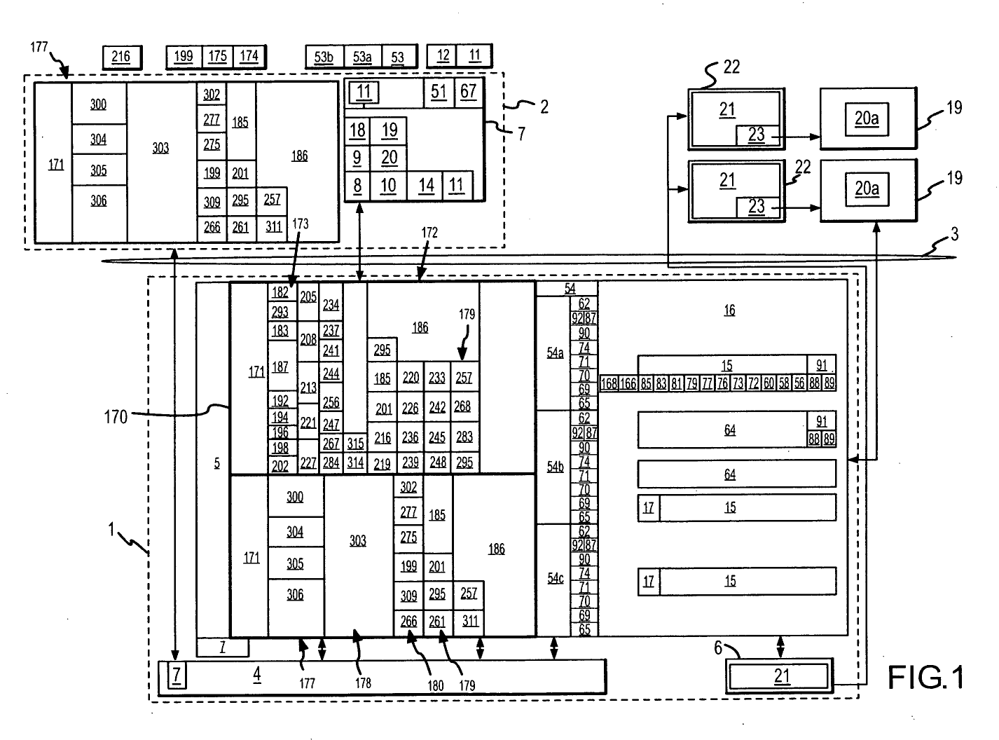

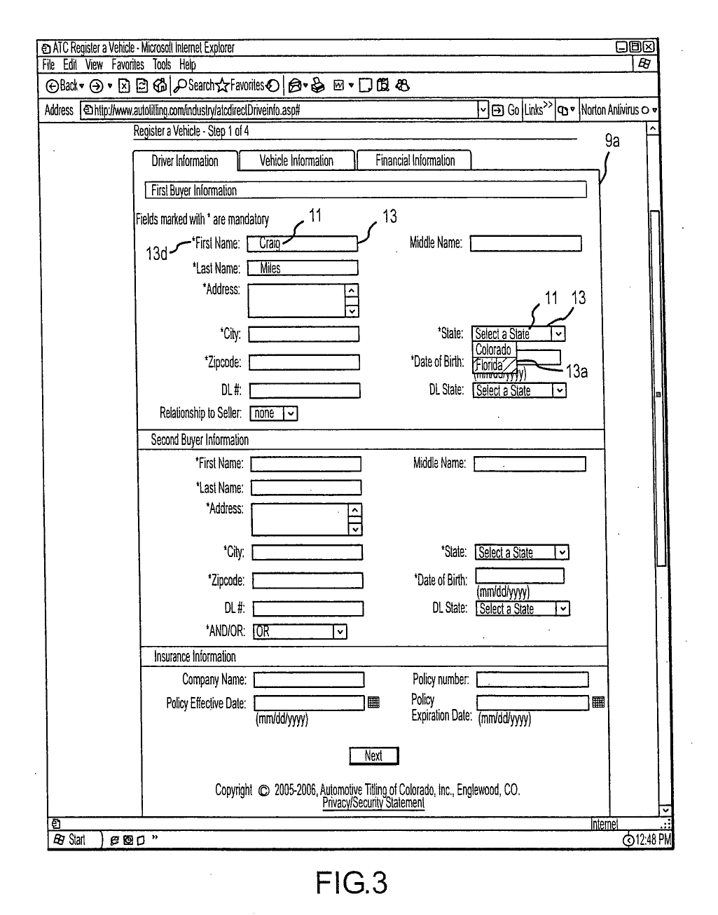

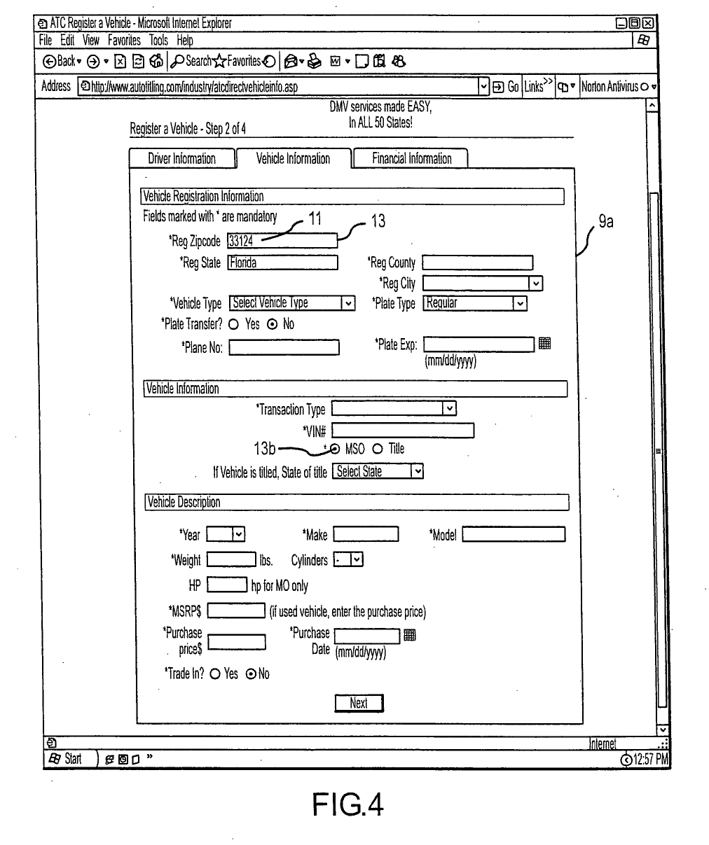

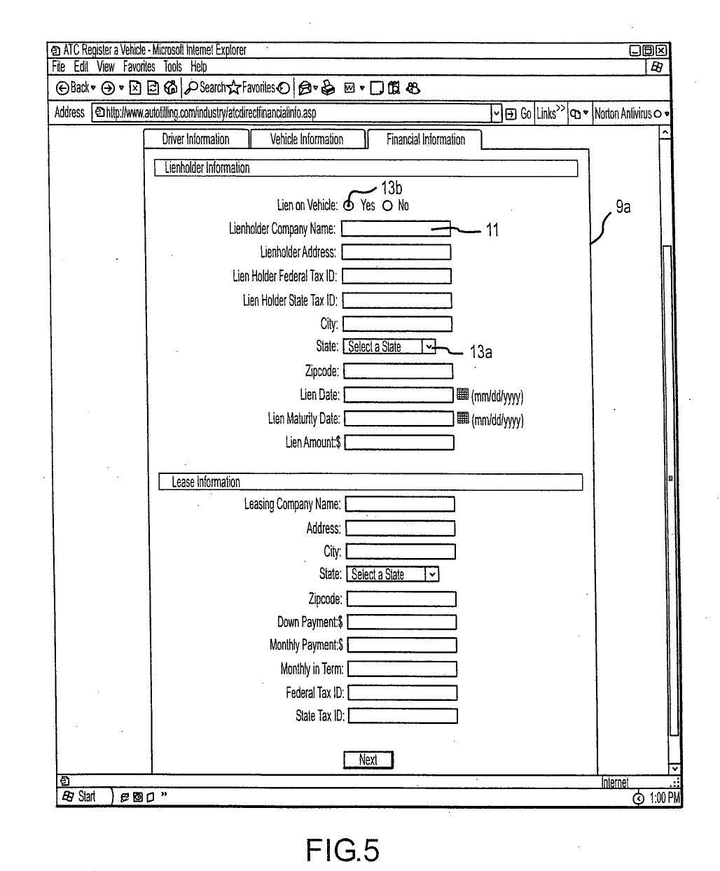

Now referring primarily to FIGS. 1 and 3-5, which provide a broad overview of certain elements and functions which underlie embodiments of the invention, a first computer (1) allows access by a second computer (2) over a wide area network (such as the Internet) (3) to a web server (4), a motor vehicle titling instructions server (5) and an email server (6). The web server (4) of the first computer (1) can download to the second computer (2) a motor vehicle titling inquiry author (7). The motor vehicle titling inquiry author (7) provides a programming interface which includes without limitation a first module (8) which functions to generate a motor vehicle titling inquiry author viewer (9) and a second module (10) which functions to generate a motor vehicle titling inquiry (14).

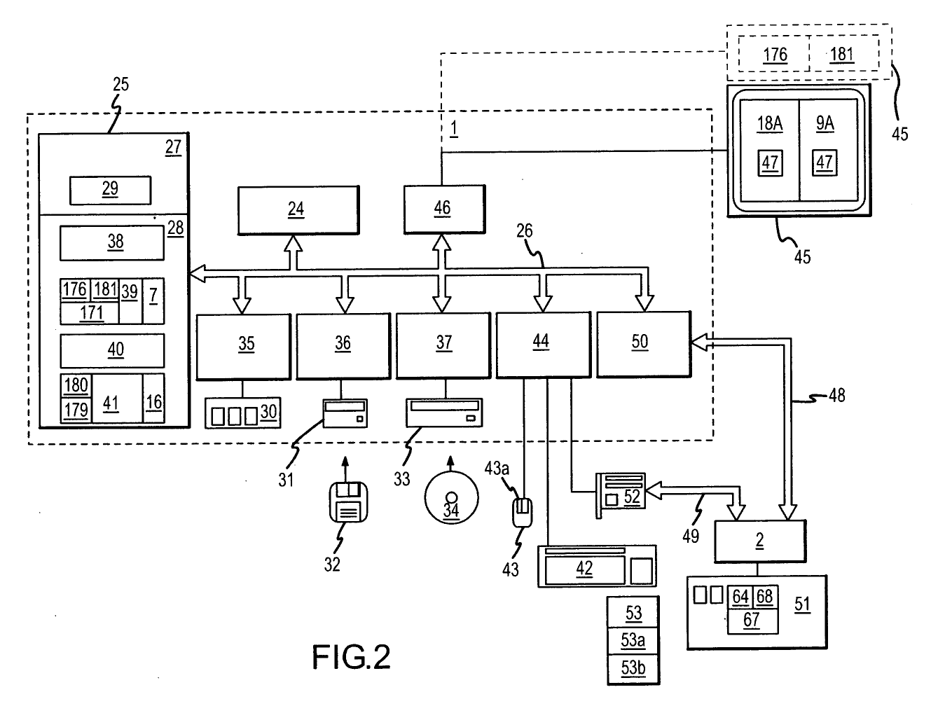

The motor vehicle titling inquiry author viewer (9) functions to display an motor vehicle inquiry author image representation (9a)(see FIGS. 2-5 which show but one non-limiting example) which includes a plurality of inquiry fields (13)(a representative number of the fields labeled) each having a inquiry field identifier (13d). The first module (8) of the motor vehicle titling inquiry author (7) further functions to allow a corresponding one of a plurality of motor vehicle titling data elements (11)(such as name, address, vehicle type, vehicle weight, lienholder, or other motor vehicle titling data elements as shown in the Figures, or required as part of a motor vehicle titling inquiry (14)) pertaining to a motor vehicle titling event (12) to be established in a corresponding one of the a plurality of inquiry fields (13). Each one of the plurality of motor vehicle data elements (11) can be established in the corresponding one of the plurality of inquiry fields (13) manually by keystroke, click event from drop down lists (13a), click event of bullets (13b), or the like, or automatically populated from a second motor vehicle database (67). The second module (10) of the motor vehicle titling inquiry author (7) generates a motor vehicle titling inquiry (14) based upon the inquiry field identifiers (13d) and the plurality of motor vehicle titling data elements (11) established in each of the plurality of inquiry fields (13).

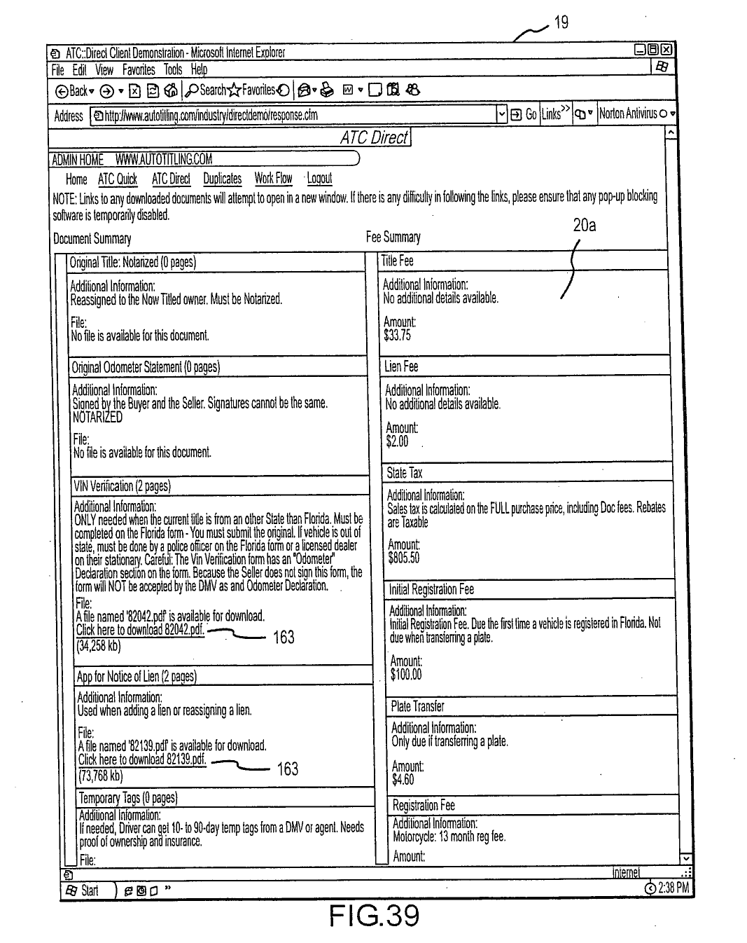

The first computer (1) can receive the titling instruction inquiry (14) and utilize the motor vehicle titling instructions server (5) to perform a sort of a plurality of motor vehicle titling data entities (15) stored in a motor vehicle titling database (16) based on the motor vehicle titling inquiry (14) which utilizes the inquiry field identifiers (13d) along with motor vehicle titling data elements (11) to correspondingly match one or more of a plurality of motor vehicle titling data entity identifiers (17) further described below. The plurality of motor vehicle titling data entities (15) retrieved by sort of the motor vehicle titling database (16) based on the motor vehicle titling inquiry (14) can be utilized to generate a motor vehicle titling instruction (20) which can be received by the second computer (2). A third module (18) of the motor vehicle titling inquiry author (7) functions to provides as an application interface a motor vehicle titling instruction viewer (19) which displays a motor vehicle titling instruction image representation (20a) such that the user (53) can view the a plurality of motor vehicle titling data entities (15) retrieved by application of the motor vehicle titling inquiry (14) to the motor vehicle titling database (16). A particular example of the motor vehicle titling instruction image representation (20a) is shown in FIG. 39.

Certain embodiments of the invention can further provide the email server (6) which allows electronic mailing of an e-mail document (21) containing a universal resource locator (URL)(23) which can be utilized by an e-mail recipient (22) (by click event) to access the titling instructions server (5), the web server (6), or both, to utilize the motor vehicle titling viewer (19) to display motor vehicle titling instruction image representation (20a) pertaining to a particular motor vehicle titling event (12).

A preferred embodiment of the invention provides a titling instruction inquiry author (7) which utilizes XML to generate packets for interoperability and connectivity between the first computer (1) and the second computer (2)(see Examples 1-3). As to each type of user (53)(dealer entity, financial entity, consumer entity, or the like), a different version of the titling instruction inquiry author (7) can be developed with an XML schema (or other standard markup language schema) based upon characteristics of the user operating system, the database currently available in the second computer (2), the types of motor vehicle titling events (12), or other factors related to the user (53), the second computer (2), or the motor vehicle titling event (12) to access the relevant portion of the motor vehicle titling database (16) or the second motor vehicle titling database (67). Importantly, each inquiry field identifier (13d) when supported by a properly configured title instruction inquiry author (7) as an XML schema, or other standard markup language, can be applied to motor vehicle database (78) to generate the motor vehicle titling instructions (17) which can include a part of the a plurality of motor vehicle titling data entities (15) without limitation motor vehicle title registration application forms which may be PDF data entities (91) having data entity fields (88) which can be populated with data field entities (89) or motor vehicle data elements (11) consistent with every department of motor vehicles in every state of the United States.

Now referring primarily to FIG. 2, a broad overview of certain computer means and certain network means which can be utilized to practice various embodiments of the invention is provided. While the computer means and the network means shown in FIG. 2 can be utilized to practice preferred embodiments of the invention including the best mode, it is not intended that the description of the best mode of the invention or any preferred embodiment of the invention be limiting with respect to the utilization of a wide variety of similar, different, or equivalent computer means or network means to practice embodiments of the invention which include without limitation hand-held devices, such as personal digital assistants or camera/cell phone, multiprocessor systems, microprocessor-based or programmable consumer electronics, network PCs, minicomputers, mainframe computers, and the like.

Similarly, it is not intended that embodiments of the invention be practiced in only wide area computing environments or only in local computing environments, but rather the invention can be practiced in local computing environments or in distributed computing environments where functions or tasks are performed by remote processing devices that are linked through a communications network. In a distributed computing environment, program modules may be located in both a local or in a remote memory storage device(s) or device elements. Also while a preferred embodiment of the invention is described in the general context of computer-executable instructions such as program modules which utilize routines, programs, objects, components, data structures, or the like, to perform particular functions or tasks or implement particular abstract data types, or the like, being executed by the computer means and network means, it is not intended that any embodiments of the invention be limited to a particular set of computer-executable instructions or protocols.

Again referring to FIG. 2, the first computer (1) can provide a processing unit (24), a memory element (25), and a bus (26) which operably couples components of the first computer (1), including without limitation the memory element(s) (25) to the processing unit (24). The first computer (1) may be a conventional computer, a distributed computer, or any other type of computer; the invention is not so limited. The processing unit (24) can comprise one central-processing unit (CPU), or a plurality of processing units which operate in parallel to process digital information. The bus (26) may be any of several types of bus configurations including a memory bus or memory controller, a peripheral bus, and a local bus using any of a variety of bus architectures. The memory element (25) can without limitation be a read only memory (ROM) (27) or a random access memory (RAM) (28), or both. A basic input/output system (BIOS) (29), containing routines that assist transfer of data between the components of the first computer (1), such as during start-up, can be stored in ROM (27). The first computer (1) can further include a hard disk drive (30) for reading from and writing to a hard disk (not shown), a magnetic disk drive (31) for reading from or writing to a removable magnetic disk (32), and an optical disk drive (33) for reading from or writing to a removable optical disk (34) such as a CD ROM or other optical media.

The hard disk drive (30), magnetic disk drive (31), and optical disk drive (33) can be connected to the bus (26) by a hard disk drive interface (35), a magnetic disk drive interface (36), and an optical disk drive interface (37), respectively. The drives and their associated computer-readable media provide nonvolatile storage of computer-readable instructions, data structures, program modules and other data for the first computer (1). It can be appreciated by those skilled in the art that any type of computer-readable media that can store data that is accessible by a computer, such as magnetic cassettes, flash memory cards, digital video disks, Bernoulli cartridges, random access memories (RAMs), read only memories (ROMs), and the like, may be used in a variety of operating environments.

A number of program modules may be stored on the hard disk, magnetic disk (32), optical disk (34), ROM (27), or RAM (28), including an operating system (38), one or a plurality of application programs (39) without limitation the motor vehicle titling inquiry author (7) or other program interfaces, other program modules (40), and the program data (41) including but not limited to the motor vehicle titling database (16) which may be served by the titling instructions server (5). A user may enter commands and information into the first computer (1) through input devices such as a keyboard (42) or a pointing device such as a mouse (43). Other input devices (not shown) may include a microphone, joystick, game pad, satellite dish, scanner, or the like. These and other input devices are often connected to the processing unit (24) through a serial port interface (44) that can be coupled to the bus (26), but may be connected by other interfaces, such as a parallel port, game port, or a universal serial bus (USB). A monitor (45) or other type of display device can also be connected to the bus (26) via an interface, such as a video adapter (46), or the like. In addition to the monitor (45), the first computer (1) can further include other peripheral output devices (not shown), such as speakers and printers.

A “click event” occurs when the user operates a application function through the use of a command which for example can include pressing or releasing the left mouse button (43a) while a pointer is located over a control icon (47)(or other field which activates a function) displayed in the a motor vehicle titling inquiry author viewer image representation (9a) or the a motor vehicle titling viewer image representation (18a) (or display generated by another application or program) in the monitor (45). However, it is not intended that a “click event” be limited to the press and release of the left button (43a) on a mouse (43) while a pointer is located over a control icon (47), rather, a “click event” is intend to broadly encompass a command by the user through which a function of an application program (39)(or other program, application, module or the like) including without limitation the motor vehicle titling inquiry author (7) can be activated or performed, whether through selection of one or a plurality of control icon(s) (47) or by user voice command, keyboard (42) stroke, mouse button (43a), or otherwise. It is further intended that control icons (47) can be configured or displayed without limitation as a bullets, point, a circle, a triangle, a square (or other geometric configurations or combinations or permutations thereof), or as fields in which addresses such as a street address, zip code, county code, or natural area code, or inputting a latitude/longitude or projected coordinate X and Y, or other notation, script or character, motor vehicle titling data elements (11), or the like, can be entered manually or by operation of an application program (39) such as the motor vehicle titling inquiry author (7) or use of the graphic user interfaces generated by the tax management application program (171) or any part, portion or element thereof.

The first computer (1) may operate in a networked environment using logical connections (48) or (49), or both, to one or a plurality of second computers (2). These logical connections (48) or (49) are achieved by a communication device (50) coupled to or a part of the first computer (1); the invention is not limited to a particular type of communications device (50). The second computer (2) may be another computer, a server, a router, a network PC, a client, a peer device or other common network node, and can include a part or all of the elements above-described relative to the first computer (1), although only a memory storage device (51) has been illustrated in FIG. 2. The logical connections (48)(49) depicted in FIG. 2 can include a local-area network (LAN) or a wide-area network (WAN). Such networking environments are commonplace in offices, enterprise-wide computer networks, intranets and the Internet.

When used in a LAN-networking environment, the first computer (1) can be connected to the local network through a network interface or adapter, which is one type of communications device (50). When used in a WAN-networking environment, the first computer (1) typically includes a modem (52), a type of communications device, or any other type of communications device for establishing communications over the wide area network, such as the Internet (3)(shown in FIG. 1). The modem (52), which may be internal or external, is connected to the bus (26) via the serial port interface (44). In a networked environment, program modules depicted relative to the first computer (1), or portions thereof, may be as to certain embodiments of the invention be stored in the second computer memory element (51). It is appreciated that the network connections shown are exemplary and other means of and communications devices for establishing a communications link between the computers can be used.

Now referring again primarily to FIG. 1, the second computer (2) can encompass a single second computer or can encompass a plurality of second computers which can be operated by a computer user (53) which can be without limitation a person, a plurality of persons, a business entity, a titling entity as above-described, or otherwise, which desires access to motor vehicle titling instructions (20) generated by the motor vehicle titling instructions server (5).

As above-described, the laws, rules or regulations, tax rates, or other requirements of a motor vehicle title registration application vary between state, county, city, locality or other type of motor vehicle jurisdiction and by the particulars of the motor vehicle titling event (12). The plurality of motor vehicle titling data entities (15) that must be stored in the motor vehicle titling database (16) to allow generation of a complete motor vehicle titling instruction (20) in response to all the permutations and combinations of parameters conveyed by the motor vehicle titling inquiry (14) the plurality of motor vehicle titling data entities (15) can encompass a very large number of data entities. As such, it is essential to have an effective motor vehicle titling program architecture to manage the plurality of motor vehicle titling data entities (15) stored in the motor vehicle titling database (16) and retrieved by application of the a motor vehicle titling inquiry (14) to generate the motor vehicle titling instruction (20) for the particular motor vehicle titling event (12) in a particular motor vehicle jurisdiction.

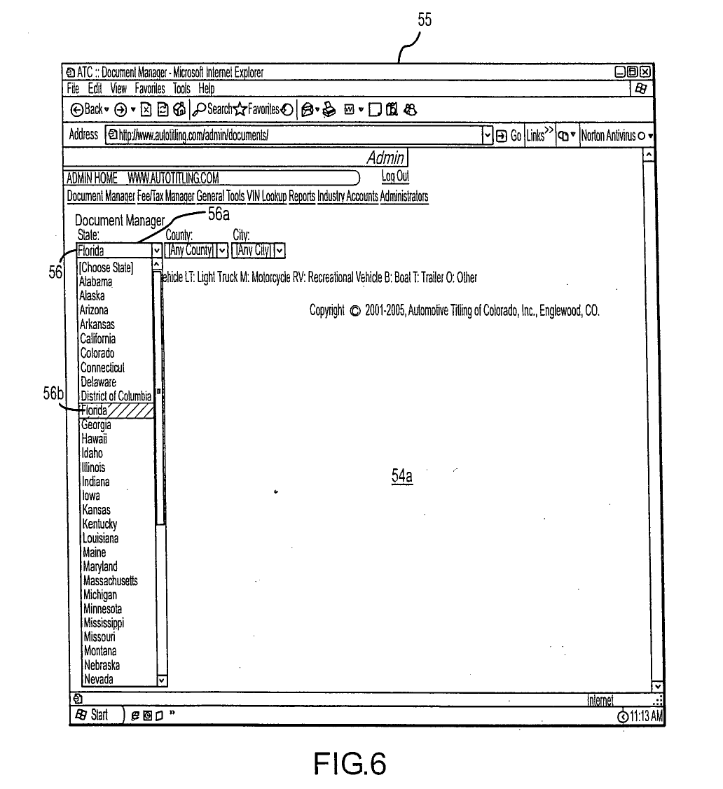

Now referring again to FIGS. 1 and 6, the first computer (1) can further include motor vehicle titling data entity manager (54) which can operate to couple at least one motor vehicle data entity identifier (17) to each of the plurality of motor vehicle titling data entities (15). The motor vehicle titling data entity manager (54) can generate a motor vehicle titling data manager viewer (55) which provides a first level manager architecture (54a) which differentiates the plurality of motor vehicle titling data entities (15) between a plurality of geographic entities. The boundaries of each geographic entity defined by the utilization of a corresponding first set of motor vehicle registration application requirements. For example, in the United States, each state establishes the motor vehicle registration requirements utilized within geographic area encompassed by its border.

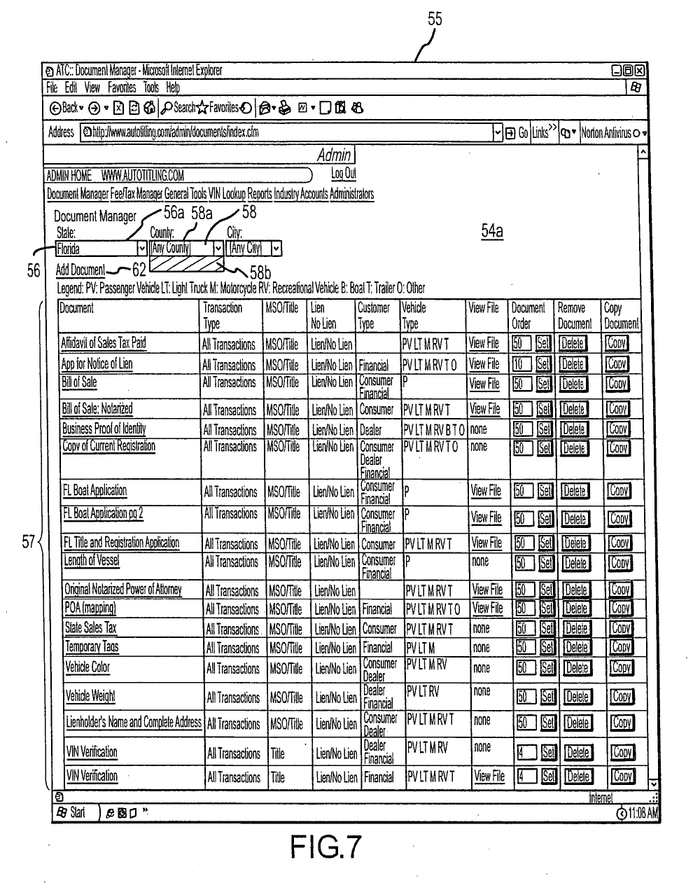

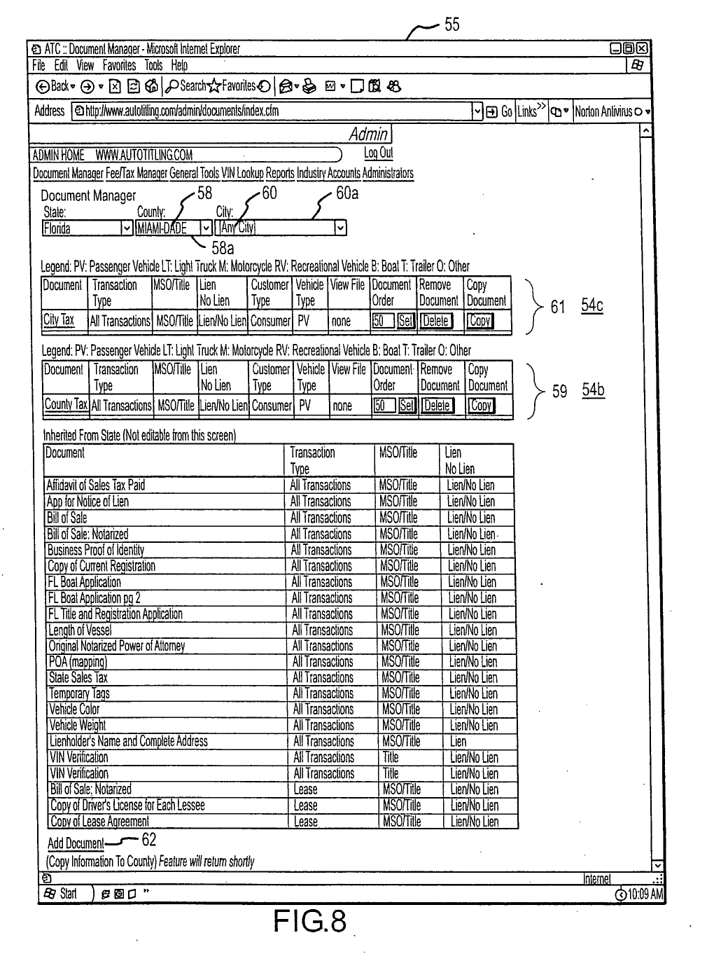

Now referring primarily to FIGS. 1 and 6, which provides a non-limiting example of a first level manager architecture (54a) for the storage and sort of the plurality of motor vehicle data entities (15) based on a state motor vehicle data entity identifier (56). The state motor vehicle identifier (56)(as an example “Florida”) can be entered into a corresponding state identifier field (56a) whether the click event is a drop down list of states (56b) as shown (or other list of motor vehicle jurisdictions), by manual entry, or otherwise. Entry of a state motor vehicle data entity identifier (56) in the state identifier field (56a) initiates sort of the plurality of motor vehicle titling data entities (15) in the motor vehicle titling database (16) based on the state motor vehicle data entity identifier (56) and generates a state data entity list (57) (shown in FIG. 7) which identifies the part of the plurality of motor vehicle titling data entities (15) coupled to that particular state motor vehicle data entity identifier (56).

As shown by FIG. 7, the specific state motor vehicle data entity identifier (56) “Florida” was selected which retrieved a state data entity list (57) including that part of the plurality of motor vehicle titling data entities (15) for the motor vehicle jurisdiction of the State of Florida. While this specific example is provided of a first level manager architecture (54a) it is not intended that the first level manager architecture (54a) be limited to the use of a state motor vehicle data entity identifier (56) and each of a plurality of geographic entities each correspondingly defined by utilization of the same motor vehicle registration application requirements can be matched to a geographic motor vehicle data entity identifier which can be coupled to the plurality of motor vehicle titling data entities (15) for that geographic entity to establish the first level manager architecture (54a).

Now referring primarily to FIGS. 1, 7 and 8, a second level manager architecture (54b) provides for the storage and sort of the plurality of motor vehicle data entities (15) retrieved by the first level manager architecture (54a) and further based on differentiating between a plurality of second regions within the geographic entity, the boundaries each defined by the application of a second set of registration application requirements. In the non-limiting example shown, a county motor vehicle data entity identifier (58) can be entered into a corresponding county identifier field (58a) whether the click event provides a list of counties (58b) as shown by FIG. 7 (or other list of county motor vehicle identifiers), by manual entry, or otherwise. Entry of a county motor vehicle data entity identifier (58) in the county identifier field (58a) initiates sort of the plurality of motor vehicle titling data entities (15) in the motor vehicle titling database (16) based on the county motor vehicle data entity identifier (58) and generation of a county data entity list (59) of the plurality of motor vehicle titling data entities (15) coupled to that particular state motor vehicle data entity identifier (56) and the county motor vehicle data entity identifier (58). As shown by FIG. 8, the county motor vehicle data entity identifier (58) “Miami-Dade” was selected which retrieved from the plurality of motor vehicle titling data entities (15) that part of the plurality of motor vehicle data entities (15) utilized only by the County of Miami-Dade, Florida and generated a separate county data entity list (59). In the example, only a single one of the plurality of motor vehicle data entities (15) was retrieved in the second level manager architecture (54b) relating to county tax.

Again referring primarily to FIGS. 1 and 8, a third level manager architecture (54c) provides for the storage and sort of the plurality of motor vehicle data entities (15) retrieved by the second level architecture (54b) and further based on differentiating a plurality of third regions within each second region the boundaries of each defined by the application of a third set of registration application requirements. The non-limiting example of a third level manager architecture (54c) provides a city or locality motor vehicle data entity identifier (60) which can be entered into a corresponding city or locality identifier field (60a) whether by click event within a list of cities (or other list of city or locality motor vehicle jurisdictions), by manual entry, or otherwise. Entry of a city motor vehicle data entity identifier (60) in the city identifier field (60a) initiates sort of the plurality of motor vehicle titling data entities (15) in the motor vehicle titling database (16) based on the city motor vehicle data entity identifier (60) and generation of city data entity list (61) of the plurality of motor vehicle titling data entities (15) coupled to the state motor vehicle data entity identifier (56), the county motor vehicle data entity identifier (58) and the particular city motor vehicle data entity identifier (60). For example, entry of the city motor vehicle data entity identifier (60) such as “Miami” can retrieve a city data entity list (61) including that part of the plurality of motor vehicle titling data entities (15) for the City of Miami, in Miami-Dade County, State of Florida.

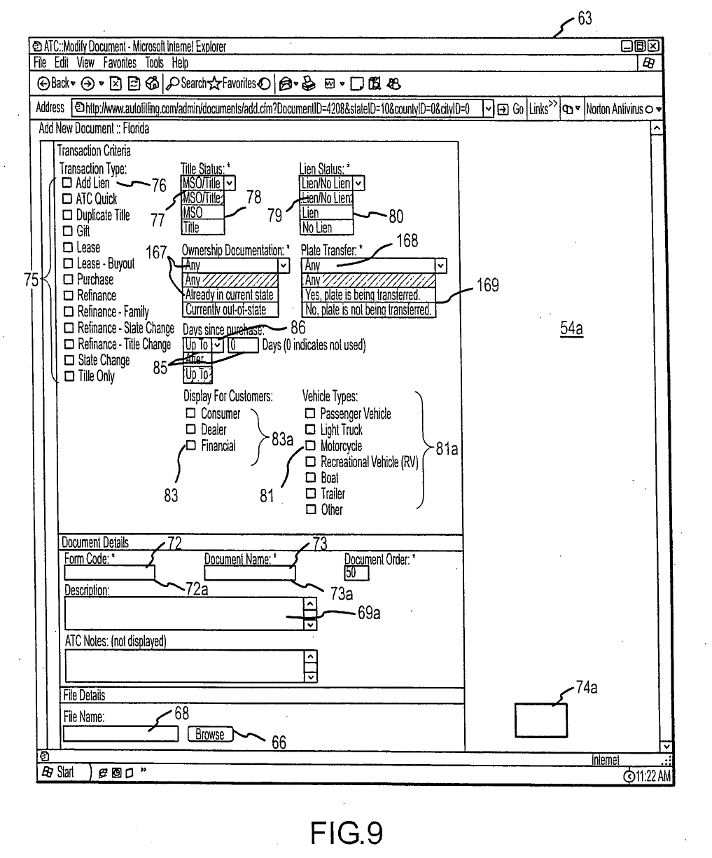

Now referring primarily to FIGS. 1, 7-9, at each of the first level, second level, or third level manager architecture (54a)(54b)(54c) above described (non-limiting examples of State (54a), County(54b), City (54c) provided), the motor vehicle titling data entity manager (54) can further provide an add data entity function (62) which upon click event operates to open an add data entity viewer (63)(an embodiment shown in FIG. 9) which can operate within each of the first level, second level or third level manager architecture (54a)(54b)(54c) to correspondingly couple a state motor vehicle data entity identifier (56), a county motor vehicle data entity identifier (58), or city motor vehicle data entity identifier (60)(or other identifiers as above discussed) to an added data entity (64) and store the added data entity (64) with the plurality of motor vehicle titling data entities (15) in the motor vehicle titling database (16).

Now referring primarily to FIGS. 1 and 9, the embodiment of the add data entity viewer (63) shown has been opened at the first level manager architecture (54a) by entering a state motor vehicle data entity identifier (56) into the state identifier field (56a) motor vehicle titling data entity viewer (55). By operating the add data entity function (62) by click event, the add data entity function (62) can further provide a browser function (65) which can be operated in the add data entity viewer (63) by click event for example on a browse icon (66) which allows the added data entity (64) to be selected from a second motor vehicle data base (67)(see FIG. 2), for example a state motor vehicle department database, and loaded into the add data entity viewer (63). The added data entity (64) can be any one of the numerous and varied types of data files (68) such as a word file, a word perfect file, a pdf file, or the like. Alternately, the added data entity (64) can comprise any type of content entered manually into a data entity author field (69a) generated by a data entity author (69) in the add data entity viewer (63). Whether the added data entity (64) is loaded into the add data entity viewer (63) as data file (68) or authored in the data entity author field (69a) provided by the data entity author (69), the added data entity function (62) further provides an added data entity form code identifier function (70) and a data entity name identifier function (71) which can be used independently or in combination to couple a corresponding data entity form code (72) or a data entity name identifier (73) entered into the corresponding data entity form code field (72a) or data entity name identifier field (73a) to the added data entity (64). The add data entity function (62) further provides a data entity storage function (74) which operates by click event of for example a data entity storage icon (74a) to store the added the data entity (64) coupled to the data entity name identifier (73) or the data entity form code identifier (74)(or both) to the plurality of motor vehicle titling data entities (15) in motor vehicle titling database (16). Operation of the data entity storage function (74) in the add data entity viewer (63) opened at the first level manager architecture (54a) as above-described further couples that particular state motor vehicle data entity identifier (56) to the added data entity (64). Subsequent entry of the state motor vehicle data entity identifier (56) into a corresponding state identifier field (56a) sorts the plurality motor vehicle titling data entities (15) and generates the state data entity list (57) which further includes the added data entity (64).

Similarly, if the add data entity function (62) is operated by click event in the second level manager architecture by entering the county motor vehicle data entity identifier (58) or in the third level manager architecture by entering the city motor vehicle data entity identifier (60), added data entities (64) can be stored with the plurality of motor vehicle titling data entities (15) in the motor vehicle titling database (16) and retrieved as part of the corresponding county data entity list (59) or city data entity list (61) by subsequently entering the county motor vehicle data entity identifier (58) or the city motor vehicle data entity identifier (60)(or both) into the corresponding county motor vehicle data entity identifier field (58a) or the city motor vehicle data entity identifier field (60a) of the motor vehicle titling data entity viewer (55).

Again referring primarily to FIG. 9, the add data entity function (62) can further operate within each of the first, second, or third level manager architecture (54a)(54b)(54c) to couple one or more of a plurality of transaction identifiers (75) to the added data entity (64) to further differentiate the added data entity (64) within the plurality of motor vehicle titling data entities (15) based on motor vehicle titling transaction condition or type. The add data entity viewer (63) can provide the list of the plurality of transaction identifiers (75)(such as “add lien”, “duplicate title”, “gift”, “lease”, lease-buyout”, “purchase”, “refinance”, “refinance-family”, “refinance-state change”, “refinance-title change”, “state change”, “title only”, or other transaction type”) utilized in a geographic entity or region. Each discrete transaction identifier (76)(a representative number labeled) can be selected by click event to couple the discrete transaction identifier (76)(“add lien” for example) to the added data entity (64). The term “a plurality of transaction identifiers” means a set of discrete transaction identifiers (76) each of which identifies a discrete transaction condition or type which can occur in filing a motor vehicle title registration application in a geographic entity or region identified by use of the first, second, or third level manager architecture (54a)(54b)(54c) such discrete transaction condition requiring inclusion of the added data entity (64) or a part of the plurality of motor vehicle titling data entities (15) to which the discrete transaction identifier (76) is coupled to complete the motor vehicle title registration application.

Again referring primarily to FIG. 9, the add data entity function (62) can further operate within each of the first, second, or third level manager architecture (54a)(54b)(54c) to couple a title status identifier (77) to the added data entity to further differentiate the added data entity (64) in the plurality of motor vehicle data entities (15) based on a title condition such as a vehicle not prior titled, a vehicle prior titled, or both. The add data entity viewer (63) can provide a title status identifier list (78). By click event on the title status identifier (77) in the list the title status identifier can be coupled to the added data entity (64). As shown by the example of the add data entity viewer (63) in FIG. 9, a MSO title status identifier can differentiate one or more of the plurality motor vehicle titling data entities (15) utilized to register a motor vehicle not prior titled (typically requiring the motor vehicle dealer to provide as additional motor vehicle titling data entities (15): a manufacturer's statement of origin “MSO”, a proof of sales tax paid, a proof of exemption, or notice that sales tax must be collected, for inclusion in the motor vehicle title registration application); a Title status identifier (which differentiates the motor vehicle data entities (15) utilized to register a vehicle prior titled), or an MSO/Title title status identifier (which differentiates the motor vehicle titling data entities (15) utilized for both vehicles not prior titled and prior titled vehicles) can be selected and coupled to a added data entity (64) or one of the plurality of motor vehicle data entities (15) by click event.

Again referring primarily to FIG. 9, the add data entity function (62) can further operate within each of the first, second, or third level manager architecture (54a)(54b)(54c) to couple a lien status identifier (79) to the added data entity (64) to further differentiate the added data entity (64) in the plurality of motor vehicle data entities (15). The add data entity viewer (63) can provide a lien status identifiers list (80) from which one lien status identifier can by click event be coupled to the added data entity (64). As shown by the example of the add data entity viewer (63) shown by FIG. 9, a Lien status identifier (which identifies the lien condition in which a loan has been made for the purchase of a motor vehicle); a No Lien status identifier (which identifies the lien condition in which no loan has been made for the purchase of the vehicle), or both an No Lien/Lien title status identifier can be selected and coupled to a added data entity (64) or one of the plurality of motor vehicle data entities (15) by click event.

Again referring to FIG. 9, the add data entity function (62) can further operate within each of the first, second, or third level manager architecture (54a)(54b)(54c) to couple a vehicle identifier (81) to the added data entity to further differentiate the added data entity (64) by the type of vehicle. The add data entity viewer (63) can provide a list of the vehicle identifiers (81a) one of which can be coupled to the added data entity (64) by click event on the vehicle identifier (81) in the list. As shown by the example of the add data entity viewer in FIG. 9, a vehicle identifier (81) which identifies the type of vehicle such as a passenger vehicle, a light truck, a motorcycle, a recreational vehicle, boat, trailer, or other can be selected and coupled to a added data entity (64) or one of the plurality of motor vehicle data entities (15) by click event.

Again referring to FIG. 9, the add data entity function (62) can further operate within each of the first, second, or third level manager architecture (54a)(54b)(54c) to couple a user identifier (83) to the added data entity (64) to further differentiate the added data entity (64) by user of the motor vehicle titling inquiry author (7). The add data entity viewer (63) can provide a user identifier list (83a) from which one user identifier (83) can be coupled to the added data entity (64) by click event on the user identifier (83). As shown by the example of the add data entity viewer shown by FIG. 9, a Consumer user identifier (which identifies a person in the general public), a Dealer user identifier (which identifies a motor vehicle dealer entities), a Financial user identifier (which identifies financing entities such as banks, lenders, or the like) can be selected and coupled to a added data entity (64) or one of the plurality of motor vehicle data entities (15) by click event. This allows the plurality of plurality of motor vehicle titling data entities (15) to be sorted based on specific requirements of the particular user (53) type.

Again referring to FIG. 9, the add data entity function (62) can further operate within each of the first, second, or third level manager architecture (54a)(54b)(54c) to couple a time period identifier (85) to the added data entity (64). The add data entity viewer (63) can provide a time period identifier list (86) from which one time period identifier (85) can be coupled to the added data entity (64) by click event on the time period identifier (85). As shown by the example of the add data entity viewer (63) in FIG. 9, an “up to” identifier which can be used to identify certain of the plurality motor vehicle titling data entities (15) which can be used until the specified time period elapses (such as the elapse of a certain number days after purchase of the vehicle) and an “after” identifier which identifies plurality motor vehicle titling data entities (15) which must be used after the elapse of a specified time period (such as after the elapse of a certain number days after purchase of the vehicle) can each be selected by click event to be coupled to a added data entity (64) or one of the plurality of motor vehicle data entities (15).

Again referring to FIG. 9, the add data entity function (62) can further operate within each of the first, second, or third level manager architecture (54a)(54b)(54c) to couple a ownership location identifier (166) to the added data entity (64). The add data entity viewer (63) can provide a state ownership identifier list (167) from which an ownership location identifier (166) can be coupled to the added data entity (64) by click event. As shown by the example of the add data entity viewer (63) in FIG. 9, an in-state ownership identifier differentiates certain of the plurality of motor vehicle titling data entities (15) based on the vehicle being titled within the motor vehicle jurisdiction of registration and an out-of-state ownership identifier differentiates certain of the plurality of motor vehicle titling data entities (15) based on the vehicle being titled outside of the motor vehicle jurisdiction of registration.

Again referring to FIG. 9, the add data entity function (62) can further operate within each of the first, second, or third level manager architecture (54a)(54b)(54c) to couple a plate transfer identifier (168) to the added data entity (64). The add data entity viewer (63) can provide a plate transfer identifier list (169) from which one plate transfer identifier (168) can be coupled to the added data entity (64) by click event. As shown by the example of the add data entity viewer (63) in FIG. 9, an plate transfer identifier allows differentiation of certain of the plurality of motor vehicle titling data entities (15) based on whether or not the license plate for the vehicle being registered is being transferred from another vehicle.

Understandably, certain added data entities (64) or certain of the plurality of motor vehicle titling data entities (15) could have a plurality of the identifiers above-described coupled while other added data entities (64) and certain of the plurality of motor vehicle titling data entities (15) may have only one or few of the identifiers coupled and will be retrieved of the motor titling instruction (20) only in the event the motor vehicle titling inquiry (14) includes a motor vehicle data element (11) matched to that particular transaction identifier(75)(or other identifier). By use of the architecture levels (54a)(54b)(54c) and by selectively coupling the various identifiers above-described to each added data entity (64) the resulting plurality of motor vehicle titling data entities (15) can be mapped against a limited plurality of inquiry fields (13) of the vehicle titling inquiry author (7) to produce the motor vehicle titling instruction (20) corresponding to a motor vehicle titling event.

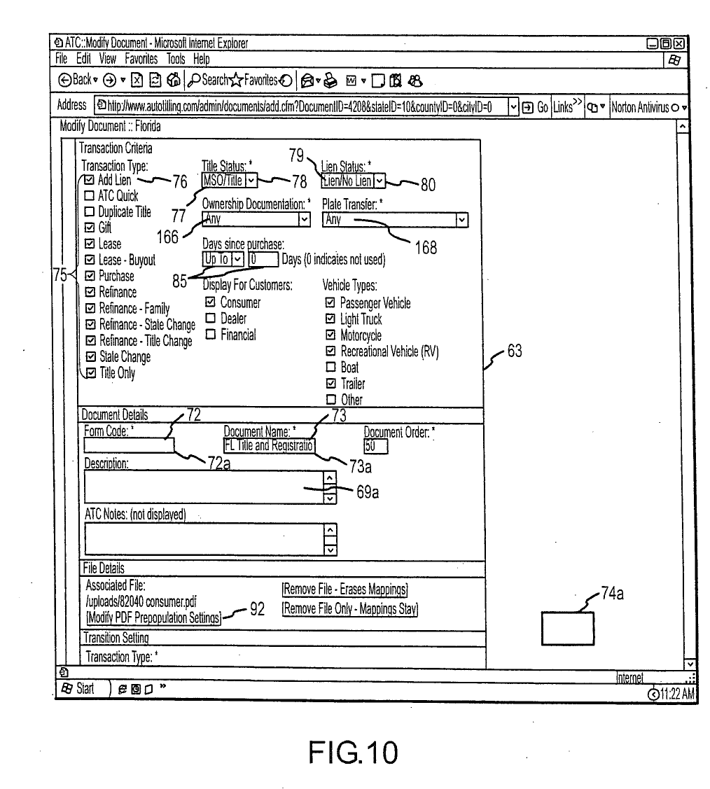

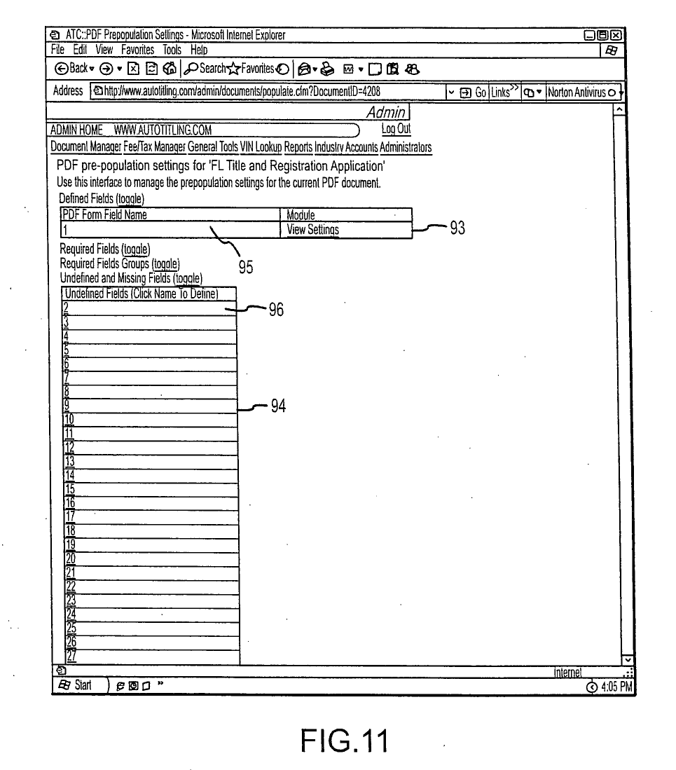

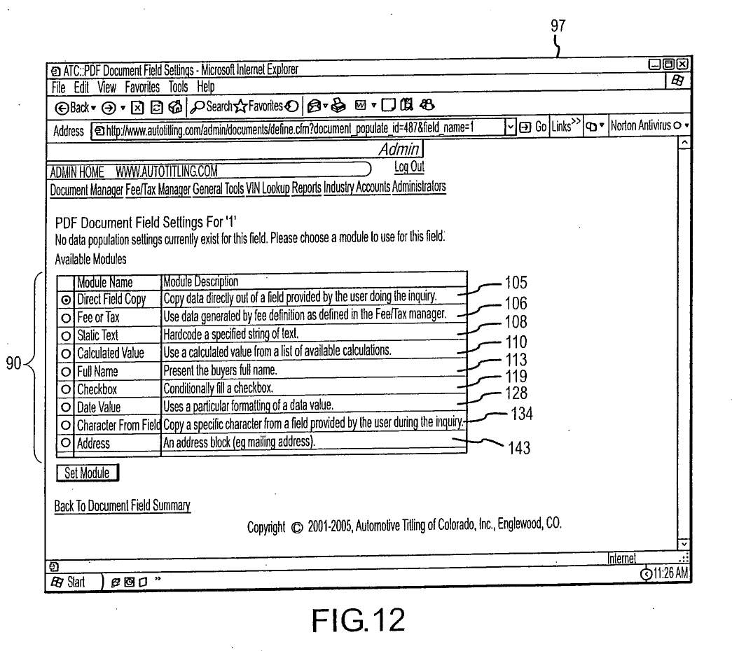

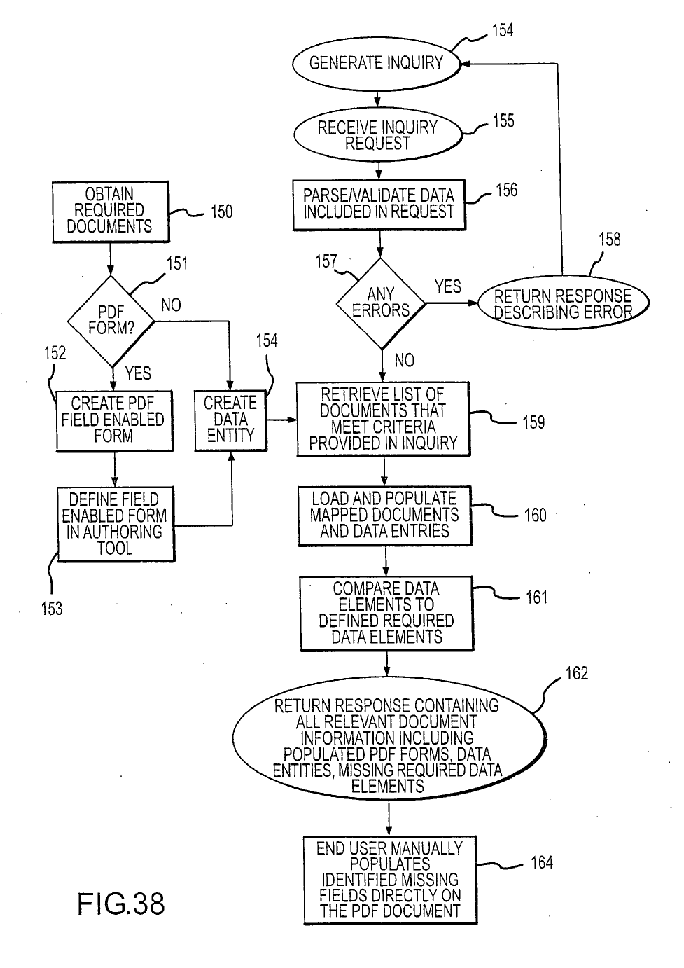

Now referring primarily to FIGS. 10 and 38, the add data entity function (62) further provides a data entity field population module (87) which allows the data entity fields (88) in certain of the plurality of motor vehicle titling data entities (15) or an added data entity (64) to be defined for population with data field entities (89) by utilizing one of a plurality of data field setting modules (90)(see for example FIG. 12). Now referring to FIGS. 1 and 9, in a first step (150)(see FIG. 38) a data entity (64) can be retrieved from a second data base (67) of a second computer (2) using the browser function (65) of the add data entity function (62). If the retrieved data entity is a Portable Document Forms (“PDF”) developed by Adobe Systems, in a second step (151)(see FIG. 38) the data entity fields (88) can be enabled utilizing the conventional Acrobat Systems form tool to name each data entity field (88). See “Adobe Acrobat Help-PDF Forms”, Creating Form Fields, p. 145-146, hereby incorporated in the entirety by reference herein. Enabling the data entity fields (88) as described allows the enabled PDF data entity (91) to be interactive with the data entity field population module (87) of the invention. In a third step (152), the data entity field population module (87) can activated by click event in the add data entity viewer (63) of a data entity field population module activation function (92)(shown in the embodiment of the add data entity viewer (63) as a “Modify PDF Pre-populations Setting” icon) to generate a viewable list of defined data entity fields (93)(see FIG. 11) and a viewable list of undefined data entity fields (94)(see FIG. 11) for the enabled PDF data entity (91) and further allows each of one of the defined data entity fields (95) or undefined data entity fields (96) to be selected by click event to provide a data field setting module viewer (97)(see FIG. 12) in which one of a plurality of data field setting modules (90) can be selected to define the data field entity (89) for the selected undefined data entity field (94). The third step is repeated to define each of the undefined data entity fields (94) in the enabled PDF data entity (91)(or as many of the undefined data entity fields (94) as necessary or desired). In a fourth step (153)(see FIG. 38) the PDF data entity (91) with defined data field entities (89) is then saved to the motor vehicle titling database (16) as one of the plurality of motor vehicle titling data entities (15).

In general, each of the plurality of data field setting modules (90) of the embodiment of the invention shown in FIG. 12 function upon click event to provide a field arguments viewer (98) which displays a field arguments list (99) in which all the field arguments (100) listed must be satisfied to define the data field entity (89) for the selected undefined data entity field (96) of the PDF data entity (91). Upon selection of each field argument (100) by click event a field argument setting viewer (101) can be displayed which provides all field argument settings (102) which can satisfy each field argument (100) selected. By selection of an argument setting (103) by click event or entering the field argument setting (103) manually in an argument setting field (104), the undefined data entity field (96) in the PDF data entity (91) with defined fields can be created and can upon subsequent retrieval be populated with one of the plurality of motor vehicle titling data elements (11) defined by the argument setting (103).

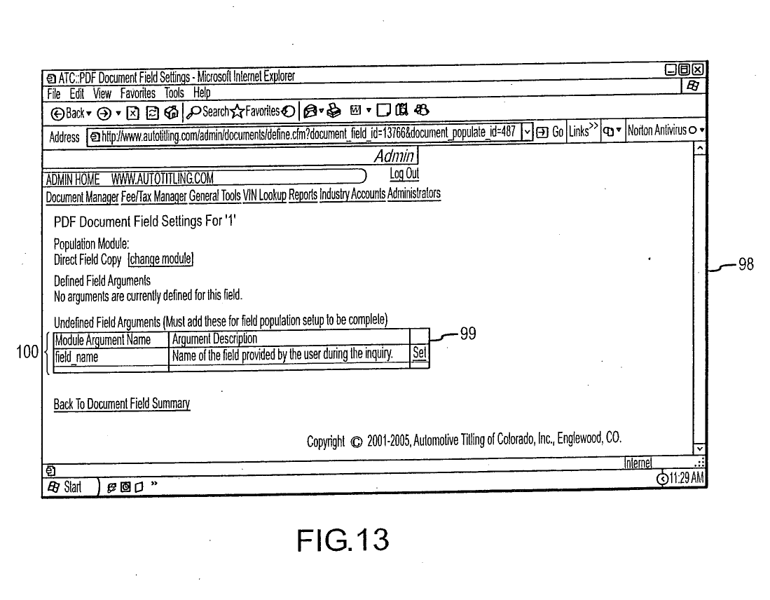

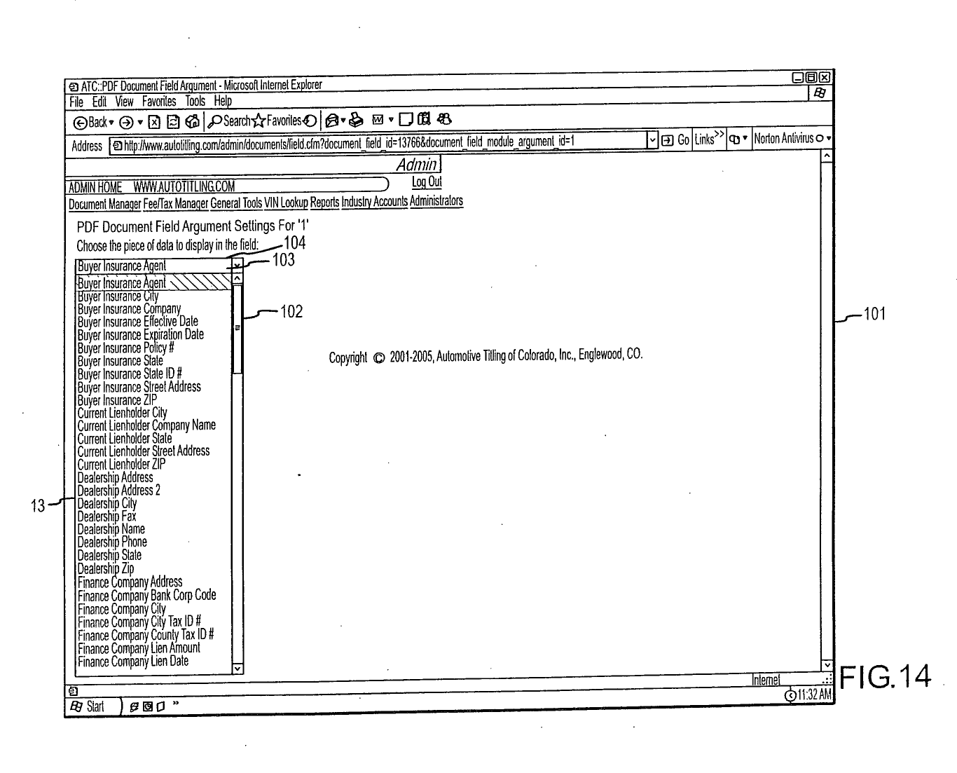

Now referring primarily to FIGS. 12, 13, and 14, a first of the plurality of data field setting modules (90) comprises a direct field copy module (105) which functions by click event to generate the corresponding field argument viewer (98) (an embodiment shown in FIG. 13) and by click event of one of the field arguments (100) using the “set” icon in the embodiment shown, the corresponding argument setting viewer (101) (an embodiments shown in FIG. 14) further generates a list of all field argument settings (102) which includes the plurality of inquiry fields (13) of the motor vehicle titling inquiry author viewer (9). One of the plurality of inquiry fields (13) can be selected by click event to establish the field argument setting (103) for the selected undefined data entity field (96) of the enabled PDF data entity (91). Subsequent retrieval of the enabled PDF data entity (91) with the defined data entity field (95) allows the population of the defined data entity field (95) by direct copy of the motor vehicle titling data element (11) established in the one of the plurality of inquiry fields (13) selected as the field argument setting (103).

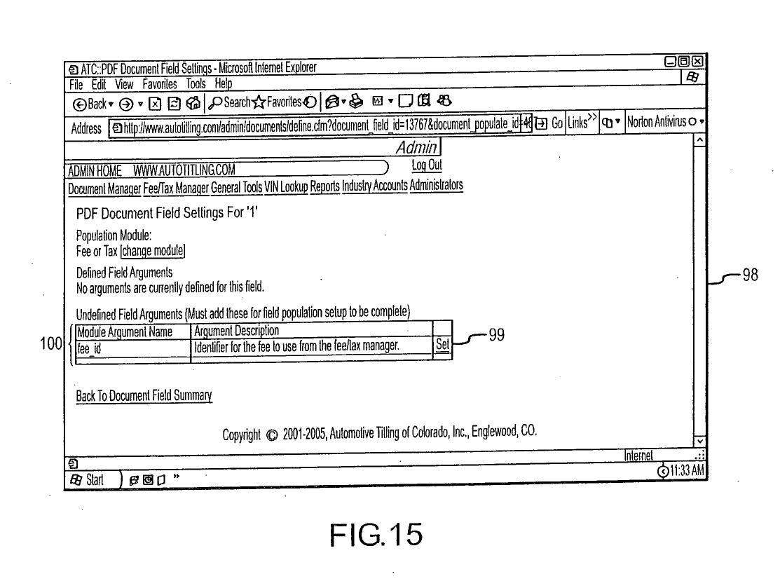

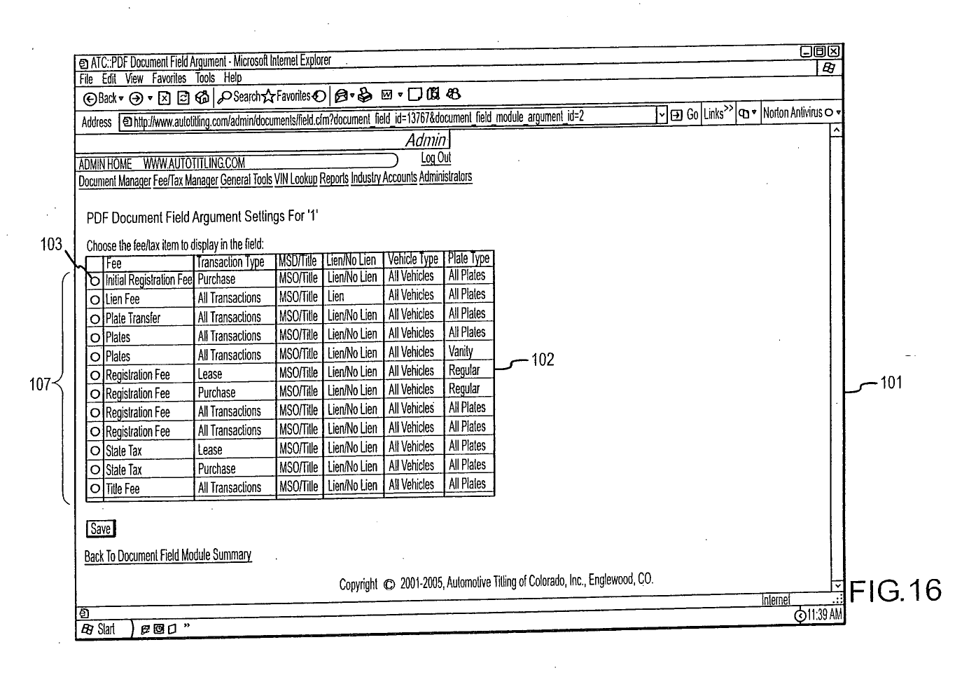

Now referring primarily to FIGS. 12, 15, and 16, a second of the plurality of data field setting modules (90) comprises a fee-tax module (106) which operates by click event to generate the corresponding field argument viewer (98) (an embodiment shown in FIG. 15) and by click event of one of the field arguments (100) using the “set” icon in the embodiment shown, the corresponding argument setting viewer (101) (an embodiment shown in FIG. 16) can further generate a field argument settings list (102) which includes a plurality of fee-tax calculators (107). One of the plurality of fee tax-calculators (107) can be selected by click event to establish the field argument setting (103) for the undefined data entity field (96) of the enabled PDF data entity (91). Subsequent retrieval of the enabled PDF data entity (91) with the defined data entity field (95) allows the population of the defined data entity field (95) with the fee or tax calculated by the selected one of the plurality of fee-tax calculators (107) corresponding to the first, second, or third architectural manager level (State, County, or City) in which the add data entity function (62) was activated by click event (as above described).

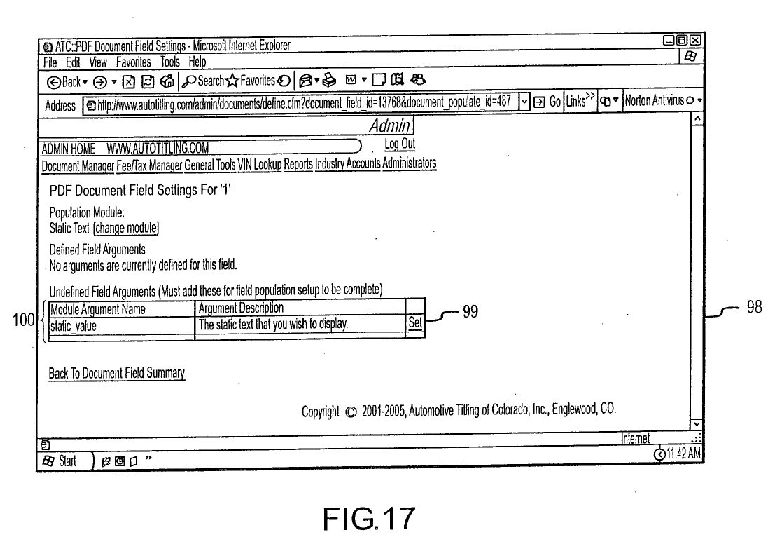

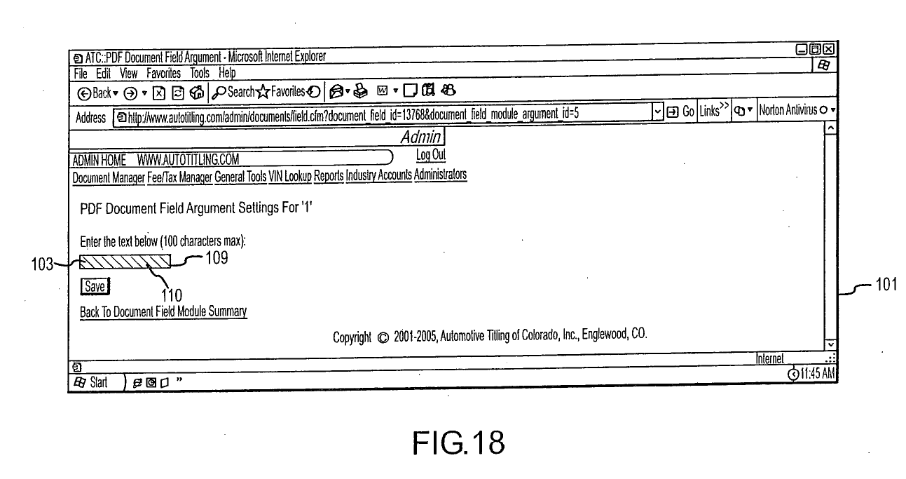

Now referring primarily to FIGS. 12, 17 and 18, a third of the plurality of data field setting modules (90) comprises a static text module (108) which operates by click event to generate a corresponding field argument viewer (98)(an embodiment shown in FIG. 17) and by click event of one of the field arguments (100) using the “set” icon in the embodiment shown, the corresponding argument setting viewer (101)(an embodiment shown in FIG. 18) further generates a static text field (109) which by entry of static text (110) establishes the field argument setting (103) for the selected undefined data entity field (96) of the enabled PDF data entity (91). Subsequent retrieval of the enabled PDF data entity (91) with the defined data entity field (95) allows population of the defined data entity field (95) with the static text (110) entered into the static text field (109).

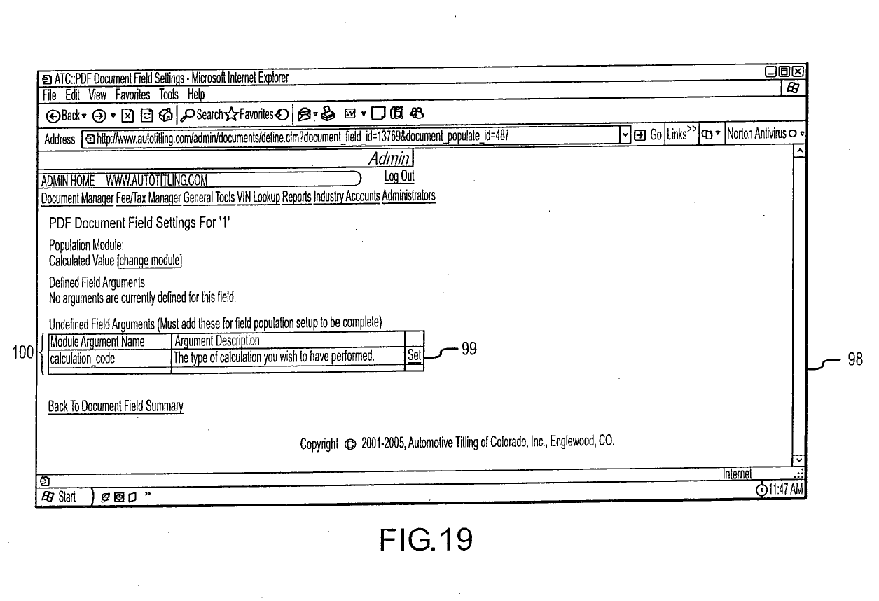

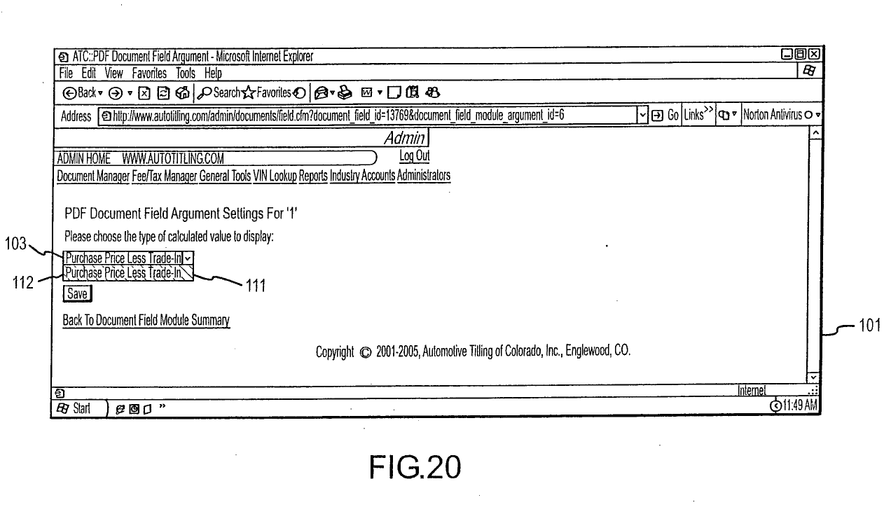

Now referring primarily to FIGS. 12, 19 and 20, a fourth of the plurality of data field setting modules (90) comprises a calculated value module (110) which operates by click event to generate a corresponding field argument viewer (98)(an embodiment shown in FIG. 19) and by click event of one of the field arguments (100) using the “set” icon in the embodiment shown, the corresponding argument setting viewer (101)(an embodiment shown in FIG. 20) further generates a value calculator list (111) the value calculator (112) selected by click establishes the field argument setting (103) for the selected undefined data entity field (96) of the enabled PDF data entity (91). Subsequent retrieval of the enabled PDF data entity (91) with the defined data entity field (95) allows population of the defined data entity field (95) with the calculated value (112).

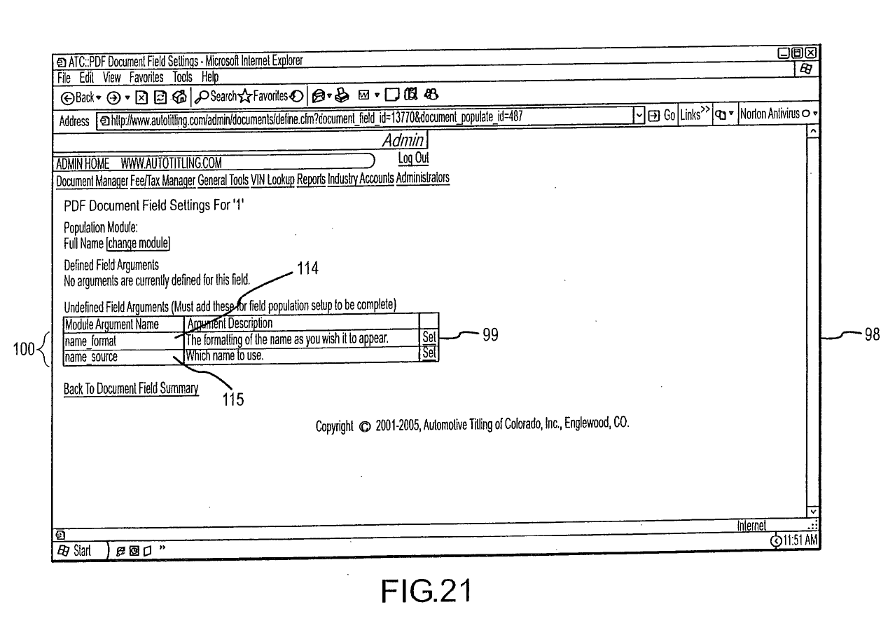

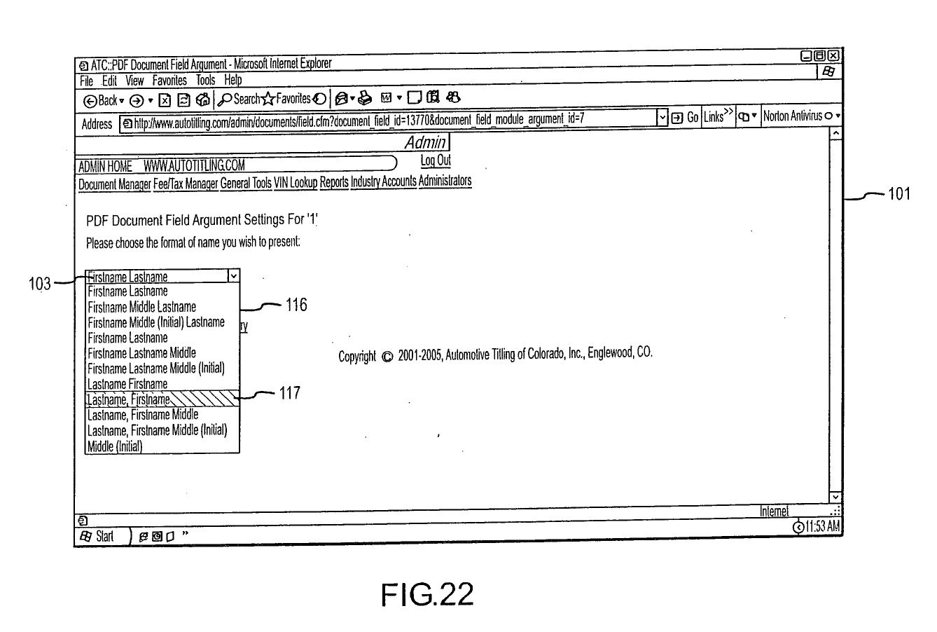

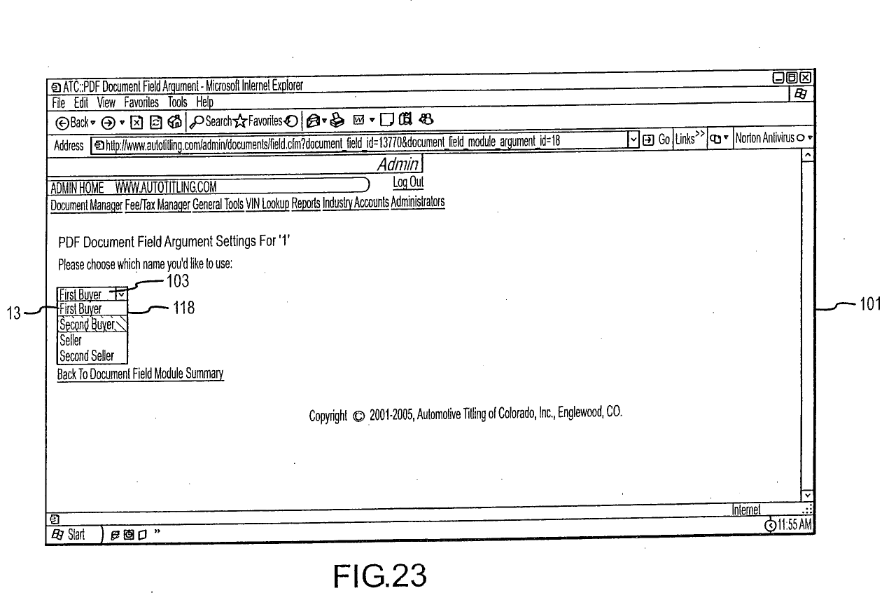

Now referring primarily to FIGS. 12, 21, 22, and 23, a fifth of the plurality of data field setting modules (90) comprises a full name module (113) which operates by click event to generate a corresponding field argument viewer (98)(an embodiment shown in FIG. 21) and by click event of one of the field arguments (100) using the “set” icon in the embodiment shown, the corresponding argument setting viewer (101)(an embodiment for each field argument setting viewer is shown in FIGS. 22 and 23). As shown by FIG. 21 the field argument viewer (98) provides a first name format field argument (114) which requires the name format to be set and a second name field argument (115) which requires which name to use to be set. A click event of the first name format field argument (114) generates in the corresponding argument setting viewer (101)(FIG. 22) a list of name formats (116) each of which by click event generates a name format (117) which establishes the field argument setting (103) for the first name format field argument (114). A click event of the second name field argument (115) generates in the corresponding argument setting viewer (101)(FIG. 23) a list of inquiry fields (118) which relates to a name, such as the first buyer name, second buyer name, first seller name, second seller name, or the like. Selection of one of the plurality of inquiry fields (13) by click event establishes the field argument setting (103) for the second name field argument (115). Subsequent retrieval of the enabled PDF data entity (91) with the defined data entity field (95) allows population of the defined data entity field (95) with the motor vehicle titling data element (11) entered into the selected inquiry filed (13) in the selected name format (117).

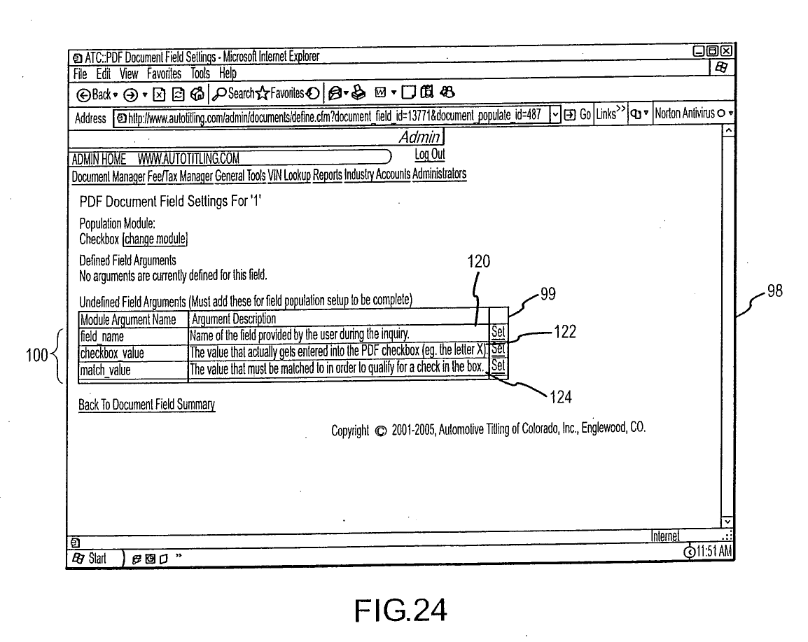

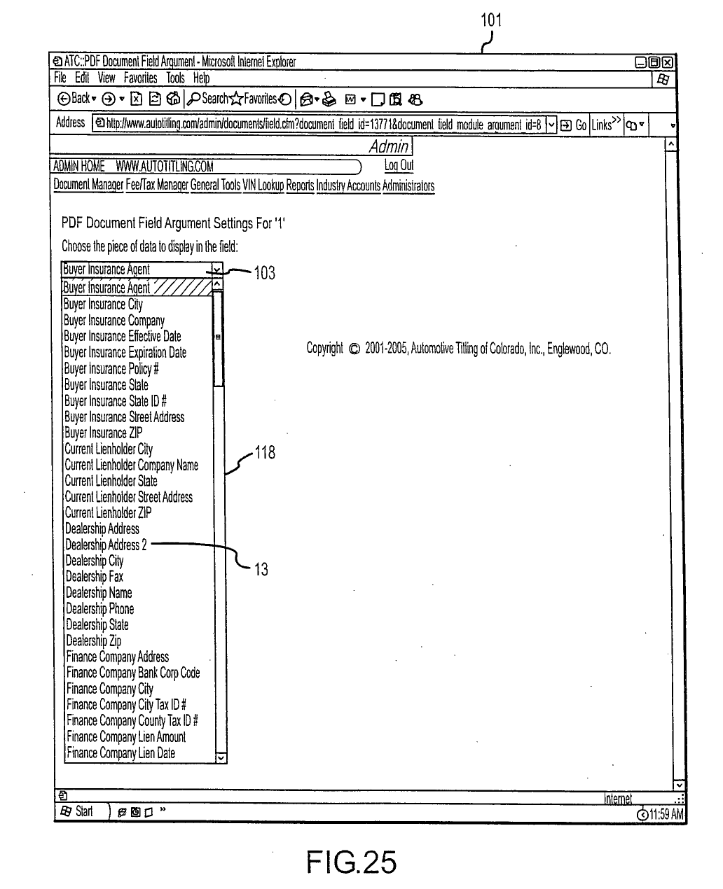

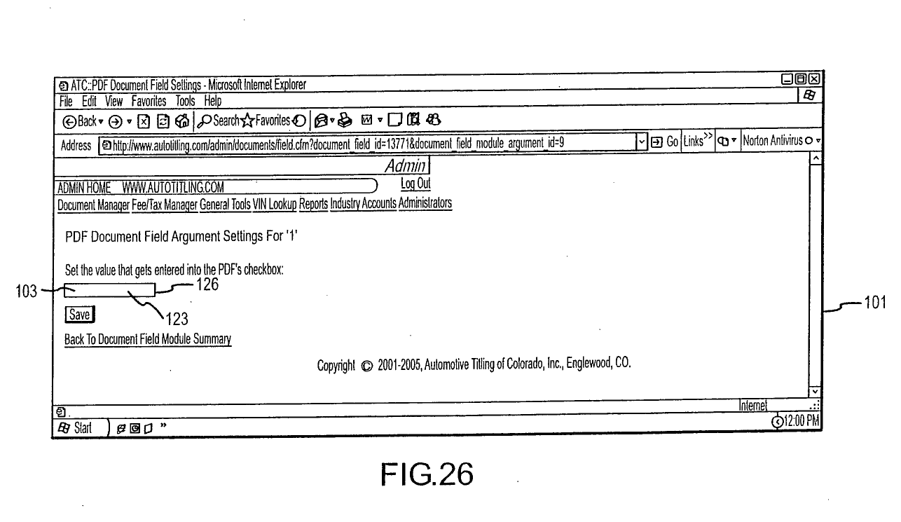

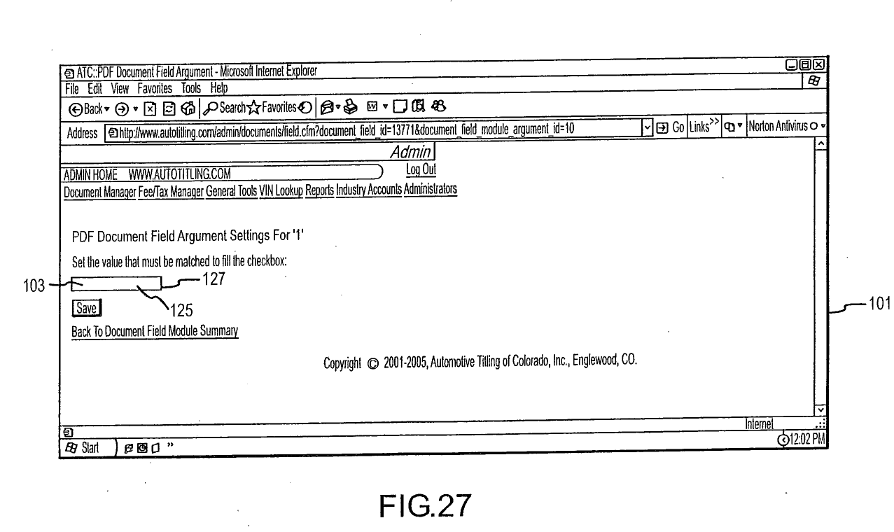

Now referring primarily to FIGS. 12, 24, 25, 26, and 27 a sixth of the plurality of data field setting modules (90) comprises a conditional fill check box module (119) which operates by click event to generate a corresponding field argument viewer (98)(an embodiment shown in FIG. 24) and by click event of one of the field arguments (100) using the “set” icon in the embodiment shown, the corresponding argument setting viewer (101)(an embodiment for each field argument setting viewer shown in FIGS. 25, 26, and 27 respectively). As shown by FIG. 24 the field argument viewer (98) provides a field arguments list (99) with a first field name argument (120) which requires identification of one of the plurality of inquiry fields (13) associated with a check box (121) to be set, a second element value field argument (122) which requires identification of an element value (123) to be entered into the check box (121) to be set, and a third value match field argument (124) which requires that a check box match value (125) must be matched in the identified inquiry field (13) to qualify the check box (121) for a check to be set. A click event of the first field name argument (120) generates in the corresponding argument setting viewer (101)(FIG. 25) a list of the plurality of inquiry fields (118). Selection of one of the plurality of inquiry fields (13) by click event identifies that one of the plurality of fields (13) with the check box (121) as the field argument setting (103) for the first field name argument (120). A click event of a second element value field argument (122) generates in the corresponding argument setting viewer (101)(see FIG. 26) a check box element value data field (126) which allows the element value (123), such as an “x” to be established in the check box element value data field (126) to establish the field argument setting (103) for the second element value field argument (122). A click event of the third value match field argument (124) generates in the corresponding argument setting viewer (101)(see FIG. 27) a check box match value data field (127) which allows a check box match value (125), such as “yes” to be established in the check box match value data field (127) to establish the field argument setting (103) for the third value match field argument (124). Subsequent retrieval of the enabled PDF entity (91) allows population of the defined data entity field (95)(the check box (121)) with the check box element value (123) if the value within the defined entity field matches the check box match value (125).

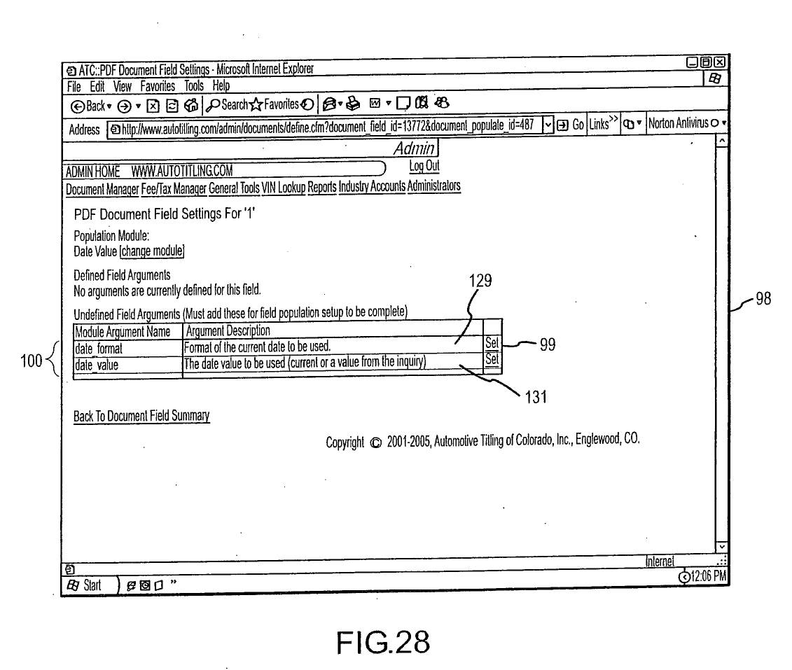

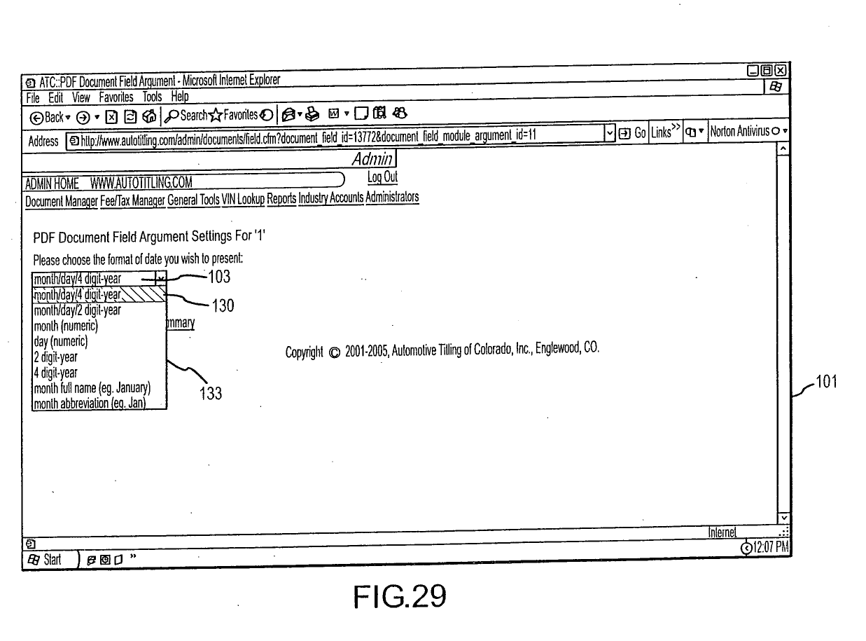

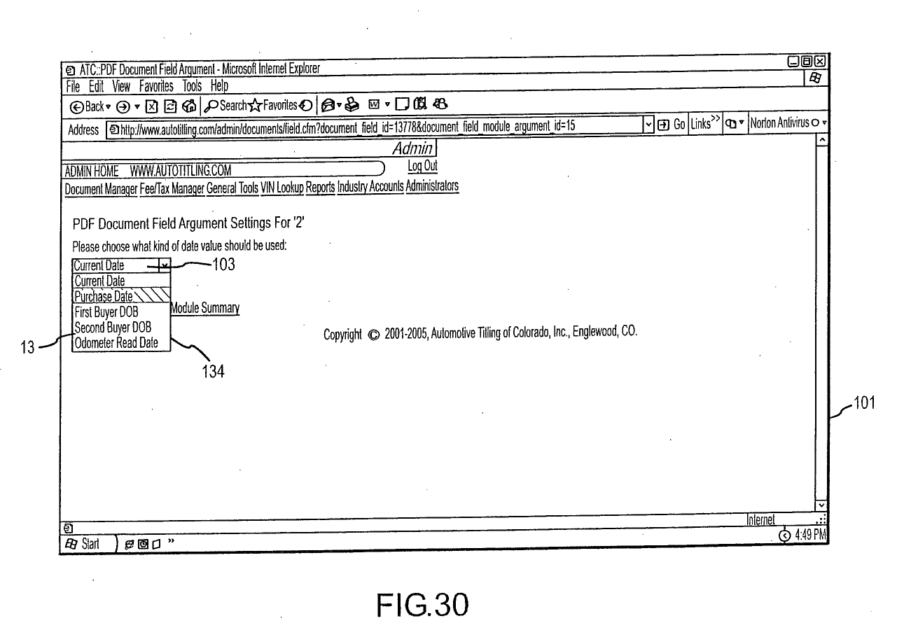

Now referring primarily to FIGS. 12, 28, 29, and 30, a seventh of the plurality of data field setting modules (90) comprises a date value module (128) which operates by click event to generate a corresponding field argument viewer (98)(an embodiment shown in FIG. 28) and by click event of one of the field arguments (100) using the “set” icon in the embodiment shown, the corresponding field argument setting viewer (101)(an embodiment shown in FIG. 29). As shown by FIG. 28 the field argument viewer (98) provides a first date value format field argument (129) which requires the date value format (130) to be set and a second date value field argument (131) which requires which a date value (132) to be set. A click event of the first date value format field argument (129) generates in the corresponding argument setting viewer (101)(see FIG. 29) a date value formats list (133) from which a date value format (130) can be selected to establish the field argument setting (103) for the first date value format field argument (129). A click event of the second date value field argument (131) generates in the corresponding argument setting viewer (101)(see FIG. 30) a date value list (134) from which one of the plurality of inquiry fields (13) in the motor vehicle titling inquiry author (7) which relate to a date, such as the current date, buyer's date of birth, second buyer's date of birth, odometer read date, or the like can be selected to establish the field argument setting for the second date value field argument (131). Subsequent retrieval of the enabled PDF data entity (91) with the defined data entity field (95) allows population of the defined data entity field (95) with the motor vehicle titling data element (11) entered into the selected inquiry filed (13) in the selected date format (130).

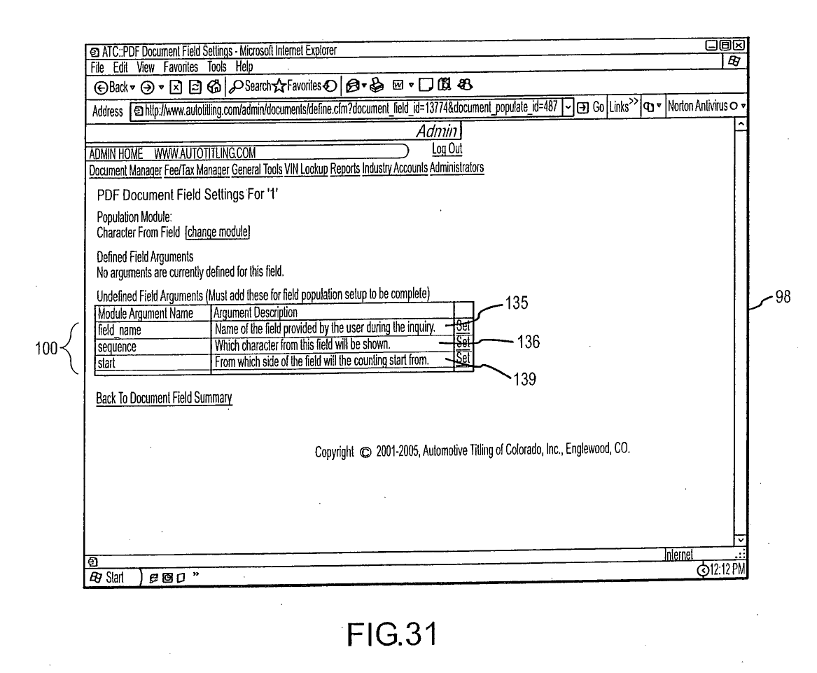

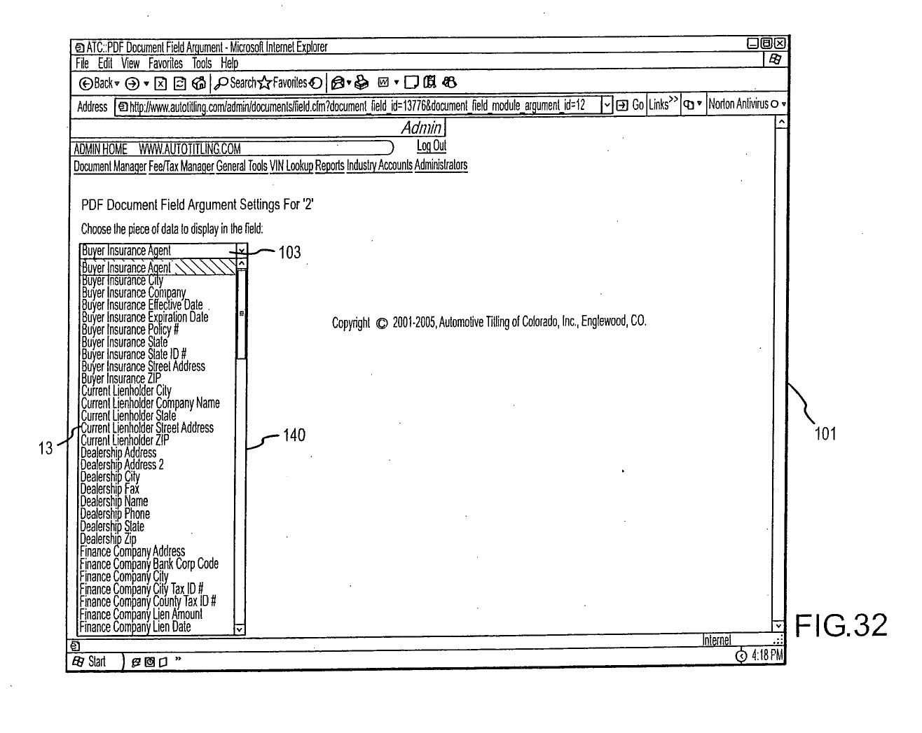

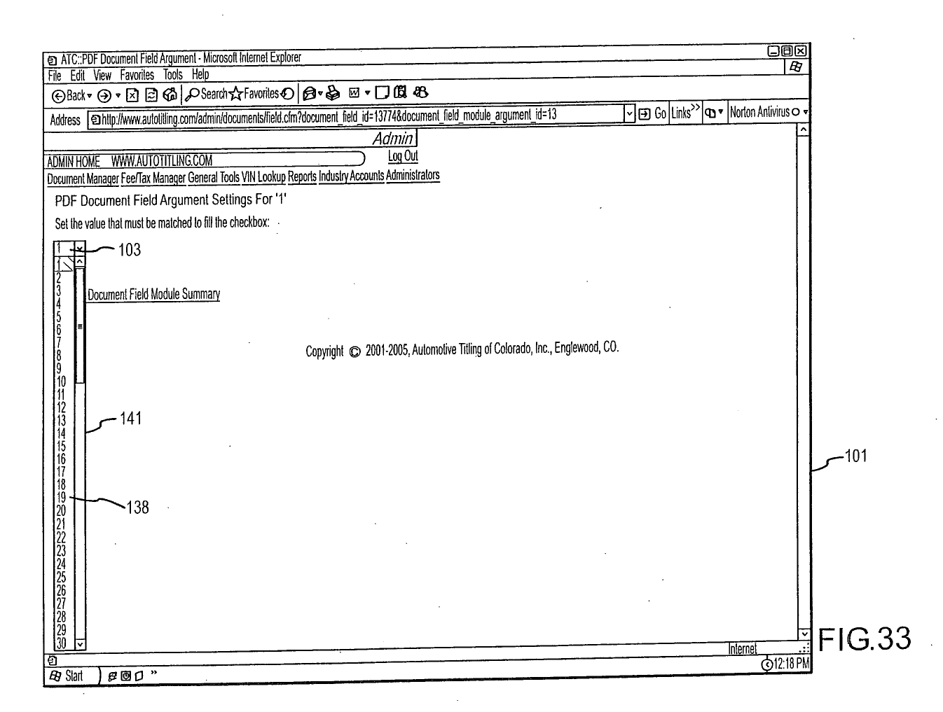

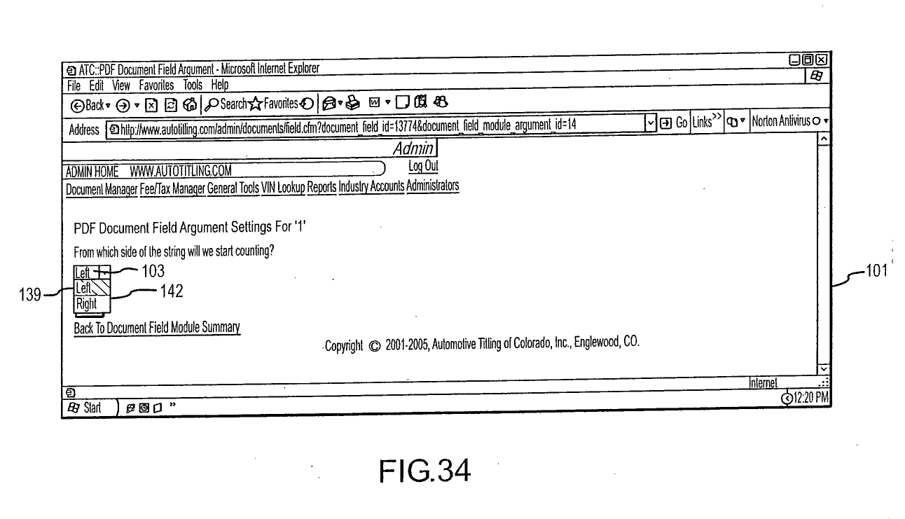

Now referring primarily to FIGS. 12, 31, 32, 33, and 34 an eighth of the plurality of data field setting modules (90) comprises a field element selection module (134) which operates by click event to generate a corresponding field argument viewer (98)(an embodiment shown in FIG. 31) and by click event of one of the field arguments (100) using the “set” icon in the embodiment shown, the corresponding argument setting viewer (101)(an embodiment for each field argument setting viewer shown in FIGS. 32, 33, and 34). As shown by FIG. 31, the field argument viewer (98) provides a first field name argument (135) which requires identification of one of the plurality of inquiry fields (13) to be set, a second field element argument (136) which requires selection of a field element (137)(such as a specific character) at a count location (138) within the selected one of the plurality of inquiry fields (13) to be set, and a third count direction field argument (139) which requires the count location (138) to be established within the selected one of the plurality of inquiry fields (13) by a count direction (139) from the left or the right terminal of the string to be set. A click event of the a first field name argument (135) generates in the corresponding argument setting viewer (101) an inquiry field list (140) each of the plurality of inquiry fields (13) listed functions by click event to establish the string associated with the selected one of the plurality of inquiry fields (13) as the field argument setting (103). A click event of the a second field element argument (136) generates in the corresponding argument setting viewer (11)(see FIG. 33) a list of count values (141) which allows selection of the count location (138), such as 1, 2, 3, . . . within the selected one of the plurality of inquiry fields (13) to establish the field argument setting. A click event of the third count direction field argument (139) generates in the corresponding argument setting viewer (101)(see FIG. 34) a list of count directions (142) which allows selection of count direction (139) starting from the left or the right terminal of the field string of the selected one of the plurality of inquiry fields (13) to establish the field argument setting (103). Subsequent retrieval of the enabled PDF data entity (91) with the defined data entity field (95) allows population of the defined data entity field (95) with the field element (137) having the count location (138) in the selected one of the plurality of inquiry fields (13).

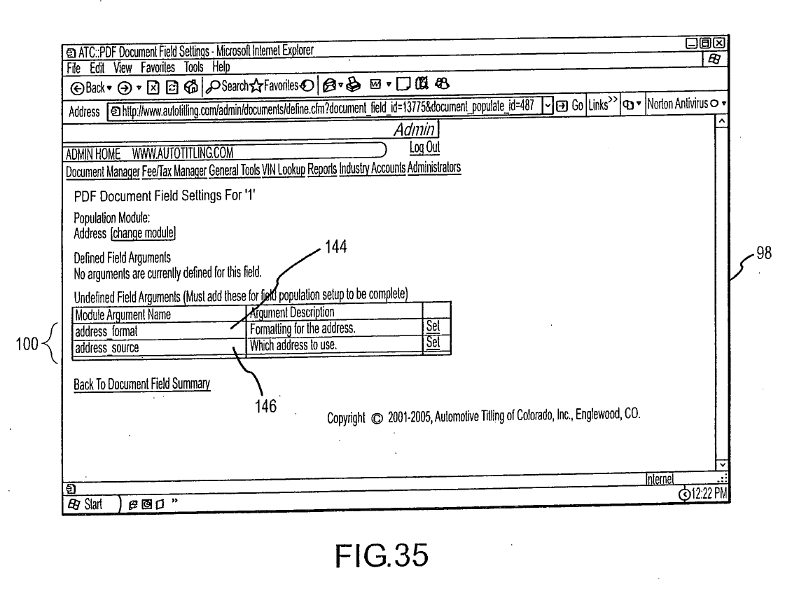

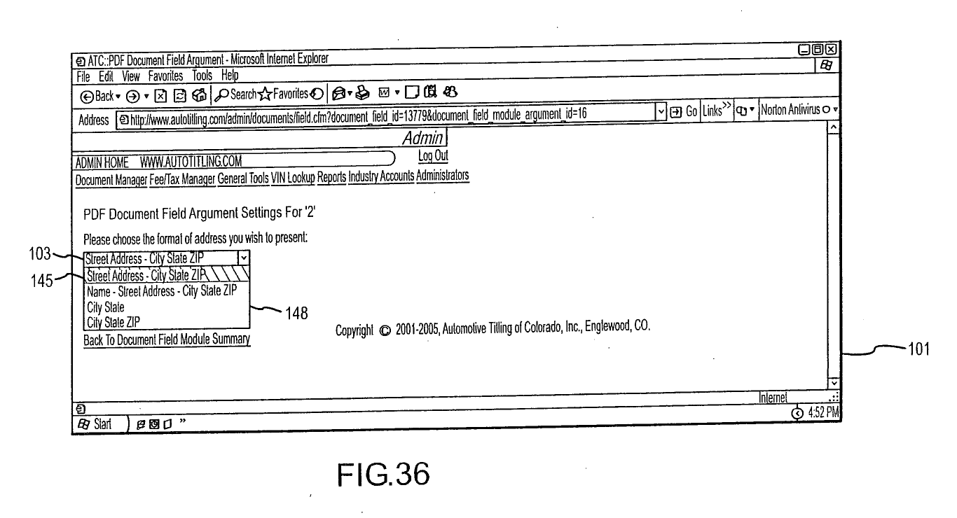

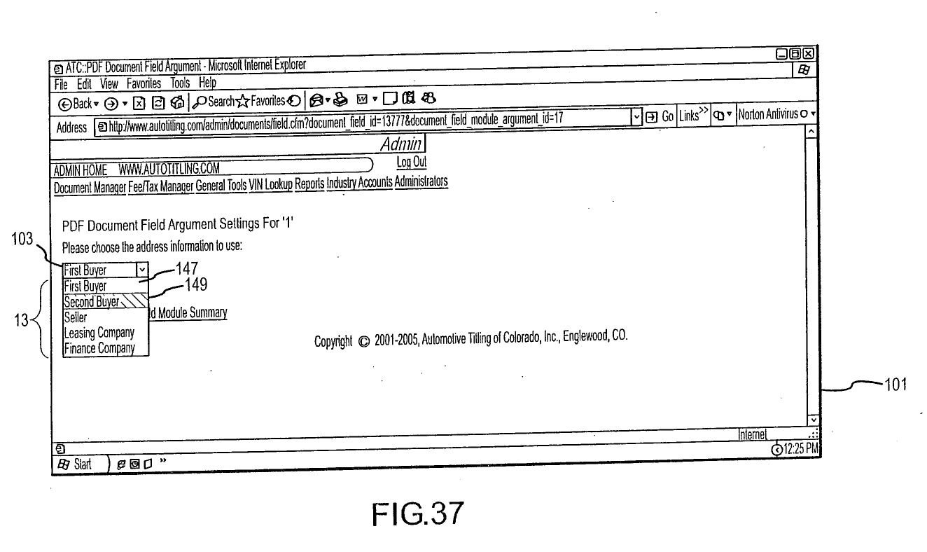

Now referring primarily to FIGS. 12, 35, 36, and 37, a ninth of the plurality of data field setting modules (90) comprises an address value module (143) which operates by click event to generate a corresponding field argument viewer (98)(an embodiment shown in FIG. 35) and by click event of one of the field arguments (100) using the “set” icon in the embodiment shown, the corresponding argument setting viewer (101)(an embodiment for each field argument is shown in FIGS. 36 and 37 respectively). As shown by FIG. 35 the field argument viewer (98) provides a first address format field argument (144) which requires an address format (145) to be set and a second address source field argument (146) which requires an address source (147) to be set. A click event of the first address format field argument (144) generates in the corresponding argument setting viewer (101) an address format list (148) selection of an address format (145) by click event establishes the field argument setting (103) for the first address format field argument (144). A click event of the second address source field argument (146) generates in the corresponding argument setting viewer (101) an address source list (149) which allows selection of one of the plurality of inquiry fields (13) in the motor vehicle titling inquiry author (7) as the address source (147) to establish the field argument setting (103) for the second address source field argument (146). Subsequent retrieval of the enabled PDF data entity (91) with the defined data entity field (95) allows population of the defined data entity field (95) with the one of the plurality of motor vehicle titling data elements (11) entered in the selected one of the plurality of inquiry fields (13) of the motor vehicle titling inquiry author (7) as the address source (147).

Because the motor vehicle titling instructions server (5) or components, elements, programs, applications or modules thereof may not be able to interpret data or data structures including motor vehicle data elements (11) held by the second computer (2), the titling instruction inquiry author (7) can provide in whole or in part a programming interface which allows definition, validation, and interpretation of motor vehicle data elements (11) or other data or data structures utilized by or held in memory of the second computer (2). The titling instruction inquiry author (7) can be generated as an Extensible Markup Language (“XML”) schema, standard generalized markup language (“SGML”), other markup language, or other type of program interface, which can be stored in the server computer (1) and accessed through the web server (4) or can be stored in the second computer (2).

Now referring primarily to FIG. 38, provides a flow diagram of the steps of generating and processing a motor vehicle titling inquiry (14) as to a preferred embodiment of the invention. In a “generate inquiry” step (154) the second module (10) of the motor vehicle titling inquiry author (7) generates the motor vehicle titling inquiry (14) utilizing the plurality of inquiry field identifiers (13d) assigned to the plurality of inquiry fields (13) along with the corresponding plurality of motor vehicle titling data elements (11) established in each of the plurality of fields (13) in a standard markup language structure. A non-limiting EXAMPLE 1 of a motor vehicle titling inquiry in an XML structure is provided below.

In a subsequent “receive inquiry” step (155) the first computer (1) receives the motor vehicle titling inquiry (14) (through the LAN or WAN such as the Internet (3)) as a secure packet of data. In a subsequent “parse and validate step” (156), the motor vehicle titling instructions server (5) operates to parse and validate the plurality of motor vehicle titling data elements (11) entered into the plurality of inquiry fields (13) utilized in the a motor vehicle titling inquiry (14).

A “check errors step” (157) can be performed, if errors exist in the motor vehicle titling inquiry (14), a “return inquiry” step (158) can operate to return the motor vehicle titling inquiry (14) to the second computer (2) with a response message describing the errors. EXAMPLE 2 provides a non-limiting example of a “return inquiry” step (158) on a titling instruction inquiry (14).

If the motor vehicle titling inquiry (14) has no errors, the motor vehicle titling instructions server (5) performs a “retrieval” step (159) to obtain the plurality of motor vehicle titling data entities (15) from the motor vehicle titling database (16) encompassed by the motor vehicle titling inquiry (14). As above-described, the motor vehicle titling database (16) of the first computer (1) can contain a plurality of motor vehicle titling data entities (15) which can be mapped to a motor vehicle titling inquiry (14) based on the identifiers coupled by the add data entity function (62).

Upon retrieving that part of the plurality of motor vehicle titling data entities (15) from the motor vehicle titling database (16) encompassed by the motor vehicle titling inquiry (14), the motor vehicle titling inquiry author (7) performs a “load data entities” step (160) by which the retrieved part of the plurality of motor vehicle titling data entities (15) are incorporated into the motor vehicle titling instruction (20). The load data entities step (160) can further include a “populate data entities” step (161) by which the plurality of motor vehicle titling data elements (11) are matched to and established in the defined data entity fields (95) of any retrieved enabled PDF data entity (91). Defined fields to which none of the plurality of motor vehicle titling data elements (11) are matched can be assigned a missing field identifier (165). An example of a motor vehicle titling instruction (20) as an XML schema is described by EXAMPLE 3.

Now referring to FIGS. 38 and 39, in a “return response” step (162) the motor vehicle titling instruction (20) can be forwarded to the second computer (2) and by function of motor vehicle titling instruction viewer (19) the motor vehicle titling instruction (20) can be displayed as an motor vehicle titling instruction image representation (20a) which displays or allows access to all of the a plurality of motor vehicle titling data entities (15) generated in response to the motor vehicle titling inquiry (14). In the embodiment of the motor vehicle titling instruction viewer (19) shown by FIG. 39, one or more enabled PDF data entity (91) can be downloaded by click event of a “click here to download pdf” icon (163).

In a subsequent “manual population step” (164), the user can manually establish one of the plurality of motor vehicle titling data elements (11) into defined data entity fields (95) of the downloaded enabled PDF data entity (91) which are assigned a missing field identifier (165).

Again referring primarily to FIG. 1 and FIG. 2, the functions of the email server (18), the to a web server (4), and the titling instructions server (5) can function to transmit motor vehicle titling instructions (17) to an email recipient (20). The user (50) retrieves one or more motor vehicle titling instructions (17) stored in a memory element (22)(48)(or generated by applications served by the titling instructions server (5)). The user (50) can than select by click event an email recipient address (74) from an email recipient list (75) of an email recipient (20) to which the user will send URL's (19) of the selected motor vehicle titling instructions (17) in an email (18). The user may also enter descriptive text, notation, or comments to the email in a message field (76). The email can then either be created and sent by click event on email control icon (77)(such as the OK button) or canceled by click event of the email cancel icon (78). The email recipient (20) receives the recipient's email (18) which, upon opening displays URL (19)(or icon corresponding to an URL). Click event on the URL (19) establishes communication with and the titling instructions server (5) to transmit the motor vehicle titling instructions (17) to the email recipient's (20) automotive titling viewer (9).

Again referring to FIGS. 1 and 2, the invention can further include a fee-tax manager (170) (also referred to as a fee-tax management system) provides an fee-tax management application program (171)(see FIG. 2) which can be served by the titling instructions server (5) to the first computer (1) or one or more second computers (2) as above-described. The fee-tax management application program (171) includes a fee-tax administrator module (172) which operates to provide a hierarchical structure of a plurality of fee-tax modules (173) each of which function as further described below to allow an administrator computer user (53a)(also referred to as an “administrator”) to characterize each one of a plurality of fee-taxes (174) of a taxing entity (175)(or any one or a plurality of taxing entities) through use of an administrator fee-tax graphic interface (176)(see FIG. 2). The fee-tax management application program (171) can further include an fee-tax user module (177) which provides a hierarchical structure of a plurality of fee-tax retrieval modules (178) each of which function as further described below to allow a customer computer user (53b)(“also referred to as a “customer”) to retrieve each one of the plurality of fee-taxes (174) for each one of the plurality of fee-tax entities (175) based upon matched correspondence of one or more fee-tax retrieval elements (180) with one or more fee-tax identifiers (179) associated with one of the plurality of fee-taxes (174) by utilization of the fee-tax administrator module (172).

The term “a plurality of fee-taxes (174)” as used herein is intended to broadly encompass a plurality of amounts levied or charged by a plurality of taxing entities (175) (any of the plurality of entities entitled or authorized to levy or charge taxes or fees) relating to a vehicle entity (203) regardless of type, make, or kind; the registration, titling, licensing of a vehicle or obtaining plates for a vehicle; the vehicle value regardless of the basis whether in whole or in part; or on any product, income, service or activity related to a vehicle and without limitation to the forgoing specifically includes for example the amount levied by a taxing entity (183) to register title of a vehicle entity (203) with the taxing entity (183). The term “a fee-tax (186)” as used herein means the information digitized in accordance with the description relating to any one of the plurality of fee-taxes (174) which can be differentiated by utilization of the fee-tax manager (170).

The term “characterize” as used herein is intended to broadly encompass the function of linking, coupling, or otherwise associating one or more fee-tax identifier(s) (179) to a fee-tax (186) which allows retrieval of the fee-tax (186) based on matched correspondence of the one or more the fee-tax identifier(s) (179) with one or more of a plurality of fee-tax retrieval elements (180) selected by click event to activate the functionalities of one or more of the plurality of fee-tax retrieval modules (178) in a customer fee-tax graphic user interface (181)(see FIG. 2 in broken lines) generated by the fee-tax user module (177).

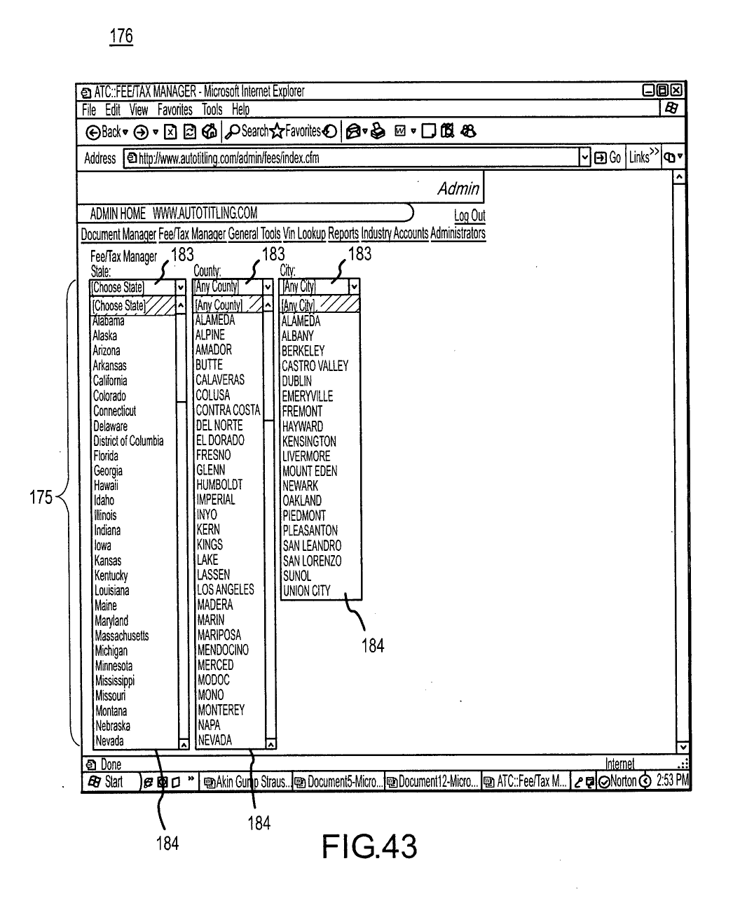

Now referring primarily to FIGS. 43-53, which provides a non-limiting example of an administrator fee-tax graphic user interface (176)(see also FIG. 1 which can be generated by the fee-tax management application program (171) which allows the administrator (53a) to utilize the functionalities of the plurality of fee-tax modules (173) in the intended hierarchical structure to couple one or more fee-tax identifiers (179) to each fee-tax (186) of each one of the plurality of taxing entities (175). Now referring primarily to FIG. 43, which shows that part of the administrator fee-tax graphic user interface (176) which by click event allows utilization of the functionalities of a taxing entity selection module (182) in a first level of the hierarchical architecture to select a taxing entity (183) from a plurality of taxing entities (175). In the embodiment of the administrator fee-tax graphic user interface (176) shown, by click event a taxing entities list (184) can be generated by the taxing entity selection module (182) and a taxing entity (183) from the plurality of taxing entities (175) can be selected by click event to couple a taxing entity identifier (185) corresponding to the selected taxing entity (183) to the fee-tax (186) characterized. Typically, the taxing entity selection module (182) allows selection of a taxing entity (183) from a plurality of taxing entities (175) from the group consisting of a state, a county, and a city (or other similar political units or units which have authority to promulgate fees or taxes), as shown for example by FIG. 43; however, the invention is not so limited, and the taxing entity selection module (182) can function to provide selection of the taxing entity (183) in any manner which defines the bounds, whether geographic, political, or otherwise, of a taxing entity (183) which utilizes a particular fee-tax (186).

While the particular embodiment of the administrator fee-tax graphic interface (176) shown by the Figures provides selection by click event way of utilizing drop down lists and check boxes, the invention is not so limited and any manner of allowing selection by click event to activate a function of any particular one of the plurality of fee-tax modules (173) is encompassed by the invention.

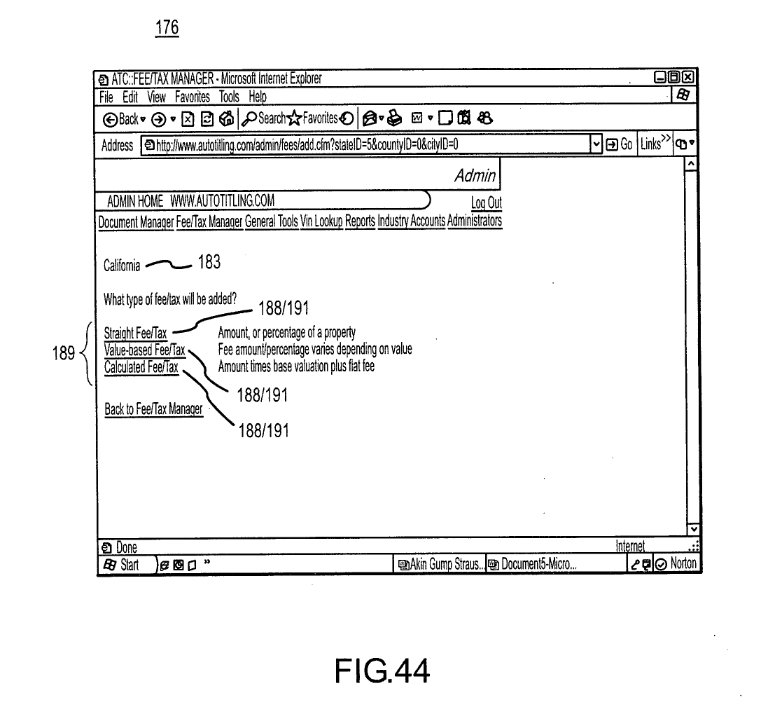

Now referring specifically to FIG. 44, that part of the administrator fee-tax graphic user interface (176) generated by selection of a taxing entity (183) as above-described is shown and which allows by click event utilization of the functionalities of a fee-tax type selection module (187) in a second hierarchical level to select a fee tax type (188) from a plurality of fee-tax types (189). Selection by click event of one of the plurality of fee-tax types (189) generates a corresponding fee-tax type template (190). Each fee-tax type template (190) provides that part of the administrator fee-tax graphic interface (176) which allows by click event activation of the remaining plurality of fee-tax modules (173) necessary to characterize or couple additional fee-tax identifiers (179) to the fee-tax (186) for subsequent retrievable storage.

One embodiment of the fee-tax management application program (171) allows by click event selection of one of the group of fee-tax types (189) including a straight fee type (191) which operates to generate a straight fee-tax template (192), a value-based fee type (193) which operates to generate a value-based fee-tax template (194), and a calculated fee type (195) which operates to generate a calculated fee-tax template (196) each of such fee-tax template (190) providing an interface to activate the corresponding fee-tax modules necessary to characterize the fee-tax (186). While the group of fee-tax types (189) includes only three fee-tax types (188) which are sufficient to in characterize all now existing of fee-tax types (174) of the plurality of taxing entities (175), additional fee-tax types can be included as new fee-tax types evolve, all of which are encompassed by invention.

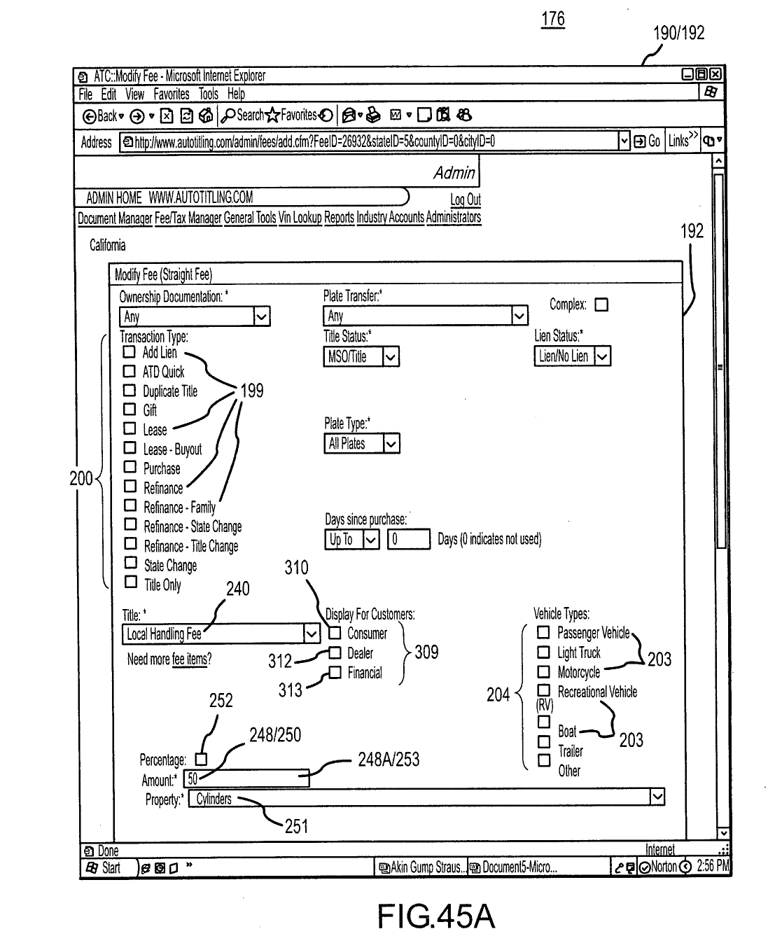

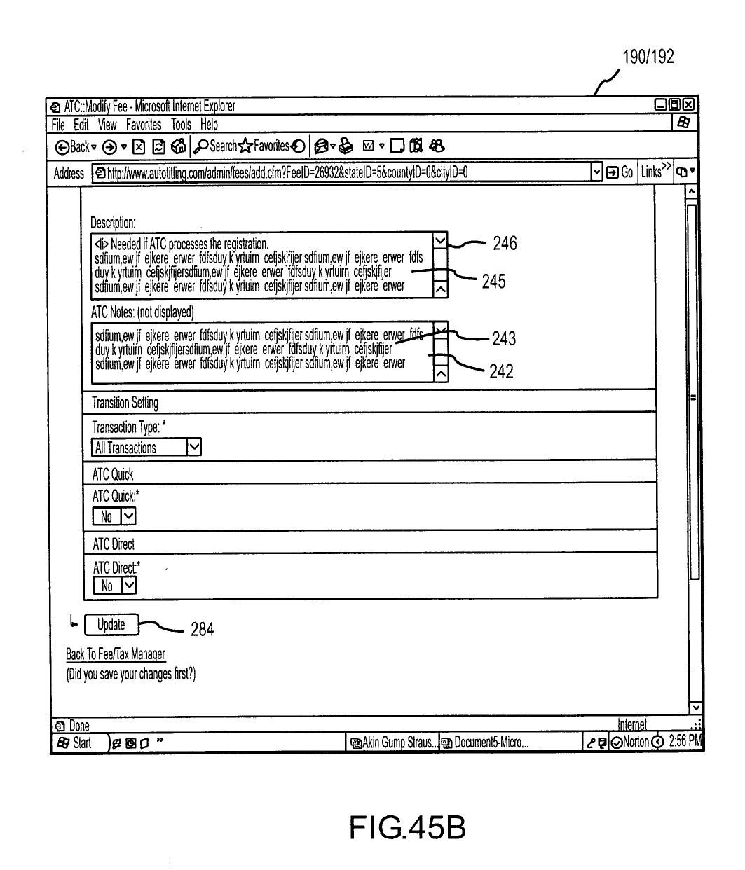

As shown primarily by FIGS. 45A and 45B, 48 and 49, and 50A and 50B certain of the plurality of fee-tax modules (173) are common to all fee-tax type templates (190)(193)(194)(196). A first of the plurality of fee tax modules (173) operable by click event in each of the fee-tax type templates (190)(193)(194) can be a transaction type module (198) which functions to characterize the fee-tax (186) by a transaction type (199) performable with the taxing entity (183). As shown by the non-limiting example afforded by the Figures, one or more of the plurality of transaction types (200) can be selected by click event from the group including: an add lien, a duplicate title, a gift, a lease, a lease-buyout, a purchase, a refinance, a refinance family, a refinance state change, a refinance title change, a state change, and a title only.

While between a plurality of taxing entities (175), the scope of each of the plurality of transaction types (200) may vary and the corresponding plurality of fee-taxes (174) encompassed by each transaction type (199) may correspondingly vary, for a single selected taxing entity (183) the scope of each transaction type (199) can remain consistent such that to one of ordinary skill in fee-tax art each fee-tax (186) of a taxing entity (183) can be unambiguously characterized as being encompassed by one or more of the plurality of transaction types (200) to couple a corresponding one or more of the plurality of transaction type identifiers (201) to the fee-tax (186).

Subject to the breadth accorded each transaction type (199) by each of one of the plurality of taxing entities (175), “add lien” means add a lien to an existing title without ownership change; “duplicate title” means obtain a replacement title; “gift” means without payment of consideration for the property received; “lease” means an owner of the property allows use by another person in return for payment of consideration; “lease-buyout” means that end of a lease period the property can be bought from the lessor; “purchase” means that the ownership of the property is transferred for an amount of consideration; “refinance” means to place a new loan on a vehicle that currently has a lien on the title; “refinance-family” means to place a new loan on a vehicle that currently has a lien and add a family member owner to the title; “refinance-state change” place a new loan on a vehicle that currently has a lien and move the title from a first taxing entity to the selected taxing entity; “refinance-title change” means place a new loan on a vehicle that currently has a lien and add a non-family member owner to the title; “state change” means move the title from the selected taxing entity to another taxing entity without a change in the ownership of the property; “title only” means an ownership change in the previously titled or not previously titled property. Again, while the transaction types above-described encompass all now existing transaction types that can be performed with the plurality of taxing entities (174) the invention can further include additional transaction types (199) which evolve.

Again referring primarily to FIGS. 45A and 45B, 48 and 49, and 50A and 50B, a second one of the plurality of fee-tax modules (173) common to each fee-tax type template (192)(194)(196) can be a vehicle entity module (202) which allows characterization of the fee-tax (186) based upon a vehicle entity (203). As shown in the Figures, a vehicle entity (203) can be selected by click event from a plurality of vehicle entities (204) which includes: a passenger vehicle, a light truck vehicle, a motorcycle vehicle, a recreational vehicle, a boat vehicle, a trailer vehicle, and any other vehicle. While between the plurality of taxing entities (175) the breadth of vehicle types encompassed by each vehicle entity (203) may vary and the corresponding plurality of fee-taxes (174) encompassed by the vehicle entity (203) may correspondingly vary, the breadth of vehicle types encompassed by each vehicle entity (203) within a single one of the plurality of taxing entities (175) remains consistent such that each fee-tax (186) can be unambiguously characterized as corresponding to a vehicle entity (203) selected by click event from the plurality of vehicle entities (204) to couple the corresponding vehicle entity identifier (216) to the fee-tax (186). Subject to the breadth accorded the vehicle entity (203) by each of one of the plurality of taxing entities (175), “passenger vehicle” means vehicle designed or adapted for the transport of nine or fewer seated persons; “light truck” means a truck with a gross vehicle weight of 8,500 pounds or less along with SUVs and minivans built on a truck chassis; “motorcycle” means a two wheel vehicle powered by an engine; “recreational vehicle” means a vehicle primarily designed as temporary living quarters for recreational, camping, or travel use which either has its own motive power or is mounted on or towed by another vehicle; “boat” means a vehicle which floats on the water propelled by an engine; “trailer” means a vehicle designed to hauled by a truck or tractor; “other vehicle” means any other type of vehicle entity. Again, while additional new vehicle entities such as “hybrid” vehicle entities may require addition of vehicle entities to the plurality of vehicle entities (175) listed, the plurality of vehicle entities (204) now encompasses the plurality of vehicle entities (204) of the plurality of taxing entities (175).

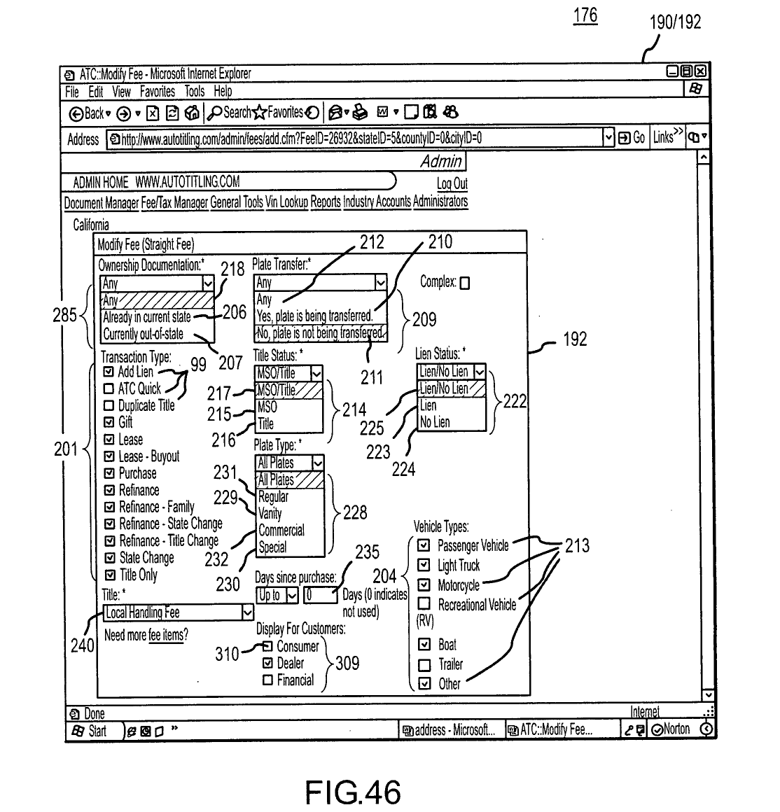

Again referring primarily to FIGS. 45A and 45B, 48 and 49, and 50A and 50B, a third of the plurality of fee-tax modules (173) common to each fee-tax template (192)(194)(196) can be an ownership documentation location module (205) which allows characterization of the fee-tax (186) based upon whether the ownership documentation (such as a title registration document) of the vehicle entity (203) is currently filed in the selected taxing entity (183) or is currently filed outside of the selected taxing entity (183). As a non-limiting example shown primarily by FIG. 46, one of a plurality of ownership documentation location indicators (285) can be selected by click event from the group including: “currently out of state” (207), “already in current state” (206), or “any” (218)(naturally other designations could be utilized which allow the administrator to select the proper functionality to couple a corresponding ownership documentation location identifier (283) to the fee-tax (186). Selection by click event of “any” (218) establishes that the fee-tax (186) is not to be characterized on the basis of the current filing location of the ownership documentation. While between taxing entities, the definition as to whether the ownership documentation of a vehicle is currently filed in the taxing entity (183) selected (shown as “already in current state”) or is currently filed outside of the taxing entity (183) selected (shown as “currently out of state”) may vary, this does not render the selection by click event of the current filing location of the ownership documentation unclear to one of ordinary skill in fee-tax art for any given taxing entity (183) and each fee-tax (186) can be unambiguously characterized as applying to a vehicle having ownership documentation filed with the selected taxing entity, filed with a non-selected taxing entity to couple a corresponding ownership documentation location identifier to the fee-tax (186), or establish that the fee-tax (186) is not characterized on the basis of the current filing location of the ownership documentation.

Again referring primarily to FIGS. 45A and 45B, 48 and 49, and 50A and 50B, a fourth of the plurality of fee-tax modules (173) common to each fee-tax template (192)(194)(196) can be a plate transfer module (208) which allows characterization of the fee-tax (186) on the basis of whether the vehicle plate is transferred from a first vehicle to a second vehicle. As shown in the non-limiting example in FIG. 46, the plate transfer module (208) allows by click event selection of one of a plurality of plate transfer events (209) from the group including: a transferred plate (a plate transferred from a vehicle to a replacement vehicle) (210), a non-transferred plate (the plate of a vehicle is not being transferred to a replacement vehicle) (211), or any plate transfer (212)(the fee-tax is not to be characterized by a plate transfer identifier). While between taxing entities, the definition as to whether or not the a plate has transferred from a vehicle to a replacement vehicle may vary, this does not render the selection by click event one of a plurality of a plate transfer event (209) (for example, “yes, plate is being transferred” or “no, plate is not being transferred”) unclear to one of ordinary skill in fee-tax art of a given taxing entity (183) and each fee-tax (186) can be unambiguously characterized as being a plate transfer or as not a plate transfer. Selection of one of the plurality of plate transfers (209) couples a corresponding one of the plurality of plate transfer identifiers (219) to the fee-tax (186).

Again referring primarily to FIGS. 45A and 45B, 48 and 49, and 50A and 50B, a fifth of the plurality of fee-tax modules (173) common to each fee-tax template (192)(194)(196) can be a title status module (213) which allows characterization of the fee-tax (186) as applying to one of a plurality of title statuses (214). As shown in the Figure, the title status module (213) allows selection by click event one of a plurality of title statuses (214) from the group including: an untitled vehicle (“MSO”)(typically a new vehicle not having a prior title) (215), a titled vehicle (typically a used vehicle) (216), or either an untitled or titled vehicle (“MSO/titled)(217)(the fee-tax is not to be characterized by the title status). While between the plurality of taxing entities (175), the definition as to whether the vehicle is an untitled vehicle or is a titled vehicle may vary, this does not render the selection by click event of a title status unclear to one of ordinary skill in fee-tax art of a given taxing entity and each fee-tax (186) can be unambiguously characterized as being applied to a titled or untitled vehicle, or either titled or untitled, to couple one of corresponding plurality of title status identifiers (220) to the fee-tax (186) or indicate that the fee-tax is not to be characterized by the title status.

Again referring primarily to FIGS. 45A and 45B, 48 and 49, and 50A and 50B, a sixth of the plurality of fee-tax modules (173) common to each fee-tax template (192)(194)(196) can be a lien status module (221) which allows characterization of the fee-tax (186) as applying to one of a plurality of lien statuses (222). As shown by the non-limiting example in FIG. 46, the lien status module (221) allows selection by click event of one of a plurality of lien statuses (222) from the group including: a lien (“lien”)(223), no lien (“no lien”)(224), and any lien status (“lien/no lien”)(225)(indicating that the fee-tax is not characterized the lien status). While between taxing entities, the definition as to whether a lien has attached to vehicle may vary, this does not render the clickable selection of a lien status unclear to one of ordinary skill in fee-tax art of a given taxing entity (183) and each fee-tax (186) can be unambiguously characterized on the basis of whether a vehicle entity (203) to has a lien has attached or a vehicle to which no lien has attached and the corresponding one of a plurality of lien identifiers (226) can be coupled to the fee-tax (186) or not characterized on the basis of whether or not a lien has attached.

Again referring primarily to FIGS. 45A and 45B, 48 and 49, and 50A and 50B, a seventh of the plurality of fee-tax modules (173) common to each fee-tax template (192)(194)(196) can be a plate type module (227) which allows characterization of the fee-tax (186) on the basis of one of a plurality of plate types (228). As shown in the non-limiting example shown in FIG. 46, the plate type module (227) allows selection by click event of one of the plurality of plates types (228) from the group including: a vanity plate (229), a special plate (230), a regular plate (231), and a commercial plate (232). While between taxing entities, the definition of each one of the plurality of plate types (228) may vary, this does not render the selection by click event of one of the plurality of plate types (228) unclear to one of ordinary skill in fee-tax art of a given taxing entity (183) and each fee-tax (186) can be unambiguously characterized on the basis of one of the plurality of plate types (228) in a particular taxing entity (183) to couple a plate type identifier (233) to the fee-tax (186).

Again referring primarily to FIGS. 45A and 45B, 48 and 49, and 50A and 50B, an eighth of the plurality fee-tax modules (173) common to each fee tax template (192)(194)(196) can be an elapsed days module (234) which allows characterization of the fee-tax (186) based upon occurrence of the transaction type (199) with the taxing entity (183) within a number of elapsed days (235) from a purchase date of a vehicle entity (203). As shown by the non-limiting example in FIG. 46, the elapsed days module (234) allows selection by click event of a number of elapsed days (235) from the purchase date of a vehicle entity (203)(either entered by keystroke or selected from a drop down list or otherwise). Selection by click event of a number of elapsed days (235) couples the corresponding elapsed days identifier (236) to the fee-tax (186).

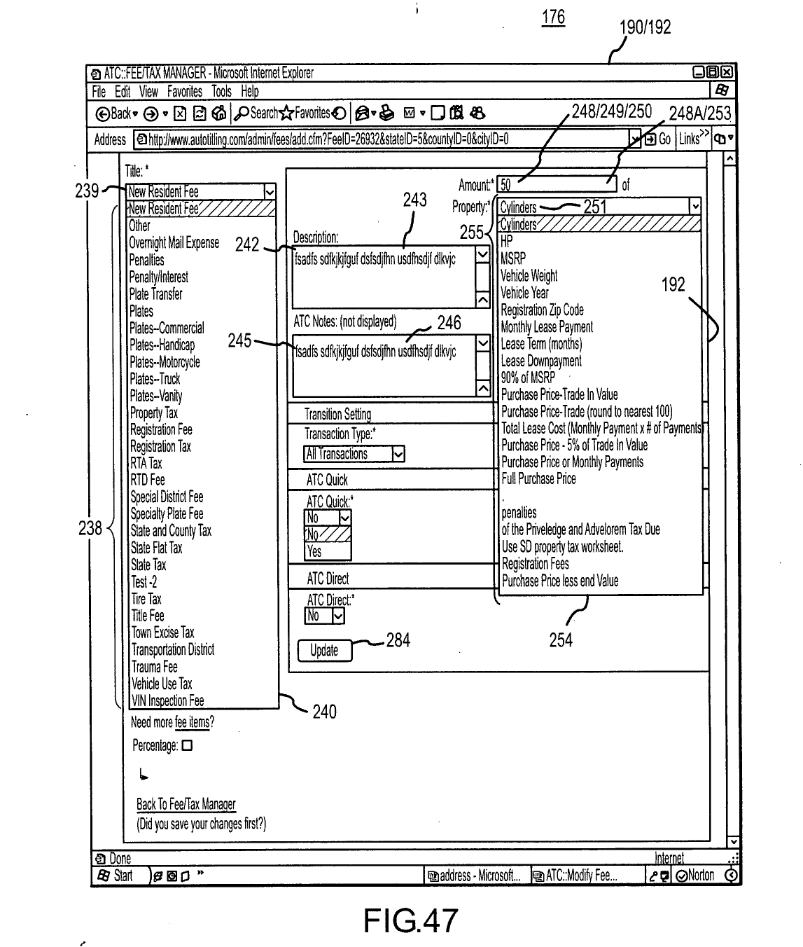

Again referring primarily to FIGS. 45A and 45B, 48 and 49, and 50A and 50B, a ninth of the plurality of fee-tax modules (173) common to each fee tax template (192)(194)(196) can be a fee-tax title module (237) which allows characterization of the fee-tax (186) based upon one of a plurality of fee-tax titles (238). As shown in the non-limiting example in FIG. 47, a fee-tax title (239) can be selected by click event from a drop down list of titles (240). Selection by click event of a fee-tax title (239) couples the fee-tax title (239) to the fee-tax (186) to be subsequently retrievable with the fee-tax (186) by operation of the fee-tax administrator module (172) as further described below.

Again referring primarily to FIGS. 45A and 45B, 48 and 49, and 50A and 50B, a tenth of the plurality of fee-tax modules (173) common to each fee-tax template (192)(194)(196) can be an administrator fee-tax description module (241) which by click event functions to allow entry of an administrator fee-tax description (242) into an administrator fee-tax description field (243) such administrator fee-tax description (242) can be coupled to the fee-tax (186) to be subsequently retrievable with the fee-tax (186) by operation of the fee-tax administrator module (172) as further described below.

Again referring primarily to FIGS. 45A and 45B, 48 and 49, and 50A and 50B, an eleventh of the plurality of fee-tax modules (173) common to each fee-tax template (192)(194)(196) can be a customer fee-tax description module (244) which allows entry of a customer fee-tax description (245) into a user fee-tax description field (246) such customer fee-tax description (245) subsequently retrievable with the fee-tax (186) by operation of the fee-tax user module (177) as further described below.

Again referring primarily to FIGS. 45A and 45B, 48 and 49, and 50A and 50B, a thirteenth of the plurality of fee tax modules (173) common to each fee-tax template can be a fee-tax update module (284) which functions to store said fee-tax (186) as characterized by utilization of the plurality of fee-tax modules (173) described herein in the memory element (28) of the first computer (1) (or fee-tax database) for matched retrieval by a second computer (2) based upon a match between fee-tax retrieval elements (180) and the fee-tax identifiers (179) coupled to the fee-tax (186)(in the embodiment of the tax manager described herein there must one to one correspondence between the entered fee-tax retrieval elements (180) and the fee-tax identifiers (179) coupled to the fee-tax (186) to retrieve a particular one or more than one of the plurality of fee-taxes (186) stored in the memory element (28) of the server computer (1).

Now referring primarily to FIGS. 45A and 47, the straight fee-tax template (192) can further allow operation of a straight fee-tax module (247) which allows characterization of the fee-tax (186) with a straight fee-tax amount (248)(the flat fee-tax amount (249) of the selected taxing entity (183) or generated as the product of a selected percent value (250) of a vehicle value (251) in United States dollars or equivalent amount of the fee tax in another currency). In the non-limiting example of the straight fee tax template (192) shown in FIG. 45A, the straight fee-tax module (247) generates a straight fee-tax field (248A) in which the flat fee-tax amount (249) can be entered as the straight fee-tax amount (248). Upon subsequent matched retrieval of the fee tax (186) the flat fee-tax amount (249) can also be retrieved. The straight fee-tax module (247) can in the alternative operate to generate the straight fee-tax amount (248) based upon a percent value (250) applied to a vehicle value (251). In the example of the straight fee-tax template (192) shown by FIG. 45A, the percent value (250) function can be activated by click event of a percentage check box (252) and entering the percent value (250) into an percentage amount field (253). The vehicle value (251) can be selected by click event from a drop down vehicle value list (254)(see the non-limiting example shown in FIG. 47) which can include a plurality of vehicle values (255), for example: a cylinder value, a manufacturer's suggested retail price (“MSRP”) value, a vehicle weight value, a vehicle year value, a vehicle registration address value, a vehicle purchase price, a lease term value, a lease down payment value, a ninety percent of MSRP value, a purchase price less trade in value, a purchase price less trade value, a total lease cost value, a total lease purchase cost, a full purchase price, a purchase price less value, an amount of registration fees, an amount of penalties, an amount of privilege or ad valorum tax value, or SD value property tax worksheet value. Again, additional new vehicle values can be added to the plurality of vehicle values (255) as such values evolve and are encompassed by the invention.

Upon selection of the percentage value (250) and the vehicle value (251) the straight fee-tax module (247) functions to calculate the straight fee-tax amount (248) as the percentage value (250) of the selected vehicle value (251) and characterizes the fee-tax (186) with the staight fee-tax amount (248) calculated. Upon subsequent retrieval of the fee-tax (186) the straight fee-tax amount (248) calculated is also retrieved.

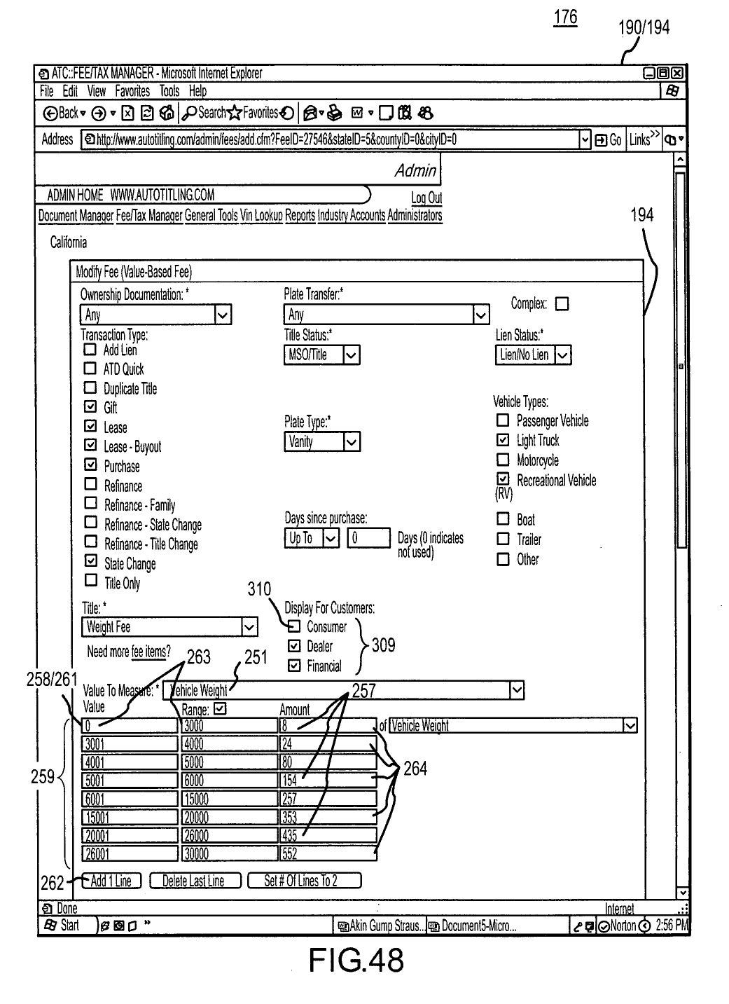

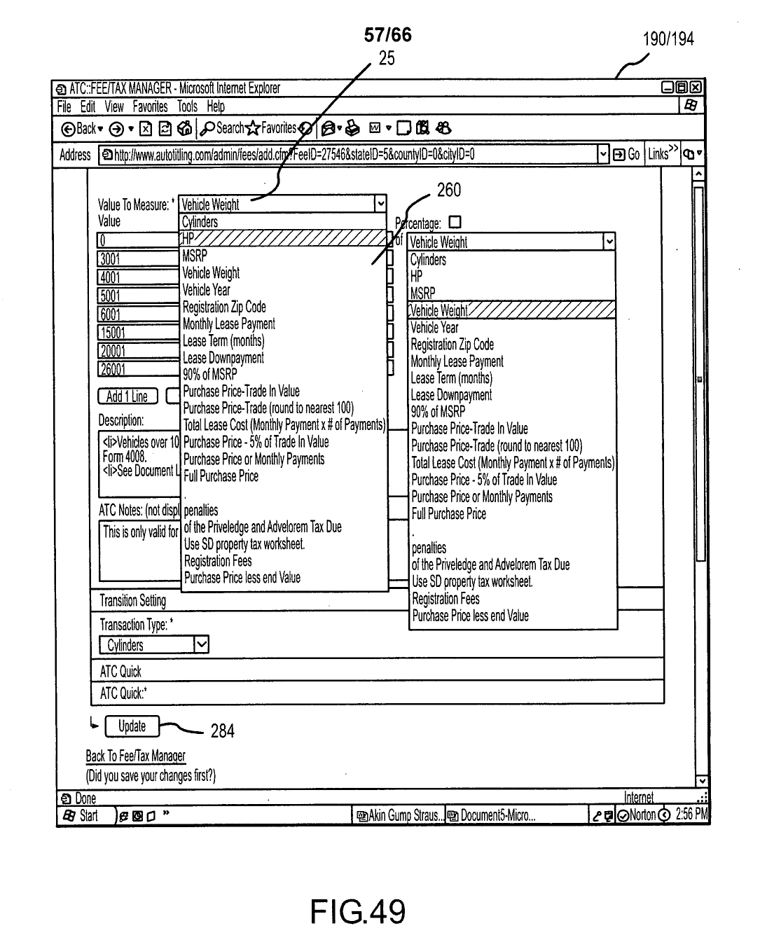

Now referring primarily to FIGS. 48 and 49, the value based fee-tax template (194) allows utilization of the functions of a value based fee-tax module (256) which allows characterization of the fee-tax (186) with a value based fee-tax amount (257). The value based fee-tax module (256) functions by click event to generate a value range (258) or plurality of value ranges (259) for a vehicle value (251). Each value range (258) or each of the plurality of value ranges (259) can have a corresponding value-based fee-tax amount (257). For example, as shown by the Figure, a vehicle value (251) (“vehicle weight”) can be selected by click event from a list of vehicle values (260). A first value range (261) (for example “0-3000” as shown in the Figure) for the vehicle value (251) (“vehicle weight”) can be generated by click event of a vehicle value range generation element (262)(for example the “add 1 line” element shown in the figure) and entry of a pair of numerical range indicators (263) (for example “0” and “3000” for the first value range) of the vehicle value (251). The value based fee-tax amount (257)(for the first value range (261) established can be entered in a fee-tax amount field (264)(under “amount” column as shown in FIG. 48). The plurality of value ranges (259) for the selected vehicle value (251) can be similarly generated by using the vehicle value range generation element (262) each having a value based fee-tax amount (257) entered into the corresponding fee-tax amount field (264). While seven value ranges for the vehicle value (251)(“vehicle weight”) are shown by the example, the invention is not so limited, and any number of vehicle value ranges can be established. Upon subsequent retrieval of the fee-tax (186) the value based fee-tax module (256) further operates to retrieve the corresponding value based fee-tax amount (257) by a match between an actual vehicle value (266)(entered in the customer fee-tax user graphic interface) and one of the plurality of vehicle value ranges (265) established in the value based fee-tax template (194).

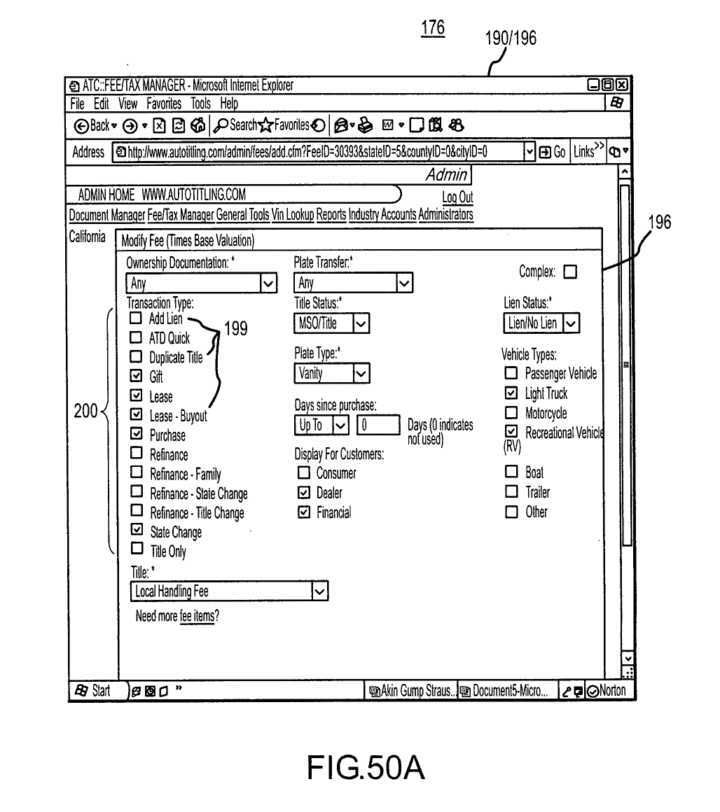

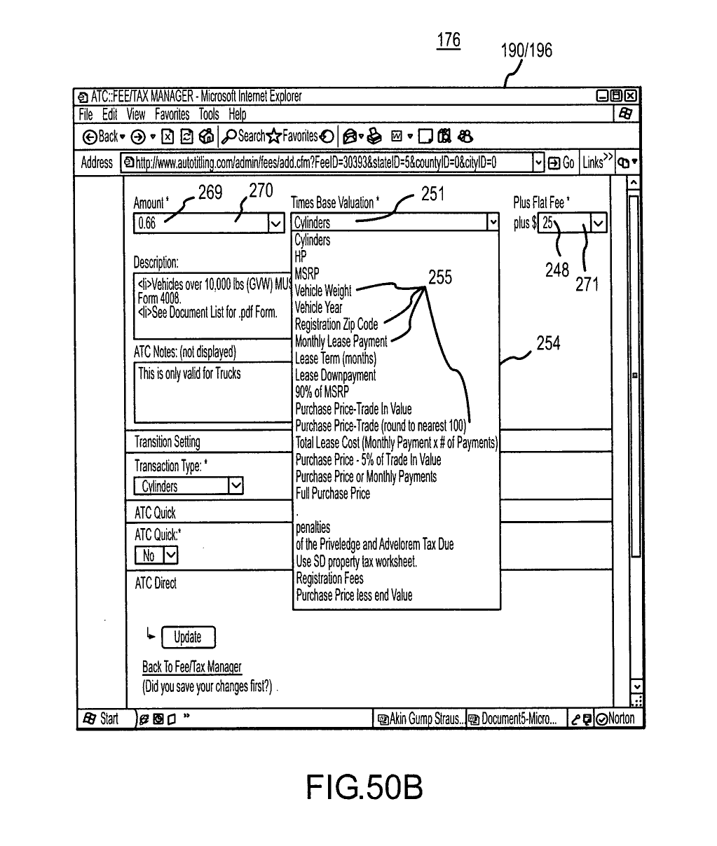

Now referring primarily to FIGS. 50A and 50B, the calculated fee-tax template (196) can further allow operation of a calculated fee-tax module (267) which allows characterization of the fee-tax (186) with a calculated fee-tax amount (268). The calculated fee-tax module (267) functions to determine the calculated fee-tax amount (268) as a fractional value (269) of a vehicle value (251) to which a flat fee-tax amount (248) can be added. For example, as shown by FIG. 50B, a vehicle value (251) can be selected by click event from a plurality of vehicle values (255) from a vehicle value list (254). A fractional value (269) between 0 and 1 can be entered into a fractional value field (270). A flat fee-tax amount (248) can be entered by click event into flat fee-tax field (271). Upon subsequent retrieval of the fee-tax (186), the calculated fee-tax module (267) determines the calculated fee-tax amount (268) by multiplying the selected vehicle value (251) by the fractional value (269) entered into the fractional value field (270) and adding the flat fee-tax amount (248) entered in the flat fee-tax field (271).

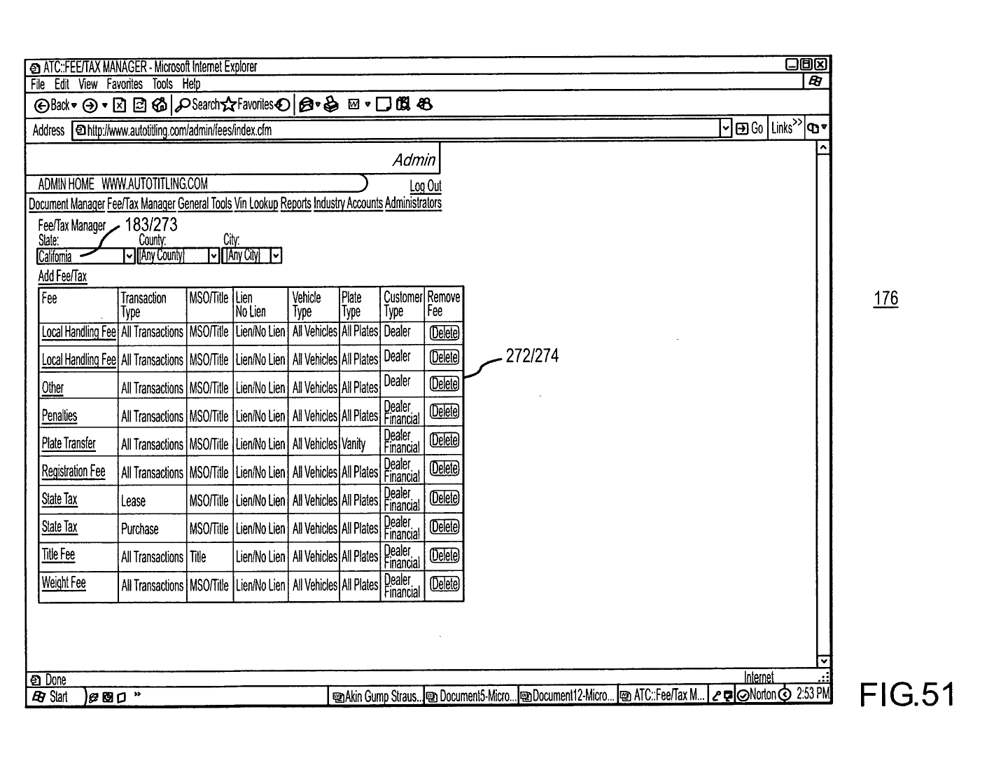

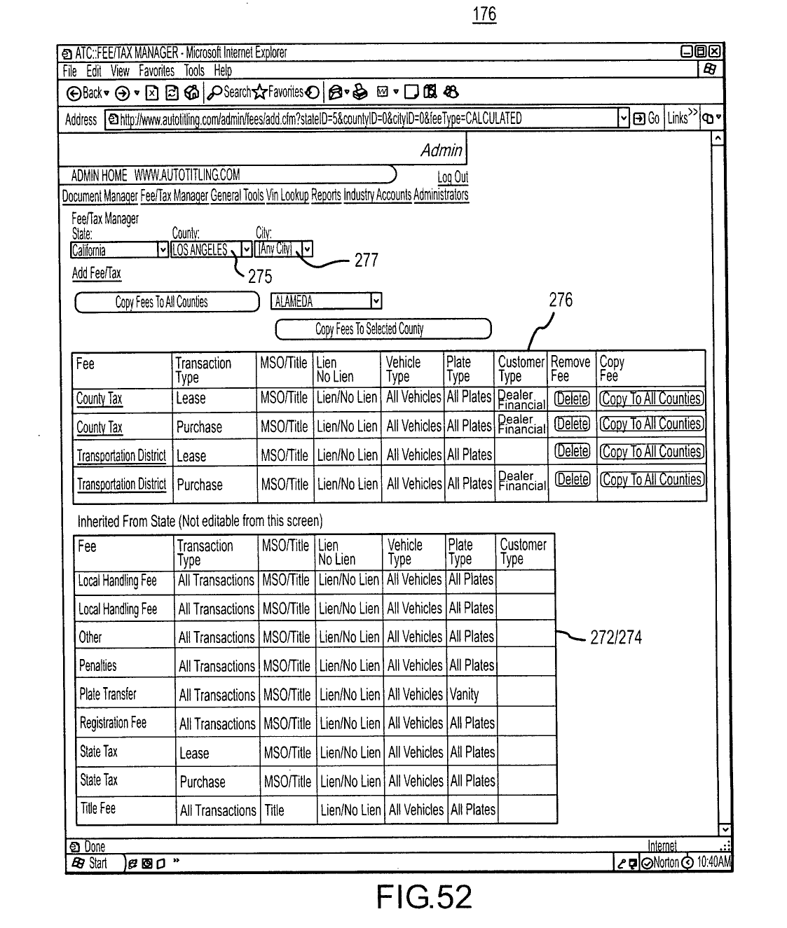

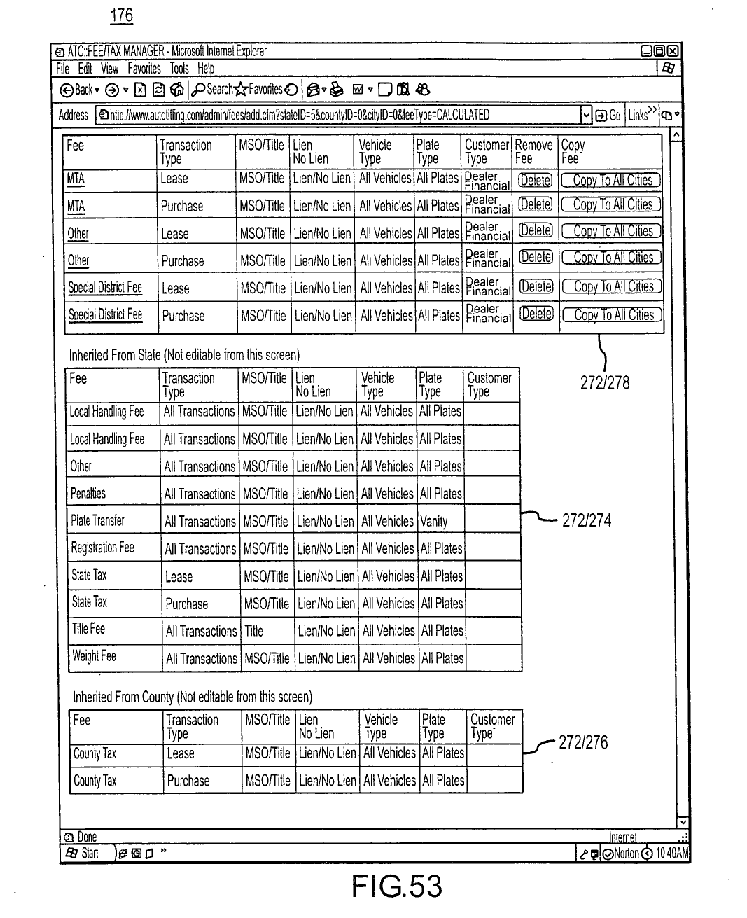

Now referring primarily to FIGS. 51-53, upon characterization of the fee-tax (186) using the above-described plurality of fee-tax modules (173) and establishing retrievable storage of the fee-tax (186) by utilization of the fee-tax update module (284), subsequent selection by click event of a taxing entity (183) in the administrator fee-tax graphic user interface (176) as above-described can generate an administrator fee-tax list (272) for the selected taxing entity (183). As shown by the example provided by FIG. 51, the selection by click event of a state taxing entity (273) can generate a state fee-tax list (274). As further shown by FIG. 52, subsequent selection by click event of a county taxing entity (275) having a location within the selected state taxing entity (273) can generate an additional county fee-tax list (276). As further shown by FIG. 53, the selection by click event of a city fee-taxing entity (277) having a location within the county taxing entity (275) can generate an additional city fee-tax list (278). Activation by click event of a delete function (shown as “delete” in the embodiment shown) each fee-tax (186) can be removed if desired. Alternately, the fee-tax (186) can be populated to all counties within a state taxing entity (273) or all cities within a county taxing entity (277) by activation of a county population function (314) and a city population function (315) respectively.

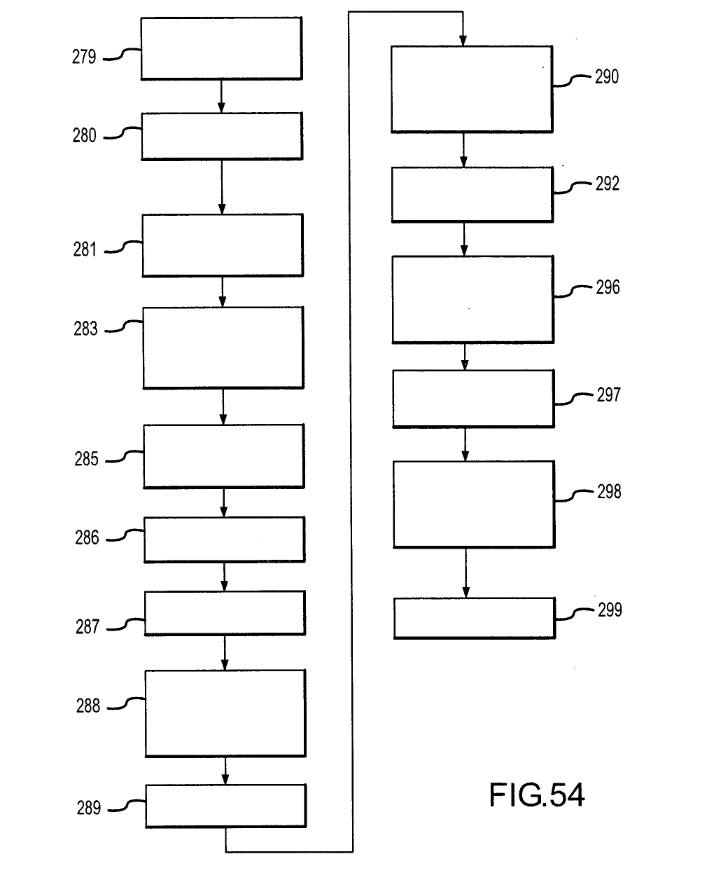

Now referring primarily to FIG. 54, a flow chart shows the stepwise utilization of a particular embodiment of the fee-tax administrator module (172) to activate the functions of each of the plurality of fee-tax modules (173) above-described to characterize a fee-tax (186) of a selected taxing entity (183) for retrievable storage in the memory element (28)(or other memory element) of the first computer (1) or a second computer (2). In a first step (279), the administrator (53a) can activate by click event the taxing entity selection module (182) above-described to select a taxing entity (183) which functions to couple a corresponding taxing entity identifier (185) to the fee-tax (186). In a second step (280), the administrator (53a) can by click event activate a fee-tax type selection module (187) to select one of a plurality of fee-tax types (189) which functions to generate the corresponding fee-tax template (192)(194)(196)(each above-described) in which the administrator (53a) can take further steps to characterize the fee-tax (186) of the taxing entity (183) selected. Within each of the particular embodiments of the fee-tax templates (192)(194)(196), the administrator (53a) can take a third step (281) to activate by click event the vehicle title registration entity module (205) which upon selection of one of a plurality of vehicle title registration location indicators (285) functions to couple a corresponding one of the plurality of vehicle title registration entity identifiers (282) to the fee-tax (186). In a fourth step (283), the administrator (53a) can by click event activate the transaction type module (198) to select one or more of a plurality of fee-tax transaction types (200) which functions to couple the corresponding fee-tax transaction type identifiers (201) to the fee-tax (186). In a fifth step (285), the administrator (53a) can by click event activate the plate transfer module (208) to select one of the plurality plate transfers (209) which functions and couple a corresponding one of a plurality of plate transfer identifiers (284) the fee-tax (186). In a sixth step (286), the administrator (53a) can by click event activate the title status module (213) above to select one of a plurality of title statuses (214) which functions to couple one of the corresponding plurality of title status identifiers (220) to the fee-tax (186). In a seventh step (287), the administrator (53a) can by click event activate the lien status module (221) to select one of a plurality of lien statuses (222) which functions to couple the corresponding one of a plurality of lien identifiers (226) to the fee-tax (186). In an eighth step (288), the administrator (53a) can by click event activate the plate type module (227) to select one of a plurality of plates types (228) which functions to couple the corresponding plate type identifier (233) to the fee-tax (186). In a ninth step (289), the administrator (53a) can by click event activate the elapsed days module (234) and select a number of elapsed days (235) from the purchase date of a vehicle entity (203) which functions to couple a corresponding elapsed days identifier (236) to the fee-tax (186). In a tenth step (290), the administrator (53a) can by click event activate the fee-tax title module (237) and select from a plurality of fee-tax titles (238) the fee-tax title (239) of the fee-tax (186) which functions to couple the corresponding fee-tax title (239)(or a fee tax title identifier (291)) to the fee-tax (186). In an eleventh step (292), the administrator (53a) can by click event activate one of a customer type module (293) and select one or more of a plurality of customer types (294) which functions to couple the corresponding customer type identifier (295) to the fee-tax (186). In a twelfth step (296), the administrator (53a) can by click event activate the vehicle entity module (202) and select by click event from a plurality of vehicle entities (204) which functions to couple the corresponding vehicle entity identifier (216) to the fee-tax (186).

If in the second step (280), the administrator (53a) by click event selects the flat fee-tax template (194), then the administrator (53) in a thirteen step (297) can by click event activate the flat fee-tax module (247) and either enter a flat fee-tax amount (248) in the flat fee-tax field (249) which functions to couple the corresponding flat fee-tax amount (247) to the fee-tax (186); or alternately, in the thirteenth step (297) can by click event activate a percent value function (252) which by entering a percent value (250) into the percentage value field (253) and selecting a vehicle value (251) calculates a flat fee-tax amount (247) as the product of the entered percent value (250) and the selected vehicle value (251) and further functions to couple the corresponding flat fee-tax amount (247) to the fee-tax (186).

However, if in the second step (280), the administrator (53a) by click event selects the value based fee tax template (194), then in the thirteenth step (297) can by click event activate the value based fee-tax module (256) which allows the administrator (53a) to generate of one value range (258) or plurality of value ranges (259) for a selected vehicle value (251) and entry of the value based fee-tax amount (257) corresponding the value range (258) for the selected vehicle value (251) or each of the plurality of value ranges (259) generated which functions to couple the corresponding value based fee-tax amount (257) for each of the plurality of vehicle value ranges (259) to the fee-tax (186).

Again, if in the second step (280), the administrator (53a) by click event selects the calculated fee tax template (196), then in the thirteenth step (297) can by click event activate the calculated fee tax module (267) which functions to determine the calculated fee-tax amount (268) as the product of an entered fractional value (269) and a selected vehicle value (251) and subsequent addition of any flat fee-tax amount (248) further functions to couples the corresponding calculated fee-tax amount (268) to the fee-tax (186).

Regardless of the type of fee-tax template (192)(194)(196) selected, as to each in a fourteenth step (298), the administrator (53a) can by click event enter a user fee-tax description (244) into the user fee-tax description field (245) which functions to couple the user fee-tax description (244) to the fee-tax (186).

In a fifteenth step (299), the administrator (53a) can by click event activate the fee-tax update module (246) which functions to store the fee-tax (186) characterized by the various fee-tax identifiers coupled by use of the plurality of fee-tax modules of the fee-tax administrator module (172) of the fee-tax manager (171).

Now referring primarily to FIGS. 1, 2 and 55, a part of the fee-tax management application program (171) can be served by the first computer (1) to one or more second computers (2) or to the first computer (1). The part of the fee-tax management application program (171) served can include the fee-tax user module (177) which provides a hierarchical structure of a plurality of fee-tax retrieval modules (178). Each of a plurality of customer fee-tax graphic user interfaces (181) can be generated by the fee-tax user module (177) of the fee-tax management application program (171) which allows a customer user (53b) to activate the functionalities of the plurality of fee-tax retrieval modules (178) in the intended hierarchical structure as further described in the non-limiting example below to allow retrieval of fee-taxes (186) for each taxing entity (183) based upon matched correspondence of one or more fee-tax retrieval elements (180)(entered by the customer (53b) into the embodiment of the customer fee-tax graphic user interface (181) generated) with a corresponding one or more of the fee-tax identifiers (179) coupled to each one the fee-taxes (186) by utilization of the fee-tax administrator module (172) by an administrator (53a).

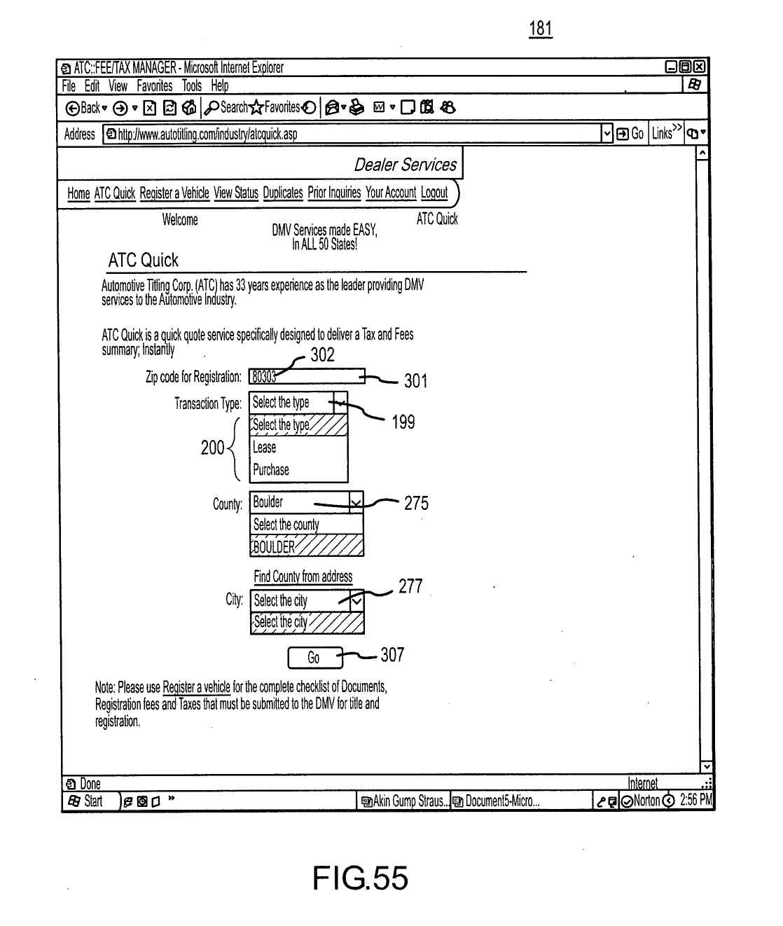

One of the plurality of a fee-tax retrieval modules (178) can be a taxing entity selection module (300) which functions to generate a zip code entry field (301) into which the customer (53b) can enter a zip code (302) which can be matched against the plurality of taxing entity identifiers (185) to retrieve one or more fee-taxes (186) matched to the corresponding taxing entity (183) encompassed by the entered zip code (302). While in the embodiment of customer fee-tax graphic user interface (181) generated by the fee-tax retrieval taxing entity selection module (300) shown in FIG. 55 a zip code (302) is matched to the plurality of taxing entity identifiers (185), the invention is not so limited and the fee-tax retrieval taxing entity selection module (300) could for example generate a customer fee-tax graphic user interface (181) configured similar to the administrator fee-tax graphic user interface (176), or otherwise which allow use of the functions of the plurality of fee-tax retrieval modules (178).

Now referring primarily to FIG. 55, which shows that part of the customer fee-tax graphic interface (181) generated by a fee-tax retrieval transaction type module (303) which allows selection by click event of a transaction type (199) which can be performed by the selected taxing entity (183) matched to the zip code (302) entered as above-described. As shown, the embodiment of the customer fee-tax graphic user interface (181) allows selection by click event of one of a plurality of transaction types (200). However, the invention is not so limited and the plurality of transaction types (200) could be provided in the configuration shown in FIG. 45 as but one alternate example. Selection of the transaction type (199) further matches the transaction type (199) with the corresponding transaction type identifier (201).

Now again referring primarily to FIG. 55, an embodiment of the fee-tax retrieval taxing entity selection module (300) can further include a county taxing entity selection function (304) which allows selection by click event of a county taxing entity (275) and a city taxing entity selection function (305) which allows selection by click event of a city taxing entity (277) (other political units or geographic units which have authority to promulgate fees or taxes encompassed by the entered zip code (302) could also be selected by click event). In the embodiment of the fee-tax retrieval taxing entity selection module (300) shown, selection of the county taxing entity (275) and the city taxing entity (277) further retrieves the fee-taxes (186) matched to these additional taxing entities based upon the taxing entity identifiers (185) coupled to the fee-tax (186) as above-described by utilization of the fee-tax administrator module (172).

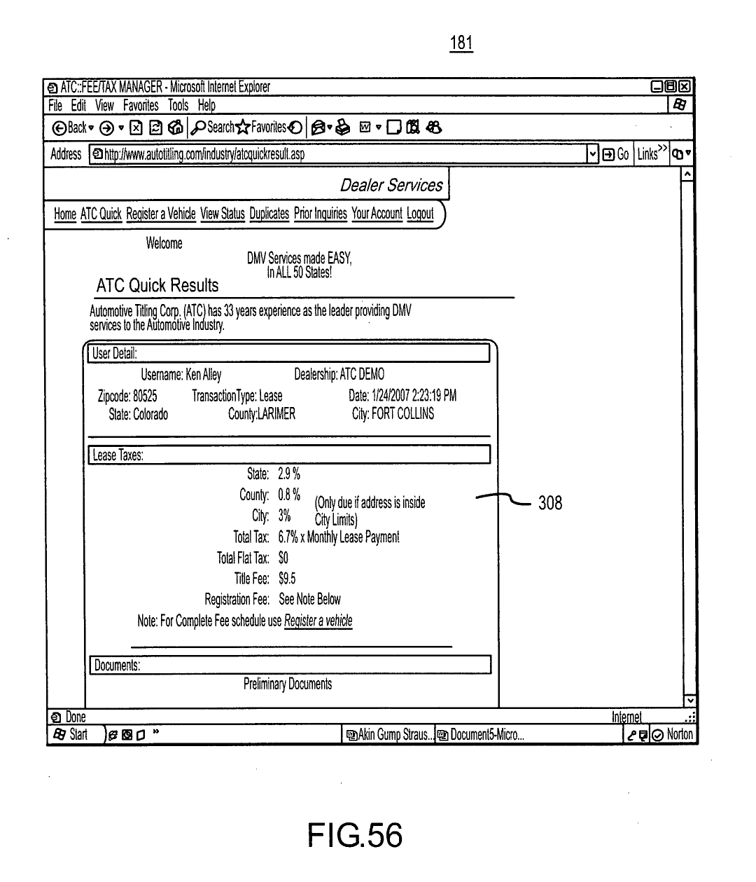

Again referring primarily to FIG. 55, upon selection by click event of the taxing entity (183) and clickable selection of the transaction type (199) as above-described the customer user (53b) can retrieve each of the fee-taxes (186) for each one of the plurality of taxing entities (175) which matches the corresponding taxing entity identifier (185) and the transaction type identifier (201) by activation of a retrieval function (306) by click event of a corresponding fee-tax retrieval icon (307) which in the embodiment of the customer fee-tax graphic user interface (181) shown in the Figure provides a non-limiting example of a “go” button. The fee-tax (186) retrieved based on matched correspondence between the fee-tax retrieval elements (179) entered in the customer fee-tax graphic user interface (181) and the fee-tax identifiers (179) coupled to each fee-tax (186) icon be displayed in the retrieved fee-tax format (308) shown by FIG. 56, as but one example.

Now again referring primarily to FIG. 45A, the fee-tax management application (171) can further provide customer type selection module (293) which functions to allow selection by click event of one or more of a plurality of customer types (309) within each embodiment of the fee-tax type templates (190) to couple one or more customer type identifiers (295) to each fee-tax (186). Each of the customer type identifiers (295) can be correspondingly matched to one of a plurality of customer graphic user interfaces (181) which can be generated by the by the fee-tax user module (177). As such, utilization of each of the plurality of customer graphic user interfaces (181) by a customer user (53b) limits retrieval of those fee-taxes (186) to those having a customer type identifier (295) correspondingly coupled by use of the customer type module (293) of the fee-tax administrator module (172). For example, the embodiment of the customer fee-tax graphic user interface (181) shown in FIG. 55 can retrieve only those particular fee-taxes (186) coupled to a consumer fee-tax identifier (311). As a non-limiting example, characterization of a fee-tax (186) with only a consumer fee-tax type identifier (311) allows the fee-tax (186) to be retrieved and formatted only in the matched user graphic interfaces (181) for an authorized consumer (typically an individual person who purchases or intends to purchase a vehicle) but not in other user graphic interfaces matched with other customer types such as “dealer” (312) (typically meaning an employee of a business entity which purchases and sells vehicles such as a vehicle dealership) or “finance” (313) (typically meaning an employee of a business entity which finances the purchase of vehicles such as lender or bank). This allows each fee-tax (186) to be displayed (or in certain instances not displayed) in a user graphic user interface (181) formatted in a manner useful to the selected customer type.

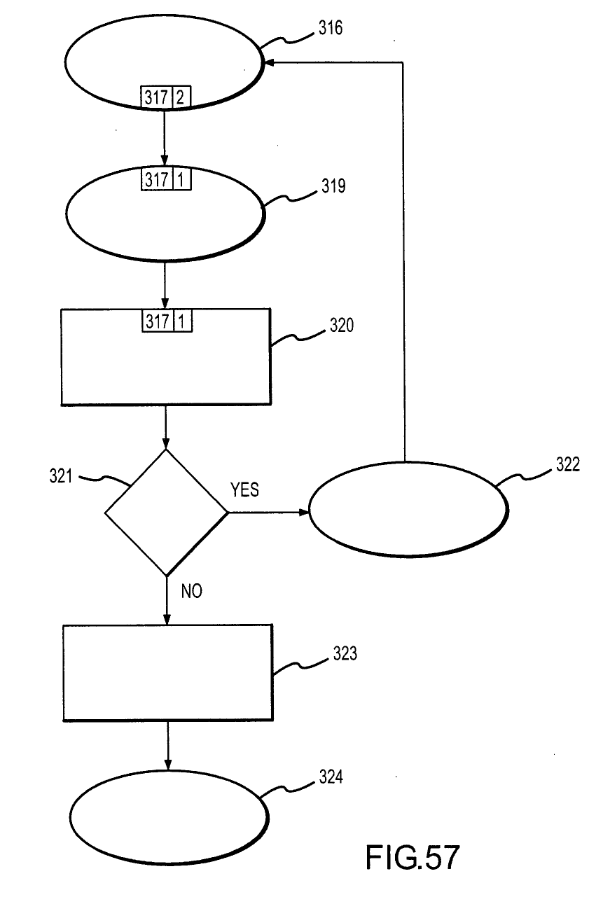

Now referring primarily to FIG. 57, a flow chart shows the stepwise function of a particular embodiment of the fee-tax user module (177) having the non-limiting user graphic interface (181) shown in FIG. 55. In a first step (316), the customer (53b) can utilize one of the plurality of user graphic interfaces (181)(such as “consumer”, “dealer”, or “finance”) above described displayed on the second computer (2) or the first computer (1) to enter fee-tax retrieval elements (180) which by activation of the retrieval function (306) by click event of a corresponding fee-tax retrieval icon (307) can generate a fee-tax inquiry (317) which in a second step (319) can be received by a fee-tax retrieval match module (318) of the first computer (1). The fee-tax retrieval match module (318) can in a third step (320) parse and validate the fee-tax inquiry (317) and in a fourth step (321) if there are any errors in a fifth step (322) the fee-tax inquiry (317) the fee-tax inquiry can be returned to the second computer (2)(or computer generating the inquiry) to be corrected in accordance with coupled error instruction. If there are no errors in the fee tax inquiry (317), in a sixth step (323) the fee-tax retrieval elements (180) contained therein matched by function of the fee-tax retrieval match module (318) to fee-tax identifiers (179). In a seventh step, each fee-tax (186) matched by the fee-tax retrieval match module (318) is retrieved and returned to the second computer (2)(or computer generating the inquiry) in a fee-tax inquiry response (325) which can be displayed as above described in a user graphic user interface (181) formatted in a manner useful to the selected customer type.

### EXAMPLE 1

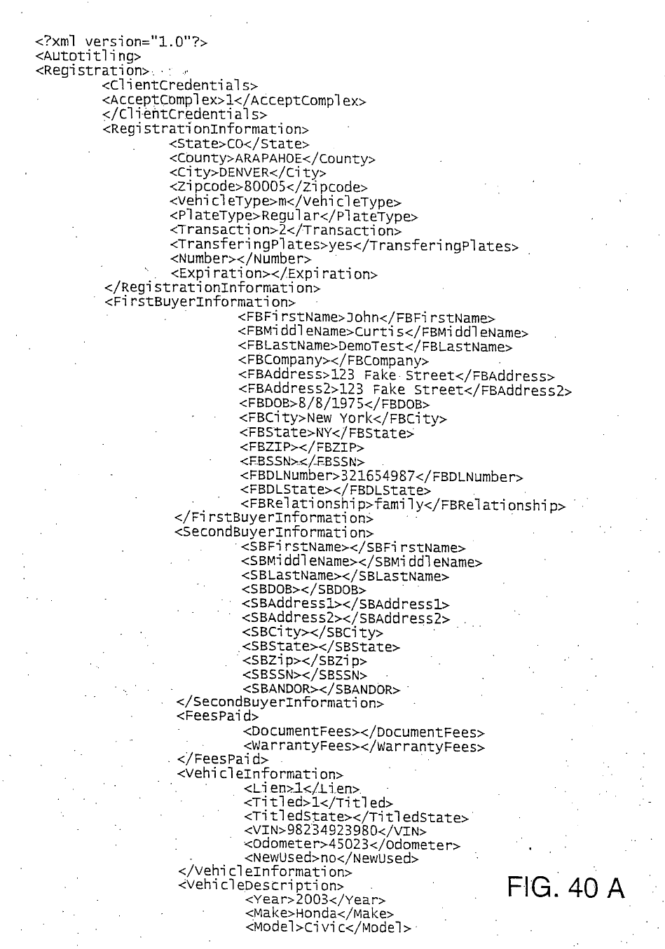

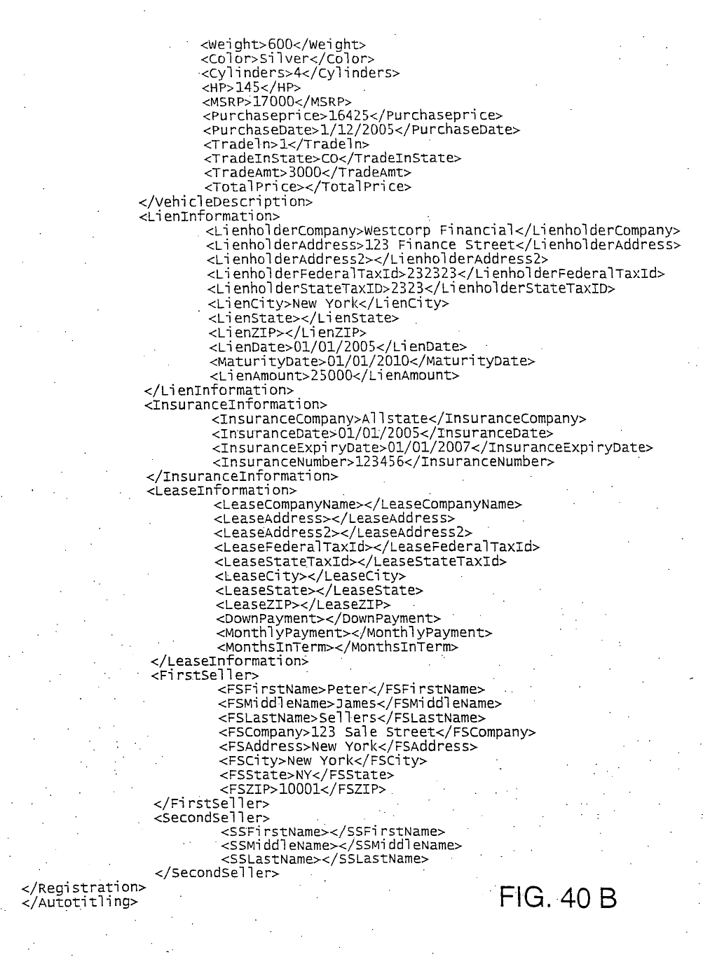

Now referring to FIGS. 40A and 40B, a non-limiting example of a motor vehicle titling inquiry is provided in an XML schema. This particular example is not intended to be limiting with respect to the type of markup language which can be utilized to generate a motor vehicle titling inquiry compatible with the architecture utilized to assign motor vehicle data entity identifiers to the plurality of motor vehicle titling data entities (15) by use of the motor vehicle titling data entity manager (54) as above described.

### EXAMPLE 2

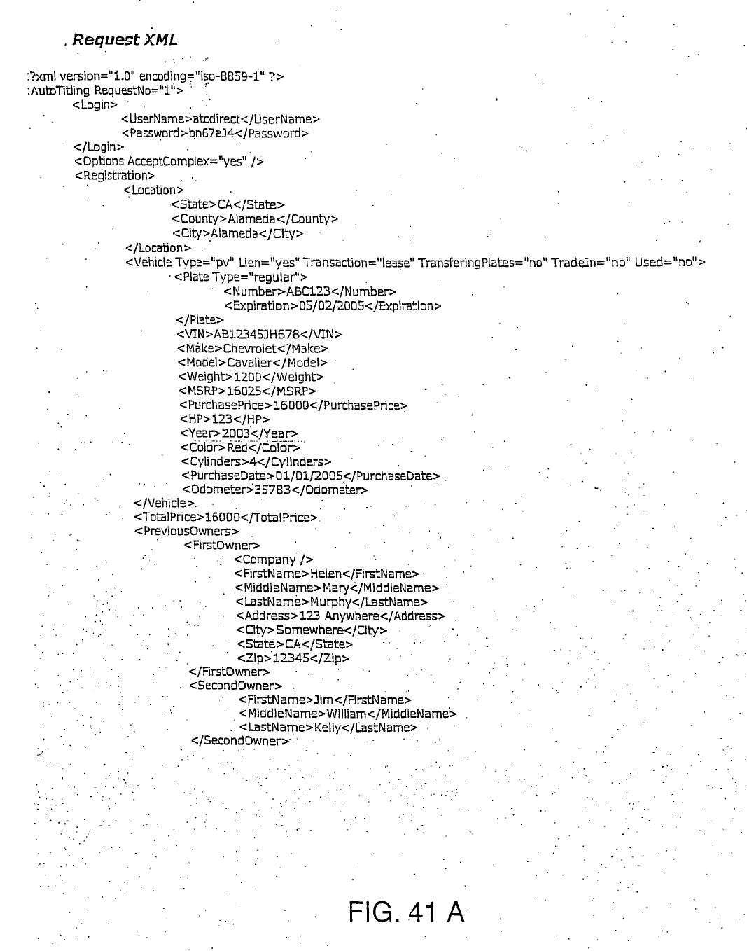

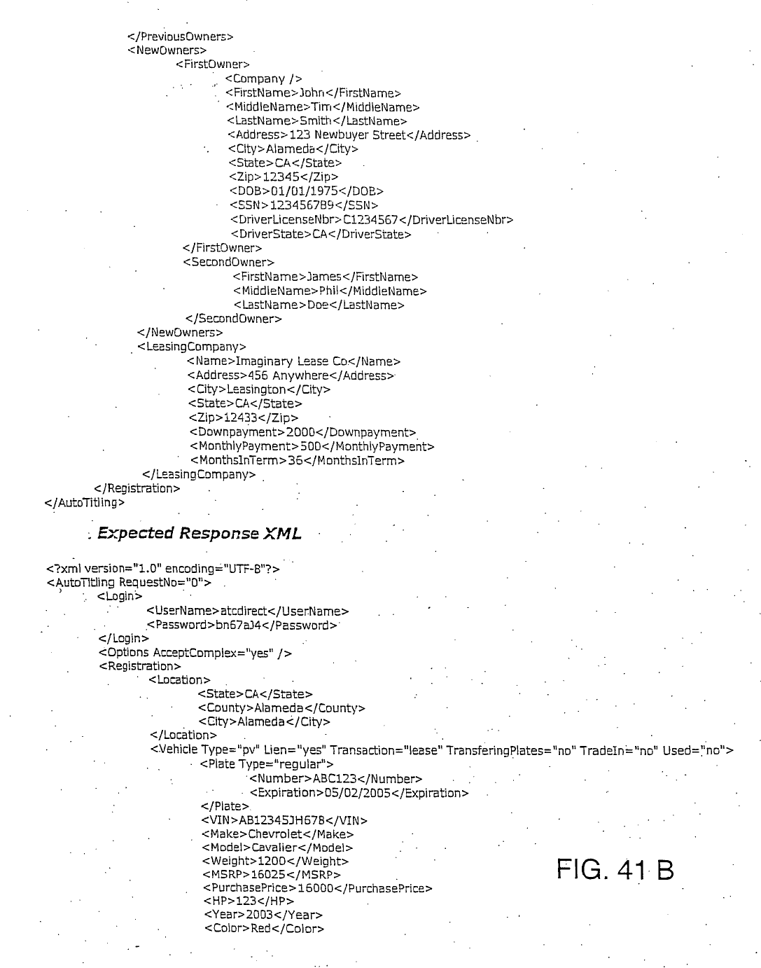

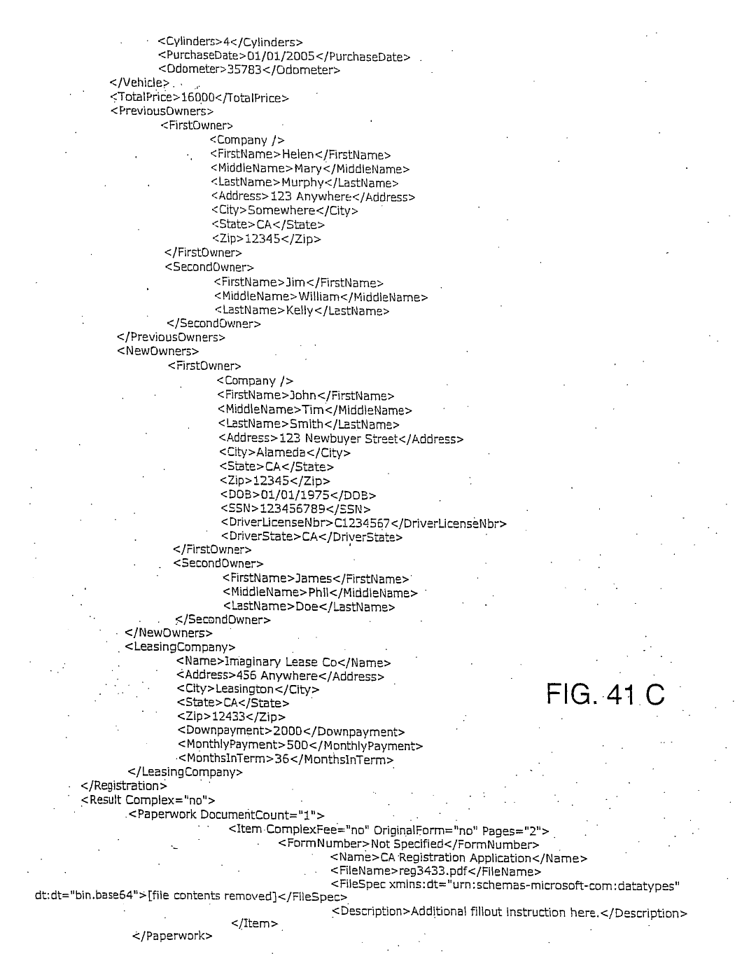

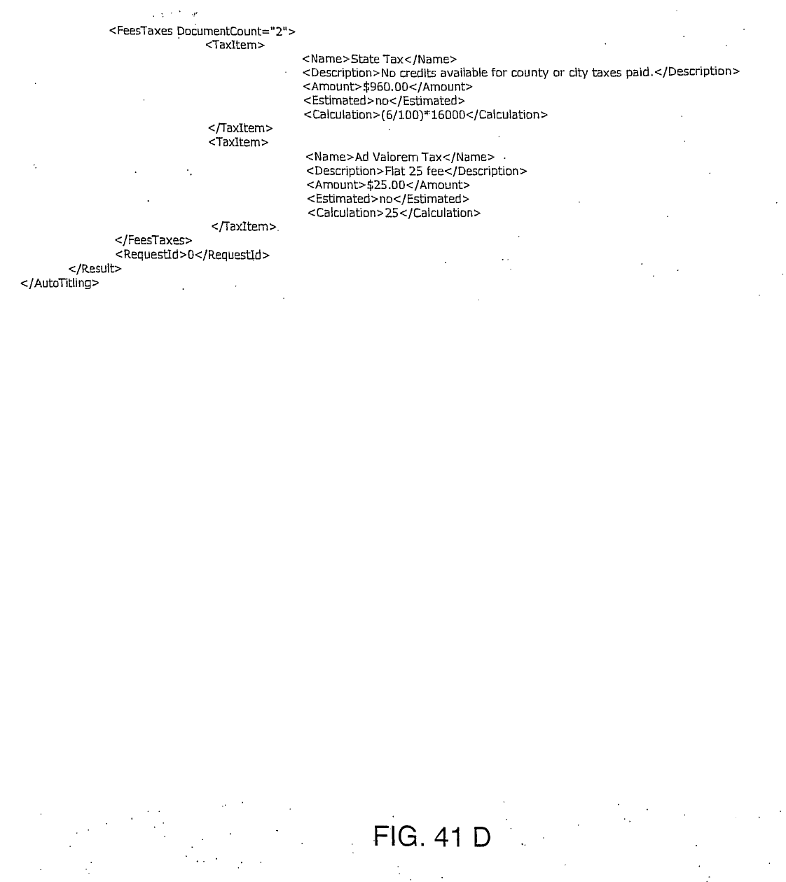

FIGS. 41A to 41D provide a non-limiting example of a “return inquiry” step (158) on a titling instruction inquiry (14) in an XML schema.

### EXAMPLE 3

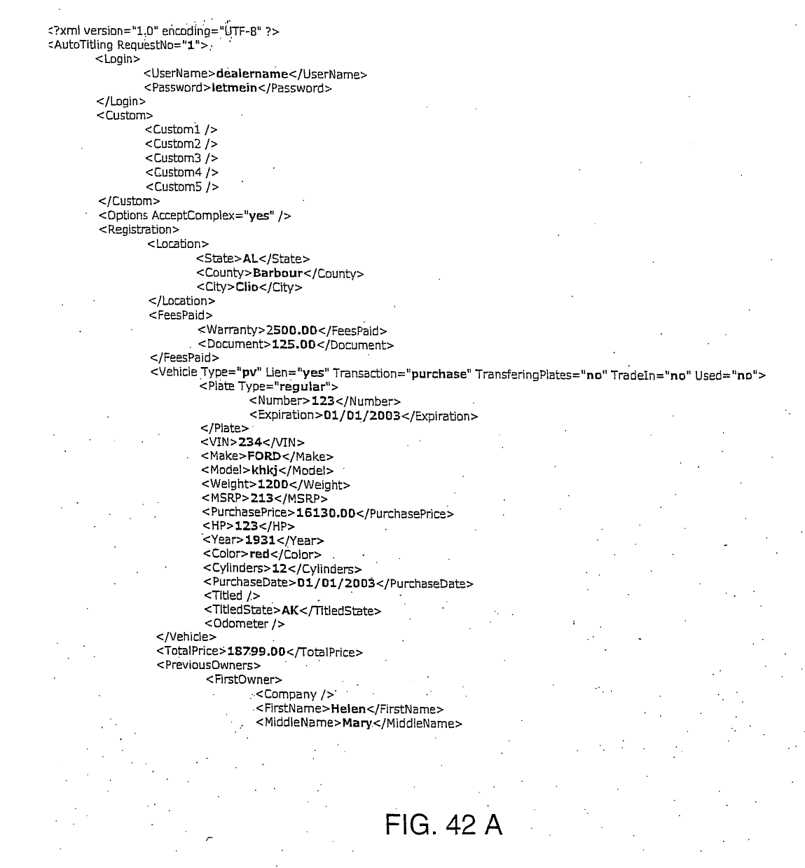

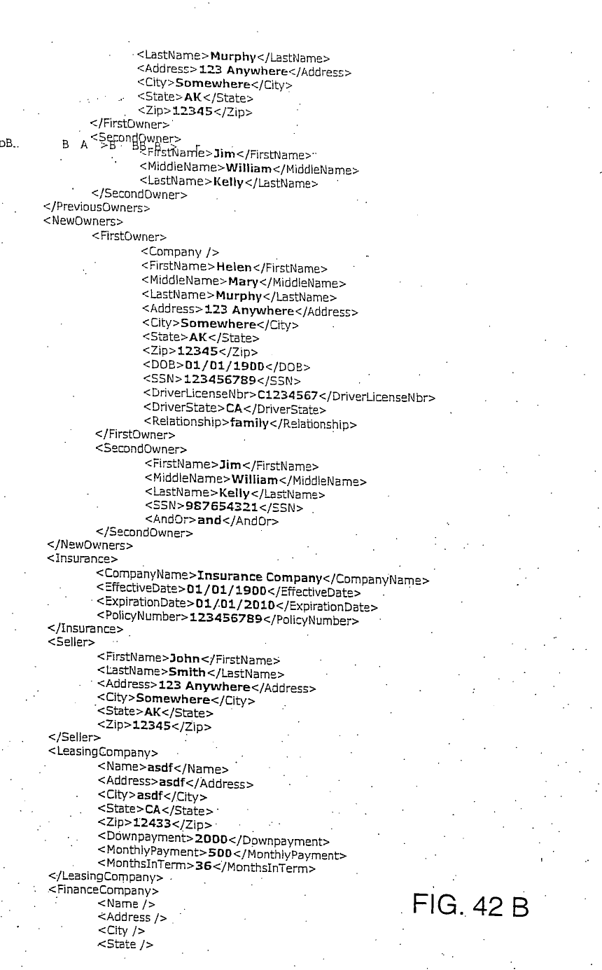

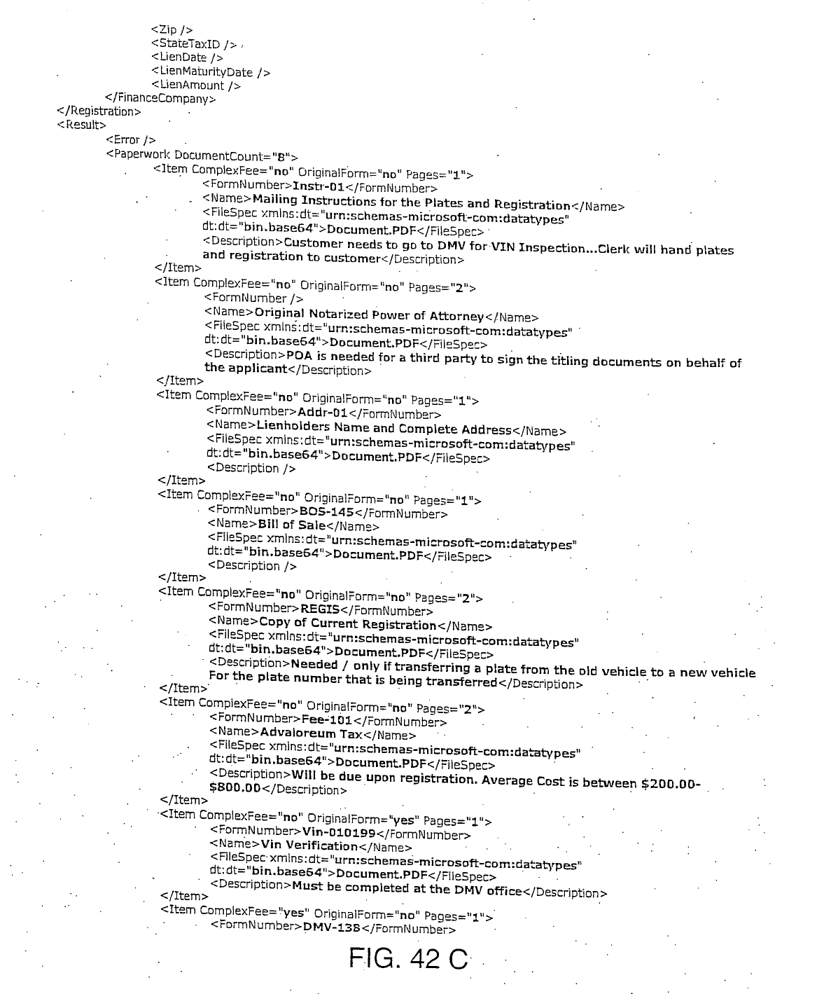

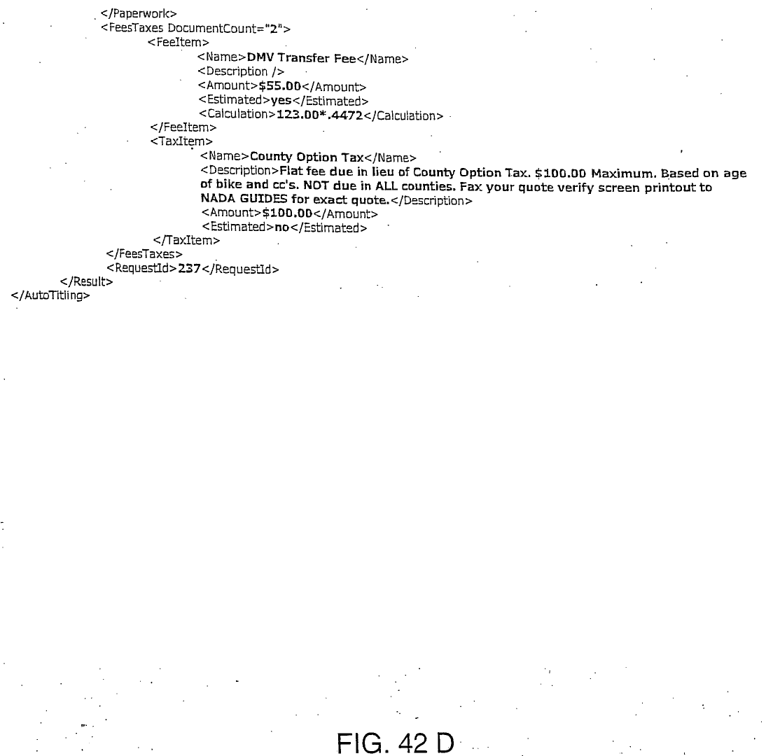

FIGS. 42A to 42D provide a non-limiting example of a motor vehicle titling instruction (20) in an XML schema.

As can be easily understood from the foregoing, the basic concepts of the present invention may be embodied in a variety of ways. The invention involves numerous and varied embodiments of an automotive titling system and methods of use thereof. As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “automotive title” should be understood to encompass disclosure of the act of “automotive titling”—whether explicitly discussed or not—and, conversely, were there the disclosure of the act of “automotive titling”, such a disclosure should be understood to encompass disclosure of a “automotive title” and even a “means for automotive titling.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the automotive titling systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent patent application, publication, statement or other information cited or incorporated herein be interpreted, construed or deemed to be admitted as prior art with respect to the invention.

Any claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of any such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Any claims set forth below are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any United States non-provision patent application or Patent Cooperation Treaty patent application, or any continuation, division, or continuation-in-part, or similar application thereof.

1. A fee-tax management system, comprising:
a) a taxing entity selection module which allows selection of a taxing entity from a plurality of taxing entities;
b) a fee-tax type selection module generated by selection of one of said plurality of taxing entities which allows selection of a fee-tax type from a plurality of fee-tax types;
c) a fee-tax type template generated by selection of one of said plurality of fee-tax types which allows characterization of a fee-tax of said taxing entity; and
d) a fee-tax database which allows retrievable storage of said fee-tax.

2. A fee-tax management system as described in claim 1, wherein said taxing entity selection module allows selection of a taxing entity from the group consisting of a state, a county, and a city.

3. A fee-tax management system as described in claim 2, wherein said fee-tax type template further comprises a transaction type module which allows characterization of said fee-tax as applying to a transaction type with said taxing entity.

4. A fee-tax management system as described in claim 3, wherein said transaction type module allows selection of one or more of a plurality of transaction types from the group consisting of: an add lien, a duplicate title, a gift, a lease, a lease-buyout, a purchase, a refinance, a refinance family, a refinance state change, a refinance title change, a state change, and a title registration.

5. A fee-tax management system as described in claim 4, wherein said fee-tax type template further comprises a vehicle entity module which allows characterization of said fee-tax based upon type of a vehicle entity.

6. A fee-tax management system as described in claim 5, wherein said vehicle entity module allows selection of said vehicle entity from the group of: a passenger vehicle, a light truck vehicle, a motorcycle vehicle, a recreational vehicle, a boat vehicle, a trailer vehicle, and an other vehicle.

7. A fee-tax management system as described in claim 6, wherein said fee-tax type template further comprises a title registration entity module which allows characterization of said fee-tax as applying to a title registration entity location at which a vehicle has a registered title.

8. A fee-tax management system as described in claim 7, wherein said title registration entity module allows selection of one of a plurality of title registration entity locations from the group consisting of any title registration entity location, a title registration entity outside of said taxing entity, and a title registration entity inside of said taxing entity.

9. A fee-tax management system as described in claim 8, wherein said fee-tax type template further comprises a plate transfer module which allows characterization of said fee-tax as applying to a plate transfer.

10. A fee-tax management system as described in claim 9, wherein said plate transfer module allows selection of one of a plurality of plate transfers from the group consisting of: a transferred plate, a non-transferred plate, any plate.

11. A fee-tax management system as described in claim 10, wherein said fee-tax type template further comprises a title status module which allows characterization of said fee-tax as applying to a title status.

12. A fee-tax management system as described in claim 11, wherein said title status module allows selection of one of a plurality of title statuses from the group consisting of: a title of an untitled vehicle, a title of a prior titled vehicle, and any title of any vehicle.

13. A fee-tax management system as described in claim 12, wherein said fee-tax type template further comprises a lien status module which allows characterization of said fee-tax as applying to a lien status.

14. A fee-tax management system as described in claim 13, wherein said lien status module allows selection of one of a plurality of lien statuses from the group consisting of: a lien status, a no lien status, any lien status.

15. A fee-tax management system as described in claim 14, wherein said fee-tax type template further comprises a plate type module which allows characterization of said fee-tax as applying to a plate type.

16. A fee-tax management system as described in claim 15, wherein said plate type module allows selection of one of a plurality of plate types from the group consisting of: a vanity plate, a special plate, a regular plate, and a commercial plate.

17. A fee-tax management system as described in claim 16, wherein said fee-tax type template further comprises an elapsed days module which allows characterization of said fee-tax based upon a number of elapsed days from a purchase date of a vehicle.

18. A fee-tax management system as described in claim 17, wherein said elapsed days module allows selection of said number of elapsed days from said purchase date of said vehicle, and wherein characterization of said fee-tax is based upon said transaction occurring with said taxing entity prior to said number of elapsed days selected or occurring after said number of elapsed days selected.

19. A fee-tax management system as described in claim 18, wherein said fee-tax type template further comprises a fee-tax title module which allows a title to be matched to said fee-tax.

20. A fee-tax management system as described in claim 19, wherein said fee-tax type template further comprises a user fee-tax description module which allows entry of a user fee-tax description into a user fee-tax description field said user fee-tax description retrieved by a user computer with said fee-tax.

21. A fee-tax management system as described in claim 20, wherein said fee-tax template further comprises an administrator fee-tax description module which allows entry of an administrator fee-tax description into an administrator fee-tax description field said administrator fee-tax description retrieved by an administrator computer with said fee-tax.

22. A fee-tax management system as described in claim 22, wherein said fee-tax type template further comprises a fee-tax update module which functions to store said fee-tax in said fee-tax database for matched retrieval by a user computer.

23. A fee-tax management system as described in claim 22, wherein tax-fee type selection module allows selection of a fee-tax type template from the group consisting of a flat fee-tax template, a value based fee-tax template, and a calculated fee-tax template.

24. A fee-tax management system as described in claim 23, wherein said fee-tax type template comprises a flat fee-tax template.

25. A fee-tax management system as described in claim 24, wherein said flat fee-tax type template further comprises a flat fee-tax module which allows characterization of said fee-tax as a flat fee-tax.

26. A fee-tax management system as described in claim 25, wherein said flat fee module allows selection of a flat fee value based on a vehicle value.

27. A fee-tax management system as described in claim 26, wherein said flat fee module allows selection of a flat fee based on a percentage of a vehicle value.

28. A fee-tax management system as described in claim 27, wherein said flat fee module allows selection of said vehicle value from the group of vehicle values consisting of: a cylinder value, an MSRP value, a vehicle weight value, a vehicle year value, a vehicle registration address value, a vehicle purchase price, a lease term value, a lease down payment value, a ninety percent of MSRP value, a purchase price less trade in value, a purchase price less trade value, a total lease cost value, a total lease purchase cost, a full purchase price, a purchase price less value, an amount of registration fees, an amount of penalties, an amount of priviledge or ad valorum tax value, and SD value property tax worksheet value.

29. A fee-tax management system as described in claim 22, wherein said fee-tax type template comprises a value based fee-tax template.

30. A fee-tax management system as described in claim 29, wherein said value based fee-tax template further comprises a value based fee-tax module which allows characterization of said fee-tax as a value based fee-tax.

31. A fee-tax management system as described in claim 30, wherein said value based fee-tax module allows selection of said value based fee-tax based upon a value range of said vehicle value.

32. A fee-tax management system as described in claim 31, wherein said value based fee-tax module further comprises a value range table generation module which allows generation of a value range table which includes a plurality of value ranges of said vehicle value each one of said plurality of value ranges coupled to a corresponding one said fee-tax.

33. A fee-tax management system as described in claim 22, wherein said fee-tax type template comprises a calculated fee-tax template.

34. A fee-tax management system as described in claim 33, wherein said calculated fee-tax template further comprises a calculated fee-tax module which allows characterization of said fee-tax as a calculated fee tax.

35. A fee-tax management system as described in claim 34, wherein said calculated fee-tax module allows generation of said calculated fee-tax based upon an amount of said vehicle value.

36. A fee-tax management system as described in claim 35, wherein said calculated fee-tax module further comprises a fee-tax calculator module which allows selection of said amount of said vehicle value to calculate said fee-tax.

37. A fee-tax management system as described in any one of claim 22, further comprising a fee-tax table generator which functions to generate a list of each said fee-tax stored in said fee-tax database for a selected said taxing entity.

38. A fee-tax management system as described in claim 37, wherein said fee-tax type template further comprises a taxed entity module which allows characterization of said fee-tax based upon type of a taxed entity.

39. A fee-tax management system as described in claim 38, wherein said taxed entity module allows selection of said taxed entity from the group consisting of: a dealer entity, a consumer entity, a finance entity.

40-78. (canceled)
